(19) United States
(12) Patent Application Publication
(10) Pub. No.: US 2022/0011484 A1
(43) Pub. Date: Jan. 13, 2022

(54) OPTICAL FILTER AND IMAGING DEVICE

(71) Applicant: AGC Inc., Tokyo (JP)

(72) Inventors: Kazuhiko SHIONO, Fukushima (JP); Motoshi NAKAYAMA, Fukushima (JP); Sayuri YAMADA, Fukushima (JP); Takuro SHIMADA, Fukushima (JP); Masumi MIYAZAKI, Fukushima (JP); Aya ITO, Tokyo (JP); Tatsuo YOKOTE, Tokyo (JP)

(73) Assignee: AGC Inc., Tokyo (JP)

(21) Appl. No.: 17/448,562

(22) Filed: Sep. 23, 2021

Related U.S. Application Data
(63) Continuation of application No. PCT/JP2020/014814, filed on Mar. 31, 2020.

(30) Foreign Application Priority Data
Apr. 3, 2019 (JP) 2019-071316

(51) Int. Cl. G02B 5/20; C09B 57/00

(52) U.S. Cl. CPC G02B 5/208; C09B 57/007; C09B 57/004

(57) ABSTRACT

An optical filter includes: a resin substrate including a resin (P) which has a glass transition temperature of 200° C. or higher and which has specific transmittance properties; an external resin layer; and dielectric multilayer films. In a case where the external resin layer includes the polyimide resin, the optical filter includes an intermediate resin layer including a cycloolefin resin. At least one of the dielectric multilayer films is a near-infrared reflection layer. At least one of the external resin layer and the intermediate resin layer contains a near-infrared absorbing dye (A). The near-infrared absorbing dye (A) has a maximum absorption wavelength within a wavelength range of 800 nm to 1,200 nm. The proportion of a total thickness of members including a resin having a glass transition temperature of 200° C. or higher to a total thickness of the resin-including members is 85% or higher.

### TECHNICAL FIELD

The present invention relates to an optical filter capable of transmitting light having wavelengths in a visible range and cutting off light having wavelengths in a near-infrared range, and an imaging device including the optical filter.

### BACKGROUND ART

In an imaging device using a solid-state image sensing device, an optical filter capable of transmitting light in the visible region (hereinafter, sometimes referred to as “visible light”) and blocking light in the near-infrared region (hereinafter, sometimes referred to as “near-infrared light”) is used so as to successfully reproduce a color tone and obtain a clean image. Known as the optical filter is a near-infrared cut filter which includes a glass substrate and includes an absorption layer and a reflection layer disposed on the glass substrate, the absorption layer including a near-infrared absorbing dye and a resin and the reflection being constituted of a dielectric multilayer film for cutting off near-infrared light.

With the recent progress toward miniaturization and weight reduction in imaging devices, a near-infrared cut filter including no glass substrate has come to be required. For example, Patent Literature 1 describes a near-infrared cut filter composed of a transparent resin film containing a near-infrared absorber and a dielectric multilayer film.

Patent Literature 2 describes a selectively light-transmitting filter which includes a resin sheet and an optical multilayer film that is an inorganic multilayer film reflecting infrared light and in which the resin sheet is composed of a support film and a resin layer containing a dye having an absorption maximum in a wavelength range of 600 to 800 nm. In Patent Literature 2, fluorinated aromatic polymers, poly(amide)imide resins, polyamide resins, aramid resins, polycycloolefin resins, etc. are used for the resin layer and the support film.

Meanwhile, optical filters including a dielectric multilayer film are known to have problems such as a light leakage problem in which the optical filter has an increased transmittance for near-infrared light entering at a high incident angle and having longer wavelengths. Patent Literature 3, for example, describes, in order to overcome that problem, an optical filter including a transparent resin layer containing both a dye having an absorption maximum in a wavelength range of 650 to 760 nm and a dye having an absorption maximum in a wavelength range of 1,050 to 1,200 nm and a dielectric multilayer film. Patent Literature 3 describes a configuration in which the transparent resin layer is composed of a transparent resin substrate and a resin layer which contains the dyes and is formed on a main surface of the transparent resin substrate.

### CITATION LIST

### Patent Literature

Patent Literature 1: International Publication WO 2014/192714

Patent Literature 2: JP 2013-228759 A

Patent Literature 3: International Publication WO 2018/043564

### SUMMARY OF INVENTION

### Technical Problem

It is difficult to provide the infrared absorption filters of Patent Literatures 1 and 2 as optical filters having excellent visible-light transmittances because of the absorption by the transparent resin films themselves. The infrared absorption filters of Patent Literatures 1 and 2 do not employ a dye which absorbs near-infrared light having wavelengths in a longer-wavelength range. It is, however, presumed that even in cases when a dye which absorbs longer-wavelength near-infrared light is used in order to overcome the problem of the leakage of longer-wavelength light, it is difficult to provide an optical filter having excellent visible-light transmittances likewise because of the absorption by the transparent resin film itself. The optical filter of Patent Literature 3 also cannot be always provided as an optical filter having excellent visible-light transmittances because of the absorption by the transparent resin film itself.

Furthermore, in these optical filters, which have configurations in which a dielectric multilayer film is in contact with a resin layer, there have been problems in that adhesion between the dielectric multilayer film and the resin layer is insufficient and the resin layer has insufficient heat resistance so that thermal deformation occurs, etc.

An object of the present invention is to provide: an optical filter which is a near-infrared cut filter employing a combination of a resin layer constituted of a resinous material containing a near-infrared absorbing dye, a resin substrate, and dielectric multilayer films and which has high transparency to visible light and the property of highly shielding near-infrared light, in particular, near-infrared light having longer wavelengths, and has excellent adhesion between a resin layer and a dielectric multilayer film and excellent heat resistance with diminished thermal deformation; and an imaging device which includes the optical filter and is excellent in terms of color reproducibility and heat resistance.

### Solution to Problem

An optical filter according to one aspect of the present invention, includes: a resin substrate including a resin (P) which has a glass transition temperature of 200° C. or higher and which, when having a thickness of 100 μm, has an average internal transmittance in a 350-450 nm wavelength range of 95% or higher and a minimum internal transmittance in a 400-450 nm wavelength range of 97% or higher in a spectral transmittance curve over a wavelength range of 350 nm to 1,100 nm; an external resin layer that is disposed on at least one of main surfaces of the resin substrate and that includes at least one of a polyimide resin and an alicyclic epoxy resin; and dielectric multilayer films disposed as outermost layers on both main surfaces of the resin substrate, in which: in a case where the external resin layer includes the polyimide resin, the optical filter includes an intermediate resin layer including a cycloolefin resin, the intermediate resin layer being disposed between the resin substrate and the external resin layer; at least one of the dielectric multilayer films is a near-infrared reflection layer; at least one of the external resin layer and the intermediate resin layer contains a near-infrared absorbing dye (A); the near-infrared absorbing dye (A), when examined in a resin included in the resin layer containing the near-infrared absorbing dye (A), has a maximum absorption wavelength λ_{max(A)TR} within a wavelength range of 800 nm to 1,200 nm in a spectral transmittance curve over a wavelength range of 400 nm to 1,200 nm; and the optical filter has a proportion of a total thickness of members including a resin having a glass transition temperature of 200° C. or higher to a total thickness of the resin-including members of 85% or higher.

The present invention also provides an imaging device including the optical filter according to the present invention.

### Advantageous Effects of Invention

The present invention can provide: an optical filter which is a near-infrared cut filter employing a combination of a resin layer constituted of a resinous material containing a near-infrared absorbing dye, a resin substrate, and dielectric multilayer films and which has high transparency to visible light and the property of highly shielding near-infrared light, in particular, near-infrared light having longer wavelengths, and has excellent adhesion between the resin layer and each dielectric multilayer film and excellent heat resistance with diminished thermal deformation; and an imaging device which includes the optical filter and is excellent in terms of color reproducibility and heat resistance.

### BRIEF DESCRIPTION OF DRAWINGS

FIG. 1 is a cross-sectional diagram schematically illustrating an example of the optical filter according to one embodiment.

FIG. 2 is a cross-sectional diagram schematically illustrating another example of the optical filter according to one embodiment.

FIG. 3 is a diagram illustrating spectral transmittance curves of the optical filter of Example.

### DESCRIPTION OF EMBODIMENTS

Embodiments of the present invention are described below.

In the present description, a near-infrared absorbing dye and an ultraviolet absorbing dye are sometimes simply referred to as “NIR dye” and “UV dye”, respectively.

In the present description, a compound represented by formula (I) is referred to as a compound (I), and the same holds true for compounds represented by other formulae. A dye including a compound (I) is sometimes referred to as a dye (I), and the same holds true for other dyes. For example, a compound represented by formula (Asi), which will be described later, is referred to as a compound (Asi), and a dye including the compound is sometimes referred to as a dye (Asi). Furthermore, a group represented by, for example, formula (1x) is sometimes referred to as a group (1x), and the same holds true for groups represented by other formulae.

In the present description, an internal transmittance is a transmittance obtained by subtracting an effect of interface reflection from a measured transmittance and represented by the formula (measured transmittance)/(100−reflectance). In the present description, the spectra of transmittance of the resin substrate and transmittance of layers of dye-containing resins, including the external resin layer and intermediate resin layer both containing a dye, all are “internal transmittance” even when it is referred to as “transmittance”. On the other hand, a transmittance as measured by examining a dye in the state of having been dissolved in a solvent, e.g., dichloromethane, and a transmittance of an optical filter having a dielectric multilayer film are a measured transmittance.

In the present description, with respect to a specific wavelength region, for example, the expression “the transmittance is 90% or more” means that the transmittance is not less than 90% throughout the entire wavelength range, i.e., a minimum transmittance in the wavelength range is 90% or more. Similarly, with respect to a specific wavelength region, for example, the expression “the transmittance is 1% or less” means that the transmittance does not exceed 1% throughout the entire wavelength range, i.e., a maximum transmittance in the wavelength range is 1% or less. The same holds true for internal transmittance. An average transmittance and an average internal transmittance in a specific wavelength region are arithmetic averages of values of transmittance and internal transmittance, respectively, measured at intervals of 1 nm over the wavelength range.

In the present description, each numerical value range expressed using “to” or “-” includes the upper and lower limits.

### <Optical Filter>

The optical filter according to one embodiment of the present invention (hereinafter, sometimes referred to as “the present filter”) includes a resin substrate having the following configuration, an external resin layer disposed on at least one of main surfaces of the resin substrate and including a polyimide resin or an alicyclic epoxy resin, an intermediate resin layer including a cycloolefin resin in the case where the external resin layer includes the polyimide resin, the intermediate resin layer having been disposed between the resin substrate and the external resin layer, and dielectric multilayer films disposed as outermost layers on both main surfaces of the resin substrate, in which at least one of the dielectric multilayer films is a near-infrared reflection layer and an NIR dye (A) having specific optical properties is contained in one or more predetermined resin layers.

The resin substrate in the present filter includes a resin (P) having a glass transition temperature of 200° C. or higher as a main component. The resin (P) has, in a spectral transmittance curve over a wavelength range of 350 to 1,100 nm when the thickness is 100 μm, has an average internal transmittance in a 350-450 nm wavelength range of 95% or higher and a minimum internal transmittance in a 400-450 nm wavelength range of 97% or higher.

In the present filter, at least one of the external resin layer and the intermediate resin layer contains an NIR dye (A). The NIR dye (A), when examined in the resin included in the resin layer containing the NIR dye (A), has a maximum absorption wavelength λ_{max(A)TR} in a wavelength range of 800 to 1,200 nm in a spectral transmittance curve over a wavelength range of 400 to 1,200 nm.

In the case where the external resin layer includes an alicyclic epoxy resin, the present filter may or may not have an internal resin layer including a cycloolefin resin, between the resin substrate and the external resin layer. In the case where the present filter has the external resin layer including an alicyclic epoxy resin, the NIR dye (A) may be contained in either the external resin layer or the intermediate resin layer. According to need, the NIR dye (A) may be contained in both the external resin layer and the intermediate resin layer.

In the case where the external resin layer includes a polyimide resin, the present filter includes an intermediate resin layer including a cycloolefin resin and disposed between the resin substrate and the external resin layer. In this case, the NIR dye (A) is contained in the intermediate resin layer.

In the present filter including those constituent elements, the proportion of a total thickness of members each including a resin having a glass transition temperature of 200° C. or higher to a total thickness of resin-including members is 85% or higher. The resin-including members include the resin substrate, the external resin layer, and the intermediate resin layer. The members each including a resin having a glass transition temperature of 200° C. or higher include the resin substrate. The external resin layer and the intermediate resin layer each can be a layer including a resin having a glass transition temperature of 200° C. or higher or be a layer not containing such resin.

For example, in the case where the present filter includes only the resin substrate, external resin layer, and intermediate resin layer as the resin-including members and where only the resin substrate includes a resin having a glass transition temperature of 200° C. or higher, then the proportion of the thickness of the resin substrate to the total thickness of the resin substrate, external resin layer, and intermediate resin layer is 85% or higher.

Since the resin substrate includes the resin (P) as a main component and the NIR dye (A) is contained in one or more specific resin layers, the present filter can have high transparency to visible light and have the property of highly shielding near-infrared light, in particular, near-infrared light having longer wavelengths. In the present filter, at least one of the dielectric multilayer films is a near-infrared reflection layer. This configuration in which one or more specific resin layers contain the NIR dye (A) enables the present filter to mitigate the leakage of light having longer wavelengths through the dielectric multilayer films and attain the property of highly shielding near-infrared light.

In the present filter, the external resin layer having the configuration described above has excellent adhesion to the dielectric multilayer film. Furthermore, since the resin members including a resin having a glass transition temperature of 200° C. or higher have a thickness within the range shown above, it is possible to provide the optical filter having excellent heat resistance with diminished thermal deformation. Moreover, since the present filter is inhibited from thermally deforming, the dielectric multilayer films can be inhibited from peeling off even in the case where the dielectric multilayers films are formed so as to be in contact with a resin member.

It is preferable that the present filter further contains an NIR dye (B) having the following optical properties. The NIR dye (B) is contained, for example, in the external resin layer or the intermediate resin layer. According to need, the NIR dye (B) may be contained in the resin substrate. The NIR dye (B), when examined in a resin included in the resin layer containing the NIR dye (B), has a maximum absorption wavelength λ_{max(B)TR} in a wavelength range of 680 to 760 nm in a spectral transmittance curve over a wavelength range of 400 to 1,200 nm.

In the case where the present filter include the NIR dye (B), the influence of the incident-angle dependence of the dielectric multilayer films can be reduced. The NIR dye (A) and the NIR dye (B) may be contained in the same resin layer so long as those requirements are satisfied. From the standpoint of the degree of freedom of designing the present filter, it is preferable that the NIR dye (A) and the NIR dye (B) are contained in different resin layers.

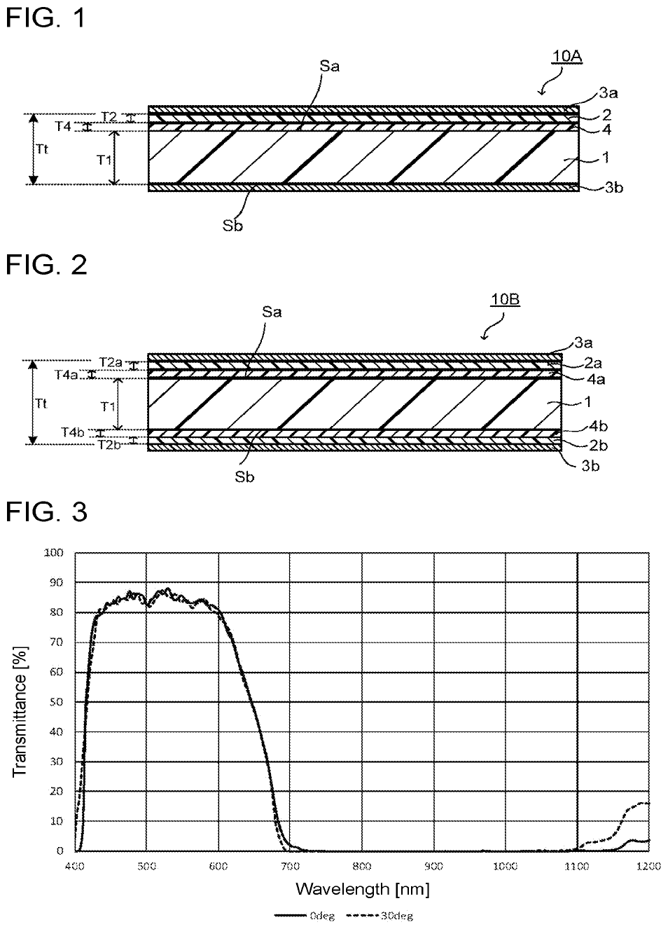

Configuration examples of the present filter are described using the drawings. FIG. 1 and FIG. 2 are cross-sectional diagrams schematically illustrating an example and another example of the optical filter according to one embodiment. The present filter may have the external resin layer on one main surface of the resin substrate or on each of both main surfaces. In the case where the external resin layer includes a polyimide resin, an intermediate resin layer is disposed between the resin substrate and the external resin layer. In the case where the external resin layer includes an alicyclic epoxy resin, the presence of the intermediate resin layer is optional.

The optical filter 10A illustrated in FIG. 1 is an example including an intermediate resin layer 4 and an external resin layer 2 which have been disposed in this order on one main surface Sa of a resin substrate 1. The optical filter 10B illustrated in FIG. 2 is an example including a first intermediate resin layer 4a and a first external resin layer 2a which have been disposed in this order on one main surface Sa of a resin substrate 1 and further including a second intermediate resin layer 4b and a second external resin layer 2b which have been disposed in this order on the other main surface Sb. The expression “including a specific layer provided on one main surface Sa of a resin substrate 1” means not only a case where said layer is in contact with the main surface Sa of the resin substrate 1 but also a case where another functional layer has been disposed between the resin substrate 1 and said layer.

The optical filter 10A illustrated in FIG. 1 includes: a resin substrate 1 having a first main surface Sa and a second main surface Sb which face each other; an intermediate resin layer 4 and an external resin layer 2 which have been disposed in this order on the first main surface Sa of the resin substrate 1; a first dielectric multilayer film 3a disposed as an outermost layer on the external resin layer 2 disposed on the first main surface Sa of the resin substrate 1; and a second dielectric multilayer film 3b disposed as an outermost layer on the second main surface Sb of the resin substrate 1.

In the optical filter 10A, the resin substrate 1 includes a resin (P) as a main component. The intermediate resin layer 4 and the external resin layer 2 respectively contain the specific resins, and at least one of the resin layers contains an NIR dye (A) in accordance with the kinds of the resins as specified above. In the case where the external resin layer 2 is a resin layer including an alicyclic epoxy resin, the optical filter 10A may not include the intermediate resin layer 4.

In a preferred embodiment of the optical filter 10A, at least one of the intermediate resin layer 4 and the external resin layer 2 contains an NIR dye (B). In this case, it is preferable that the intermediate resin layer 4 contains the NIR dye (A) and the external resin layer 2 contains the NIR dye (B). At least one of the intermediate resin layer 4 and the external resin layer 2 may contain a dye which absorbs light having wavelengths in a range other than the near-infrared region, e.g., a UV dye.

In the optical filter 10A, either the first dielectric multilayer film 3a or the second dielectric multilayer film 3b is a near-infrared reflection layer. The other may or may not be a near-infrared reflection layer. Examples of the dielectric multilayer film other than a near-infrared reflection layer include an antireflection layer and a reflection layer reflecting light having wavelengths in a range other than the near-infrared and visible-light regions. The near-infrared reflection layer may reflect light having wavelengths in a range other than the near-infrared and visible-light regions.

The first dielectric multilayer film 3a and the second dielectric multilayer film 3b may be the same or different. For example, the optical filter 10 may have a configuration in which the first dielectric multilayer film 3a and the second dielectric multilayer film 3b are each a near-infrared reflection layer that has the property of reflecting near-ultraviolet light and near-infrared light and transmitting visible light and in which the first dielectric multilayer film 3a reflects near-ultraviolet light and light having wavelengths in a first near-infrared range and the second dielectric multilayer film 3b reflects near-ultraviolet light and light having wavelengths in a second near-infrared range.

The optical filter 10B illustrated in FIG. 2 includes: a resin substrate 1 having a first main surface Sa and a second main surface Sb which face each other; a first intermediate resin layer 4a and a first external resin layer 2a which have been disposed in this order on the first main surface Sa of the resin substrate 1; a second intermediate resin layer 4b and a second external resin layer 2b which have been disposed in this order on the second main surface 2b of the resin substrate 1; a first dielectric multilayer film 3a disposed as an outermost layer on the first external resin layer 2a disposed on the first main surface Sa of the resin substrate 1; and a second dielectric multilayer film 3b disposed as an outermost layer on the second external resin layer 2b disposed on the second main surface Sb of the resin substrate 1.

In the optical filter 10B, the resin substrate 1 includes the resin (P) as a main component. The first dielectric multilayer film 3a and the second dielectric multilayer film 3b can have the same configurations as in the optical filter 10A. In the optical filter 10B, in the case where the first external resin layer 2a is a resin layer including an alicyclic epoxy resin, the presence of the first intermediate resin layer 4a is optional. Similarly, in the case where the second external resin layer 2b is a resin layer including an alicyclic epoxy resin, the presence of the second intermediate resin layer 4b is optional.

In the optical filter 10B, an NIR dye (A) is contained in at least one resin layer selected from the group consisting of the first intermediate resin layer 4a, the second intermediate resin layer 4b, and the first external resin layer 2a and second external resin layer 2b which each include an alicyclic epoxy resin. In the case where the optical filter 10B contains an NIR dye (B), the NIR dye (B) is contained in at least one resin layer selected from the group consisting of the first intermediate resin layer 4a, the second intermediate resin layer 4b, the first external resin layer 2a, and the second external resin layer 2b. The first intermediate resin layer 4a and the second intermediate resin layer 4b may be the same or different. Similarly, the first external resin layer 2a and the second external resin layer 2b may be the same or different.

In the case where the optical filter 10B contains both an NIR dye (A) and an NIR dye (B), it is preferable that the first intermediate resin layer 4a or the second intermediate resin layer 4b contains the NIR dye (A) and the first external resin layer 2a or the second external resin layer 2b contains the NIR dye (B). At least one of these four resin layers may contain a dye which absorbs light having wavelengths in a range other than the near-infrared region, e.g., a UV dye.

In the present filter, the proportion of the total thickness of members each including a resin having a glass transition temperature of 200° C. or higher to the total thickness of resin-including members is 85% or higher. In the optical filter 10A, the resin-including members are the resin substrate 1, the intermediate resin layer 4, and the external resin layer 2, and the thicknesses of these are expressed by T1, T4, and T2, respectively. The total thickness of the resin-including members is Tt=T1+T4+T2. In the optical filter 10A, in the case where the resin substrate 1 is the only member including a resin having a glass transition temperature of 200° C. or higher, the following relationship is satisfied: T1/Tt×100 [%]≥85%.

In the optical filter 10B, the resin-including members are the resin substrate 1, the first intermediate resin layer 4a, the first external resin layer 2a, the second intermediate resin layer 4b, and the second external resin layer 2b, and the thicknesses of these are expressed by T1, T4a, T2a, T4b, and T2b, respectively. The total thickness of the resin-including members is Tt=T1+T4a+T2a+T4b+T2b. In the optical filter 10B, in the case where the resin substrate 1 is the only member including a resin having a glass transition temperature of 200° C. or higher, the following relationship is satisfied: T1/Tt×100 [%]≥85%.

In the present filter, the proportion of the total thickness of members each including a resin having a glass transition temperature of 200° C. or higher to the total thickness of resin-including members is preferably 90% or higher, more preferably 92% or higher, still more preferably 93% or higher, especially preferably 96% or higher.

The resin substrate, intermediate resin layer, external resin layer, and dielectric multilayer films which constitute the present filter are described below.

### [Resin Substrate]

The resin substrate includes, as a main component, a resin (P) having a glass transition temperature (hereinafter, sometimes referred to as “Tg”) of 200° C. or higher and having the predetermined optical properties shown below.

Tg is determined by DSC measurement (differential scanning calorimetry). The expression “a resin substrate includes a resin (P) as a main component” means that the percentage of the resin (P) in the resin substrate is 90 mass % or more. From the standpoints of Tg and high transparency to visible light, the percentage of the resin (P) in the resin substrate is preferably 95 mass % or more, and it is particularly preferable that the resin substrate is composed of the resin (P).

In the case where the Tg of the resin (P) is 200° C. or higher, the resin substrate is less apt to be deformed by heat or stress and enables the dielectric multilayer films in the present filter to have excellent adhesion. The Tg is preferably 210° C. or higher, more preferably 220° C. or higher. There is no particular upper limit on the Tg, but the Tg of the resin (P) is preferably 400° C. or lower from the standpoints of forming processability, etc.

The predetermined optical properties to be possessed by the resin (P) are that the resin (P), in a spectral transmittance curve over a wavelength range of 350 to 1,100 nm when a thickness is 100 μm, satisfies the following requirements (T-1) and (T-2).

(T-1) To have an average internal transmittance in a 350-450 nm wavelength range (hereinafter referred to as “T_{350-450ave(TR)}”) of 95% or higher.

(T-2) To have a minimum internal transmittance in a 400-450 nm wavelength range (hereinafter referred to as “T_{400-450min(TR)}”) of 97% or higher.

It is preferable that, in the spectral transmittance curve over a wavelength range of 350 to 1,100 nm when the thickness is 100 μm, the resin (P) satisfies the following requirement (T-3) in addition to (T-1) and (T-2).

(T-3) In the wavelength range up to 500 nm, the internal transmittance is 90% at a wavelength (hereinafter referred to as “λᵤᵥ₉₀”) which is 350 nm or less.

So long as the resin (P) satisfies the requirements (T-1) and (T-2), the present filter has high visible-light transmittances. In the case where the resin (P) further satisfies the requirement (T-3), the present filter has higher visible-light transmittances.

In the resin (P), T_{350-450ave(TR)} is preferably 97% or higher, more preferably 98% or higher, and T_{400-450min(TR)} is preferably 97.5% or higher, more preferably 98% or higher. λᵤᵥ₉₀ is preferably 340 nm or less.

The kind of resin (P) is not particularly limited so long as the resin (P) satisfies the Tg and the given requirements regarding optical properties. Preferred are one or more resins selected from the group consisting of polyimide and polycarbonate resins satisfying those requirements.

A preferred range of the Tg of the resin (P) varies depending on resins. In the case of polyimide resins, the Tg is preferably 200° C. to 400° C., more preferably 200° C. to 350° C. In the case of polycarbonate resins, the Tg is preferably 200° C. to 300° C., more preferably 200° C. to 250° C.

It is preferable that the resin (P) includes at least one resin selected from the group consisting of polyimide resins and polycarbonate resins, and that the resin (P) has a value of T_{350-450ave(TR)} of 98% or higher, a value of T_{400-450min(TR)} of 98% or higher, and λᵤᵥ₉₀ of 340 nm or less.

Examples of the polyimide resins usable as the resin (P) include the known transparent polyimide compounds described in JP 2013-228759 A or International Publication WO 2013/146460 which are resins satisfying those requirements for the resin (P).

Specific examples of structures include the structures of typical transparent polyimides obtained by polycondensation (imide bonding) of tetracarboxylic acids or dianhydrides thereof with diamines, and more specifically include a polyimide resin (TR-1) represented by the following formula (TR-1).

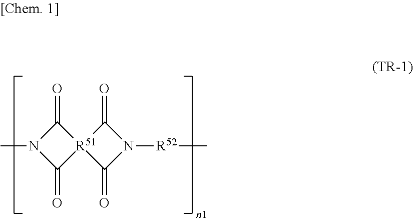

In formula (TR-1), R⁵¹ is a C₄-C₁₀ tetravalent group including a cyclic structure, an acyclic structure, or both a cyclic structure and an acyclic structure. R⁵² is a C₂-C₃₉ divalent group which includes at least one group selected from the group consisting of aliphatic hydrocarbon groups, alicyclic hydrocarbon groups, aromatic hydrocarbon groups, and organosiloxane groups and in which at least one group selected from the group consisting of —O—, SO₂—, —CO—, —CH₂—, —C(CH₃)₂—, —C₂H₄O—, and —S— may intervene in a main chain of R⁵². Symbol n1 indicates that the structure is a repeating unit, and n1 is appropriately adjusted in accordance with the physical properties required.

Preferred examples of R⁵¹ in formula (TR-1) include tetravalent groups formed by removing four hydrogen atoms from each of cyclohexane, cyclopentane, cyclobutane, bicyclopentane, bicyclooctane, and stereoisomers thereof, and more specifically include the tetravalent groups represented by the following structural formulae.

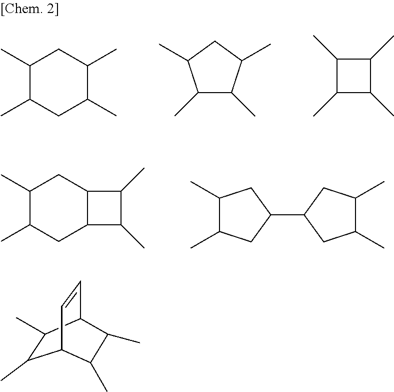

Examples of commercially available polyimide resin films usable as the resin (P) include NEOPRIM (registered trademark) L-3G30 (trade name, produced by Mitsubishi Gas Chemical Company, Inc.) (this polyimide resin film may contain silica), etc. The resin (P) may be produced from a polyimide resin varnish, and examples of usable polyimide resin varnishes include NEOPRIM (registered trademark) C-3G30 (trade name, produced by Mitsubishi Gas Chemical Company, Inc.).

Examples of the polycarbonate resins usable as the resin (P) include the known transparent polycarbonate compounds described in JP-A-2001-296423 which are resins satisfying the requirements for the resin (P).

Examples of polycarbonate resins that can satisfy the requirements for the resin (P) include the structures of typical transparent polycarbonate resins obtained by polymerizing diol components of a bisphenol structure with carbonate-forming components, e.g., phosgene compounds and carbonates such as diphenyl carbonate. More specific examples thereof include a polycarbonate resin (TR-2) represented by the following formula (TR-2). Formula (TR-2) shows a copolymer and/or blend of two units each enclosed in square brackets ([ ]).

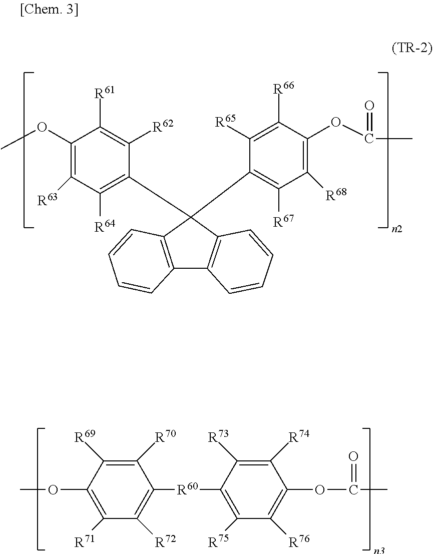

In formula (TR-2), R⁶¹ to R⁶⁸ are each independently a hydrogen atom, a halogen atom, or a C₁-C₆ monovalent hydrocarbon group. R⁶⁹ to R⁷⁶ are each independently a hydrogen atom, a halogen atom, or a C₁-C₂₂ monovalent hydrocarbon group. R⁶⁰ is a divalent group represented by any of the following structural formulae.

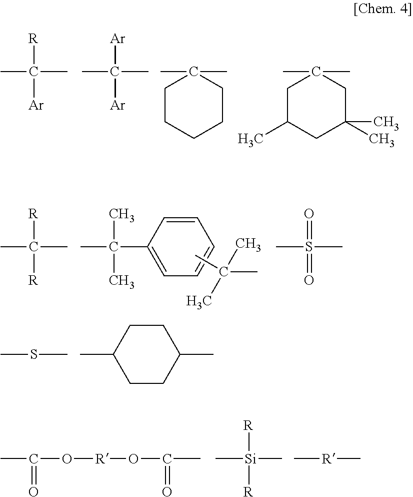

R moieties are each independently a hydrogen atom, a halogen atom, or a C₁-C₂₂ monovalent hydrocarbon group, R′ moieties are each independently a C₁-C₂₀ divalent hydrocarbon group, and Ar is a C₆-C₁₀ aryl group. Symbols n2 and n3 are each the proportion in mol % of the unit in the copolymer and/or blend; n2 is 30 to 90 mol % and n3 is 70 to 10 mol %.

Examples of commercially available polycarbonate resins usable as the resin (P) include PURE-ACE (registered trademark) M5 (trade name, produced by Teij in Limited), PURE-ACE (registered trademark) S5 (trade name, produced by Teijin Limited), etc.

The resin substrate includes the resin (P) as a main component. The resin substrate may contain, if desired, optional components in an amount of, for example, 10 mass % or less, unless the inclusion thereof does not lessen the effects of the present invention. Examples of the optional components include adhesion-imparting agents, leveling agents, antistatic agents, heat stabilizers, light stabilizers, antioxidants, dispersing agents, flame retardants, lubricants, plasticizers, etc.

It is preferable that, like the resin (P), the resin substrate including the resin (P) as a main component has a Tg of 200° C. or higher and, in a spectral transmittance curve over a wavelength range of 350 to 1,100 nm when a thickness is 100 μm, has an average internal transmittance in a 350-450 nm wavelength range of 95% or higher and a minimum internal transmittance in a 400-450 nm wavelength range of 97% or higher. It is more preferable that a wavelength which is within a wavelength range of 500 nm or less and at which the internal transmittance is 90% is 350 nm or less. It is more preferable that the resin substrate has an average internal transmittance in a 350-450 nm wavelength range of 98% or higher and a minimum internal transmittance in a 400-450 nm wavelength range of 98% or higher, and a wavelength which is within a wavelength range of 500 nm or less and at which the internal transmittance is 90% is 340 nm or less. Preferred ranges of the Tg and of those optical properties can be the same as those for the resin (P).

The thickness of the resin substrate is preferably 20 μm to 110 μm, so long as the resin substrate satisfies the requirement for the present filter (hereinafter sometimes referred to as “requirement concerning thickness proportions of resin members”) that the proportion of the total thickness of members including a resin having a Tg of 200° C. or higher to the total thickness of resin-including members should be 85% or higher. In the case where the thickness of the resin substrate is 20 μm or larger, it is easy to make the present filter have sufficient strength. In the case where the thickness thereof is 110 μm or less, it is easy to enable the present filter to have high transparency to visible light. The thickness of the resin substrate is preferably 40 μm or larger, more preferably 60 μm or larger. The thickness of the resin substrate is preferably 100 μm or less, more preferably 90 μm or less.

The resin substrate can be produced, for example, by the following method. The resin substrate can be produced by melt-extruding either the resin (P) or a mixture of the resin (P) and optional components into a film shape. Alternatively, the resin substrate can be produced by dissolving the resin (P) in a solvent together with optional ingredients, if desired, to prepare a coating solution, applying the solution in a desired thickness to a releasable base material for resin substrate production, drying the applied solution, curing the dried coating film if necessary, and then separating the resin substrate from the base material.

The solvent to be used for the coating solution is only required to be either a dispersion medium in which the resin (P) can be stably dispersed or a solvent in which the resin (P) can be stably dissolved. The coating solution may contain a surfactant for mitigating troubles such as voids due to microbubbles, dents due to adhesion of foreign substances, and cissing in a drying step. Furthermore, for applying the coating solution, use can be made, for example, of a dip coating method, a cast coating method, a die coating method, a spin coating method, etc.

### [External Resin Layer]

The external resin layer includes a polyimide resin or an alicyclic epoxy resin. Because of the inclusion of these resins, the external resin layer has excellent adhesion to the dielectric multilayer film. From the standpoint of adhesion to the dielectric multilayer film, it is preferable that the present filter includes the external resin layer on each of both main surfaces of the resin substrate.

The external resin layer may include either a polyimide resin or an alicyclic epoxy resin or may include both. Usually, the external resin layer includes either of these. These resins are included as a main component of resin components in the external resin layer, and the content thereof in the resin components is preferably 90 mass % or higher, more preferably 95 mass % or higher, especially preferably 100%.

The external resin layer, for example, contains dyes such as an NIR dye (A) and an NIR dye (B) besides the resin components in the proportions which will be described later, in accordance with the design of the present filter and the kind of the included resin. The external resin layer may further contain any desired additives such as, for example, an adhesion-imparting agent, a leveling agent, an antistatic agent, a heat stabilizer, a light stabilizer, an antioxidant, a dispersing agent, a flame retardant, a lubricant, and a plasticizer in an amount of, for example, 10 mass % or less, unless the inclusion thereof lessens the effects of the present invention.

In the case where the resin included in the external resin layer is a polyimide resin, the polyimide resin has a Tg of preferably 200° C. or higher, more preferably 250° C. or higher, from the standpoint of the shape stability of the present filter, as in the case of the resin substrate. When the preferred requirements are satisfied, the dielectric multilayer film in the present filter can have further improved adhesion. Although there is no particular upper limit on the Tg of the polyimide resin, the Tg thereof is preferably 400° C. or lower from the standpoints of forming processability, etc. So long as the Tg of the resin is 200° C. or higher, the external resin layer containing a dye has excellent heat resistance which enables the dye to retain the optical properties in high-temperature use.

Preferred examples of the polyimide resin are the polyimide resins described above as examples of the resin (P) of the resin substrate, and especially preferred is the polyimide resin (TR-1). Examples of commercial polyimide resins usable for the external resin layer include the following ones available in the form of varnish: NEOPRIM (registered trademark) C-3650 (trade name, produced by Mitsubishi Gas Chemical Company, Inc.), NEOPRIM (registered trademark)C-3G30 (trade name, produced by Mitsubishi Gas Chemical Company, Inc.), NEOPRIM (registered trademark) C-3450 (trade name, produced by Mitsubishi Gas Chemical Company, Inc.), NEOPRIM (registered trademark) P-500 (trade name, produced by Mitsubishi Gas Chemical Company, Inc.), and JL-20 (trade name, produced by New Japan Chemical Co., Ltd.). These polyimide resin varnishes may contain silica.

In the case where the resin included in the external resin layer is a polyimide resin, the intermediate resin layer contains an NIR dye (A). In this case, in the case where the present filter further contains an NIR dye (B), it is preferable that the NIR dye (B) is contained in the external resin layer. It is preferable that the polyimide resin used in the external resin layer, when containing the NIR dye (B) dissolved therein, has optical properties that satisfy the given requirements which will be described later.

Examples of the alicyclic epoxy resin used in the external resin layer include alicyclic epoxy resins obtained by curing alicyclic epoxy compounds with a curing catalyst. The alicyclic epoxy resin preferably has a Tg of 100° C. or higher, more preferably 120° C. or higher.

Preferred as the alicyclic epoxy resin is, for example, the alicyclic epoxy resin described in JP 2017-149896 A, which is obtained by curing a composition including an alicyclic epoxy compound, a curing catalyst, and a mercapto group-containing compound, from the standpoints of transparency and adhesion. This alicyclic epoxy resin is preferred also from the standpoint that cationically curable epoxy groups bring about less polymerization shrinkage and are less apt to warp the film than radical-curable groups such as acrylic, methacrylic, and vinyl groups. The following explanation is given using as an example the alicyclic epoxy resin described in JP 2017-149896 A, but the alicyclic epoxy resin to be used in the present filter is not limited thereto.

An alicyclic epoxy compound is a compound having an alicyclic epoxy group. A preferred alicyclic epoxy compound is one obtained by causing epoxy rings of an epoxy compound to undergo ring-opening polymerization using an alcohol.

Specific examples thereof include vinylcyclohexene diepoxide adducts of alcohols, 3′,4′-epoxycyclohexylmethyl 3,4-epoxycyclohexanecarboxylate adducts of alcohols, bis-3,4-epoxycyclohexylmethyl adipate adducts of alcohols, dicyclopentadiene diepoxide adducts of alcohols, ε-caprolactone-modified bis(3,4-epoxycyclohexylmethyl)-4,5-epoxycyclohexane-1,2-di carboxylic acid adducts of alcohols, √-caprolactone-modified tetra(3,4-epoxycyclohexylmethyl)butane-tetracarboxylic acid adducts of alcohols, dipentene dioxide adducts of alcohols, 1,4-cyclooctadiene diepoxide adducts of alcohols, and bis(2,3-epoxycyclopentyl) ether adducts of alcohols. One of these can be used alone, or two or more thereof can be used in combination.

Preferred of these alicyclic epoxy compounds are the vinylcyclohexene diepoxide adducts of alcohols. More preferred are vinylcyclohexene diepoxide adducts of 2,2-bis(hydroxymethyl)-1-butanol. Especially preferred is a 1,2-epoxy-4-(2-oxiranyl)cyclohexane adduct of 2,2-bis(hydroxymethyl)-1-butanol.

Such alicyclic epoxy compounds can be produced by known methods, and commercially available products can also be used. Examples of the commercially available products include Celloxide (registered trademark) 2021P, Celloxide (registered trademark) 2081, and EHPE3150 (all produced by Daicel Ltd.). Among these, preferred is EHPE3150 (weight-average molecular weight: 2,400), which is a 1,2-epoxy-4-(2-oxiranyl)cyclohexane adduct of 2,2-bis(hydroxymethyl)-1-butanol.

The curing catalyst may be appropriately selected in accordance with the kind of the alicyclic epoxy compound, etc. The curing catalyst may be one in common use, and in the case of performing thermal curing, examples thereof include a thermally latent cationic curing catalyst, a thermally latent radical curing catalyst, an acid anhydride-based catalyst, a phenol-based catalyst, and an amine-based catalyst. Especially preferred as the curing catalyst are cationic curing catalysts.

The cationic curing catalysts preferably are Lewis acids including a boron compound and an aromatic fluorine compound. Preferred specific examples of such Lewis acids include tris(pentafluorophenyl)borane, bis(pentafluorophenyl)phenylborane, pentafluorophenyl-diphenylborane, and tris(4-fluorophenyl)borane. Among these, more preferred are tris(pentafluorophenyl)borane and bis(pentafluorophenyl)phenylborane, from the standpoint that these Lewis acids can improve the heat resistance, moist-heat resistance, thermal shock resistance, etc. of the cured object.

The content of such a cationic curing catalyst is preferably regulated to 0.01 to 10 parts by mass per 100 parts by mass of the sum of the alicyclic epoxy compound and the cationic curing catalyst. This not only can bring about a higher curing rate to attain further improved production efficiency but also can more effectively reduce the possibility that the resin might be colored during the curing or upon heating or during use, etc. The content of the cationic curing catalyst is more preferably 0.05 parts by mass or larger, still more preferably 0.1 part by mass or larger, especially preferably 0.2 parts by mass or larger, and is more preferably 5 parts by mass or less, still more preferably 3 parts by mass or less, especially preferably 2 parts by mass or less.

It is considered that mercapto group-containing compounds contribute to improvements in the transparency of the cured object to visible light and improvements in the adhesion thereof. Examples of the mercapto group-containing compounds include mercapto group-containing silane coupling agents, and mercapto group-containing silane coupling agents having alkoxy groups are preferred. More preferred mercapto group-containing silane coupling agents are mercapto group-containing silane coupling agents having methoxy groups. It is preferable that the mercapto group-containing silane coupling agents are chain-shaped (preferably a linear shape with no cyclic structure).

Examples of the mercapto group-containing silane coupling agents include 3-mercaptopropyltrimethoxysilane, 3-mercaptopropyltriethoxysilane, and 3-mercaptopropylmethyldimethoxysilane. Among these, preferred is 3-mercaptopropyltrimethoxysilane, because this silane coupling agent is easily available, has high compatibility in the resin composition, and exhibits high adhesiveness to glass substrates. One mercapto group-containing silane coupling agent may be used alone, or two or more mercapto group-containing silane coupling agents may be used in combination.

The proportion in which the mercapto group-containing silane coupling agent is to be incorporated is preferably 0.1 to 25 parts by mass per 100 parts by mass of the alicyclic epoxy compound. The proportion thereof is more preferably 2 to 20 parts by mass, still more preferably 3 to 20 parts by mass, especially preferably 7 to 18 parts by mass, most preferably 10 to 15 parts by mass. In the case where the proportion of the mercapto group-containing silane coupling agent is within that range, the heat resistance and the adhesion can be enhanced.

In the case where the resin included in the external resin layer is an alicyclic epoxy resin, this external resin layer can contain an NIR dye (A). In this case, it is preferable that the alicyclic epoxy resin, when containing the NIR dye (A) dissolved therein, has optical properties that satisfy the predetermined requirements which will be described later. There is a case where the present filter includes an intermediate resin layer even in cases when the external resin layer includes an alicyclic epoxy resin. In this case, it is preferable that the NIR dye (A) is contained in the intermediate resin layer. In this case, in cases when the present filter further contains an NIR dye (B), it is preferable that the external resin layer contains the NIR dye (B). It is preferable that the alicyclic epoxy resin used in the external resin layer, when containing the NIR dye (B) dissolved therein, has optical properties that satisfy the predetermined requirements which will be described later.

The external resin layer can be formed, for example, by dissolving or dispersing a dye in the case where the external resin layer contains the dye, a resin to be included in the external resin layer or raw-material components for the resin, and various optional components in a solvent to prepare a coating solution, applying the solution to a base material, drying the applied solution, and curing the resultant coating film if necessary. The base material may be the resin substrate which is to be included in the present filter and on which an intermediate resin layer has been formed if desired, or may be a releasable base material for use only in forming the external resin layer. The solvent is not particularly limited so long as the solvent is a dispersion medium or solvent in which those ingredients can be stably dispersed or dissolved.

The coating solution may contain a surfactant for mitigating troubles such as voids due to microbubbles, dents due to adhesion of foreign substances, and cissing in a drying step. Furthermore, for applying the coating solution, use can be made, for example, of a dip coating method, a cast coating method, a die coating method, a spin coating method, etc. After having been applied to the base material, the coating solution is dried, thereby forming the external resin layer. In the case where the coating solution contains raw-material components for a resin such as an alicyclic epoxy resin, a curing treatment such as heat curing or photocuring is further performed.

The external resin layer can be produced also by extrusion molding into a film shape, and this film may be superposed on the resin substrate together with other members, e.g., the intermediate resin layer, and united therewith by hot press bonding, etc.

The thickness of the external resin layer is preferably 0.25 μm to 12 μm, so long as the external resin layer satisfies the requirement concerning thickness proportions of resin members in the present filter. In the case where the thickness of the external resin layer is 0.25 μm or larger, this external resin layer can have sufficient adhesion to the dielectric multilayer film. In the case where the thickness thereof is 12 μm or less, the present filter has high transparency to visible light.

The thickness of the external resin layer is preferably 0.4 μm or larger, more preferably 0.6 μm or larger. The thickness of the external resin layer is preferably 5 μm or less, more preferably 2 μm or less. In the case where there are two external resin layers as in the optical filter 10B illustrated in FIG. 2, the total thickness of the external resin layers is preferably 12 μm or less, more preferably 5 μm or less, still more preferably 3 μm or less. In this case, the thickness of each external resin layer is, for example, preferably 1.5 μm or less, more preferably 1.4 μm or less.

### [Intermediate Resin Layer]

The intermediate resin layer is a resin layer including a cycloolefin resin. In the case where the external resin layer of the present filter is a resin layer including a polyimide resin, the intermediate resin layer is an essential layer. In the case where the external resin layer of the present filter is a resin layer including an alicyclic epoxy resin, the intermediate resin layer is an optional layer although it is preferred to dispose this layer.

In the case where the external resin layer in the present filter includes a polyimide resin, the intermediate resin layer contains an NIR dye (A). In the case where the external resin layer in the present filter includes an alicyclic epoxy resin and where the present filter includes the intermediate resin layer, it is preferable that an NIR dye (A) is contained in the intermediate resin layer. The intermediate resin layer may contain dyes other than the NIR dye (A), such as an NIR dye (B) and a UV dye.

The cycloolefin resin included in the intermediate resin layer, when containing the NIR dye (A) dissolved therein, can have optical properties that readily satisfy the given requirements which will be described later.

The cycloolefin resin included in the intermediate resin layer is a main component of resin components in the intermediate resin layer. The content thereof in the resin components is preferably 90 mass % or higher, more preferably 95 mass % or higher, especially preferably 100 mass %. The cycloolefin resin preferably has a Tg of 130° C. or higher, more preferably 140° C. or higher.

The intermediate resin layer, for example, contains dyes such as an NIR dye (A) and an NIR dye (B) besides the resin components in the proportions which will be described later, in accordance with the design of the present filter and the kind of the included resin. The intermediate resin layer may further contain any desired additives such as, for example, an adhesion-imparting agent, a leveling agent, an antistatic agent, a heat stabilizer, a light stabilizer, an antioxidant, a dispersing agent, a flame retardant, a lubricant, and a plasticizer in an amount of, for example, 10 mass % or less unless the inclusion thereof lessens the effects of the present invention.

The cycloolefin resin to be included in the intermediate resin layer can be produced by a known method. Alternatively, any of the following commercially-available cycloolefin resin products may be used for the intermediate resin layer.

Examples of commercially available cycloolefin resin products include ARTON (registered trademark) F4520 (trade name, produced by JSR Co., Ltd.), ZEONEX (registered trademark) K26R, F52R, and T62R and ZEONOR (registered trademark) 1020R and 1060R (trade names; all produced by Nippon Zeon Co., Ltd.), and APEL (registered trademark) APL5014DP and APL6015T (trade names, both produced by Mitsui Chemicals, Inc.).

The intermediate resin layer can be formed, for example, by dissolving or dispersing a dye, e.g., an NIR dye (A), a cycloolefin resin, and various optional components in a solvent to prepare a coating solution, applying the solution to a base material, and drying the applied solution. The base material may be the resin substrate to be included in the present filter, or may be a releasable base material for use only in forming the intermediate resin layer. The solvent is not particularly limited so long as the solvent is a dispersion medium or solvent in which those ingredients can be stably dispersed or dissolved. Specific methods for forming the intermediate resin layer can be the same as those for the external resin layer.

The thickness of the intermediate resin layer is preferably 0.25 μm to 12 μm, so long as the intermediate resin layer satisfies the requirement concerning thickness proportions of resin members in the present filter. In the case where the thickness of the intermediate resin layer is 0.25 μm or larger, the present filter can have sufficient near-infrared light shielding properties. In the case where the thickness thereof is 12 μm or less, the present filter has high transparency to visible light.

The thickness of the intermediate resin layer is preferably 0.4 μm or larger, more preferably 0.6 μm or larger. The thickness of the intermediate resin layer is preferably 5 μm or less, more preferably 2 μm or less. In the case where there are two intermediate resin layers as in the optical filter 10B illustrated in FIG. 2, the total thickness of the intermediate resin layers is preferably 12 μm or less, more preferably 5 μm or less, still more preferably 3 μm or less. In this case, the thickness of each intermediate resin layer is, for example, preferably 1.5 μm or less, more preferably 1.4 μm or less.

### (NIR Dye (A))

In the present filter, at least one of the external resin layer and the intermediate resin layer contains an NIR dye (A). The NIR dye (A), in a spectral transmittance curve over a wavelength range of 400 to 1,200 nm when examined in a resin included in the resin layer containing the NW dye (A), has a maximum absorption wavelength λ_{max(A)TR} within a wavelength range of 800 to 1,200 nm.

When T_{AVE435-480(A)TR} and T_{AVE490-560(A)TR} are respectively defined as an average internal transmittance for light having wavelengths of 435 to 480 nm and an average internal transmittance for light having wavelengths of 490 to 560 nm in a spectral transmittance curve over a wavelength range of 400 nm to 1,200 nm obtained by examining the NIR dye (A) in a resin included in the resin layer containing the NIR dye (A) while regulating an internal light transmittance to be 10% at the maximum absorption wavelength λ_{max(A)TR}, and T_{AVE435-480(A)DCM} and T_{AVE490-560(A)DCM} are respectively defined as an average internal transmittance for light having wavelengths of 435 to 480 nm and an average internal transmittance for light having wavelengths of 490 to 560 nm in a spectral transmittance curve over a wavelength range of 400 to 1,200 nm obtained by examining the NW dye (A) dissolved in dichloromethane (DCM) while regulating a light transmittance to be 10% at a maximum absorption wavelength λ_{max(A)DCM}, the NW dye (A) satisfies the following relationships:
   |T_{AVE435-480(A)DCM}−T_{AVE435-480(A)TR}| being 5% or less; and
   |T_{AVE490-560(A)DCM}−T_{AVE490-560(A)TR}| being 5% or less.

In the case where the NIR dye (A) has those properties, the optical properties which the NIR dye (A) has in DCM can be similarly exhibited also in the resin. |T_{AVE435-480(A)DCM}−T_{AVE435-480(A)TR}| and |T_{AVE490-560(A)DCM}−T_{AVE490-560(A)TR}| are each more preferably 4% or less, still more preferably 3% or less.

It is also preferable that the NIR dye (A) satisfies the following: when T_{AVE435-480(A)TR}, T_{AVE490-560(A)TR}, T_{435(A)TR}, T_{550(A)TR}, and T_{700(A)TR} are respectively defined as an average internal transmittance for light having wavelengths of 435 to 480 nm, an average internal transmittance for light having wavelengths of 435 to 480 nm, an internal transmittance for light having a wavelength of 435 nm, an internal transmittance for light having a wavelength of 550 nm and an internal transmittance for light having a wavelength of 700 nm in a spectral transmittance curve over a wavelength range of 400 to 1,200 nm obtained by examining the near-infrared absorbing dye (A) in a resin included in the resin layer containing the near-infrared absorbing dye (A) while regulating an internal light transmittance to be 10% at the maximum absorption wavelength λ_{max(A)TR}, the near-infrared absorbing dye (A) satisfies the following relationships: T_{AVE435-480(A)TR} being 88% or higher, T_{AVE490-560(A)TR} being 88% or higher, T_{435(A)TR} being 88.1% or higher, T_{550(A)TR} being 79.4% or higher, and T_{700(A)TR} being 79.4% or higher.

T_{AVE435-480(A)TR} is more preferably 90% or higher, still more preferably 91% or higher.

T_{AVE490-560(A)TR} is more preferably 90% or higher, still more preferably 91% or higher.

T_{435(A)TR} is more preferably 90% or higher, still more preferably 91% or higher.

T_{550(A)TR} is more preferably 90% or higher, still more preferably 91% or higher.

T_{700(A)TR} is more preferably 80% or higher, still more preferably 85% or higher.

It is preferable that the NIR dye (A) specifically is at least one dye selected from the group consisting of squarylium dyes and diketopyrrolopyrrole dyes which satisfy those requirements concerning λ_{max(A)TR}. Examples of the squarylium dyes usable as the NIR dye (A) include compounds represented by the following formula (ASi), compounds represented by the following formula (ASii), and compounds represented by the following formula (ASiii). Examples of the diketopyrrolopyrrole dyes include compounds represented by formula (AD) which will be described layer.

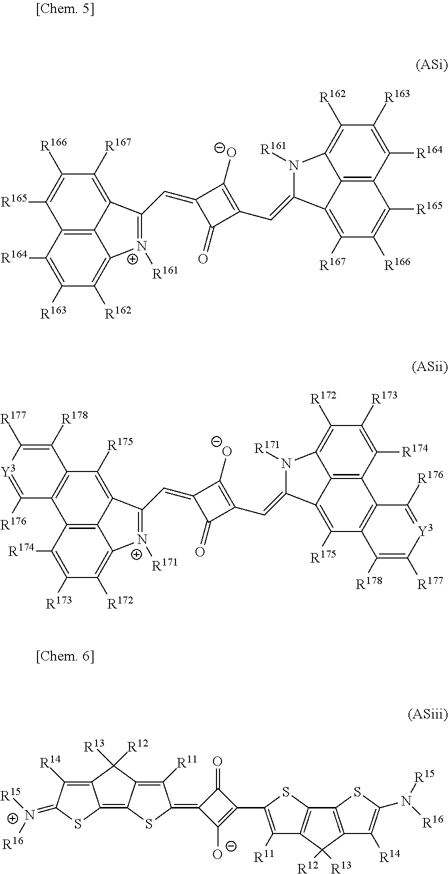

The symbols in formulae (ASi) to (ASiii) are as shown below.

In each of formulae (ASi) to (ASiii), the groups possessed by the left-hand and right-hand ring structures bonded to the squarylium ring are designated by the same symbols. However, these are independently the following groups or atoms. That is, the same symbols in the left-hand portion and right-hand portion of each structural formula may be the same groups or atoms or may be different groups or atoms.

Formulae (ASi) to (ASiii) each show one of resonance structures, and compounds (ASi) to (ASiii) each include another resonance structure.

In formula (ASi), R¹⁶¹ moieties are each independently a C₃-C₂₀ branched alkyl group or a C₁₃-C₂₀ linear alkyl group. From the standpoint of solubility in resins and solvents, R¹⁶¹ is preferably a C₈-C₂₀ branched alkyl group, and is more preferably a C₁₆-C₂₀ linear alkyl group. From the standpoint of maintaining a high transmittance in resins, R¹⁶¹ is more preferably a C₈-C₂₀ branched alkyl group.

In formula (ASii), Y³ is C—R¹⁷⁹ or N.

In formula (ASi) and formula (ASii), R¹⁶² to R¹⁶⁷ moieties and R¹⁷¹ to R¹⁷⁹ moieties are each independently a hydrogen atom, a halogen atom, a sulfo group, a hydroxy group, a cyano group, a nitro group, a carboxyl group, a phosphate group, an —NR¹¹²R¹¹³ group, an —NHSO₂R¹¹⁴ group, an —NHCOR¹¹⁵ group, an —SR¹¹⁶ group, an —SO₂R¹¹⁷ group, an —OSO₂R¹¹⁸ group, a C₁-C₂₀ alkyl or alkoxy group, a C₁-C₁₂ halogen-substituted alkyl group, a C₃-C₁₄ cycloalkyl group, a C₆-C₁₄ aryl group, or a 3- to 14-membered heterocyclic ring group.

Examples of the 3- to 14-membered heterocyclic ring group include heterocyclic ring groups each containing at least one heteroatom selected from the group consisting of N, O, and S. From the standpoint of solubility in resins or solvents, preferred examples of R¹⁷¹ are a C₈-C₂₀ linear alkyl group and a C₈-C₂₀ branched alkyl group. From the standpoint of maintaining a high transmittance in resins, R¹⁷¹ is more preferably a C₁₆-C₂₀ branched alkyl group. The R¹⁶² to R¹⁶⁷ moieties and the R¹⁷² to R¹⁷⁸ moieties are each independently preferably a hydrogen atom, a C₁-C₂₀ alkyl or alkoxy group, an —NHSO₂R¹¹⁴ group, or an —NHCOR¹¹⁵ group, more preferably a hydrogen atom, a C₁-C₂₀ alkoxy group, or an —NHCOR¹¹⁵ group. R¹⁷⁹ is preferably a hydrogen atom or a C₁-C₂₀ alkyl or alkoxy group, more preferably a hydrogen atom or a C₁-C₈ alkyl or alkoxy group.

R¹¹² to R¹¹⁸ are each independently a hydrogen atom, a C₁-C₂₀ alkyl or alkoxy group, a C₁-C₁₂ halogen-substituted alkyl group, a C₃-C₁₄ cycloalkyl group, a C₆-C₁₄ aryl group, or a 3- to 14-membered heterocyclic ring group. Examples of the halogen atom include fluorine, chlorine, bromine, and iodine atoms, and fluorine and chlorine atoms are preferred.

R¹¹² to R¹¹⁸ are each independently preferably a C₁-C₂₀ alkyl or alkoxy group, more preferably a C₃-C₁₆ alkyl or alkoxy group.

In the explanation of formulae (ASi) and (ASii), each alkyl group and the alkyl group of each alkoxy group may be linear and may include a branched structure or a saturated-ring structure, unless specified otherwise. The term “aryl group” means a group which includes an aromatic ring possessed by an aromatic compound, e.g., a benzene ring, a naphthalene ring, biphenyl, a furan ring, a thiophene ring, or a pyrrole ring, and which is bonded through one of the carbon atoms constituting the aromatic ring. Examples of the halogen atom include fluorine, chlorine, bromine, and iodine atoms, and fluorine and chlorine atoms are preferred.

In formula (ASiii), R¹¹ to R¹⁴ moieties are each independently an alkyl, alkoxy, aryl, or alaryl group which may have a substituent and may contain an unsaturated bond or an oxygen atom between carbon atoms, and R¹⁵ and R¹⁶ moieties are each independently an aryl group which may have a substituent or an alkyl or alkoxy group which may have a substituent and may contain an unsaturated bond, an oxygen atom, an alicyclic ring, or an aromatic ring between carbon atoms or R¹⁵ and R¹⁶ have combined with each other to form a 5- to 10-membered heterocyclic ring together with the nitrogen atom, the heterocyclic ring optionally having a substituent.

The dye (ASiii) has a squarylium skeleton in the center of the molecular structure and includes two cyclopentadithiophene rings bonded to the squarylium skeleton respectively on the left-hand side and right-hand side thereof. Each cyclopentadithiophene ring has such a structure that the thiophene ring on the side remote from the squarylium skeleton has —NR¹⁵R¹⁶, which is a nitrogen atom-containing substituent. The R¹¹ to R¹⁶ moieties on the left-hand side and right-hand side of the squarylium skeleton may be different, but preferably are the same from the standpoint of ease of synthesis.

Examples of the substituents in R¹¹ to R¹⁴ include halogen atoms, a hydroxyl group, a carboxy group, a sulfo group, a cyano group, an amino group, N-substituted amino groups, a nitro group, alkoxycarbonyl groups, a carbamoyl group, N-substituted carbamoyl groups, imide groups, and C₁-C₁₀ alkoxy groups. In the case where any of R¹¹ to R¹⁴ is an aryl group or an alaryl group, a substituent may be a group which replaces either a hydrogen atom bonded to the aromatic ring or a hydrogen atom of the alkyl group possessed by the aromatic ring and the aryl or alaryl group includes an aryl group besides the substituent.

In the case where R¹¹ to R¹⁴ are alkyl or alkoxy groups, the carbon number of each group is preferably 1 to 20, more preferably 1 to 15, still more preferably 1 to 12. In the case where R¹¹ to R¹⁴ are aryl groups, the carbon number of each group is preferably 6 to 20, more preferably 6 to 17, still more preferably 6 to 14. In the case where R¹¹ to R¹⁴ are alaryl groups, the carbon number of each group is preferably 7 to 20, more preferably 7 to 18, still more preferably 7 to 15. In the case where R¹¹ to R¹⁴ have substituents, the carbon number includes the number of carbon atoms of the substituent(s)

From the standpoint of light stability, R¹¹ is preferably a hydrogen atom or a C₁-C₁₂ alkyl group, especially preferably a hydrogen atom.

From the standpoints of transparency to visible light, light resistance, and solubility in solvents, R¹² and R¹³ are each preferably a linear, branched, or cyclic alkyl group which has a carbon number of 1 to 20 and may contain an oxygen atom between carbon atoms. The carbon number of the alkyl group is more preferably 1 to 12 in the case where the alkyl group is linear, 3 to 10 in the case where the alkyl group is branched, and 5 to 10 in the case where the alkyl group is cyclic. R¹² and R¹³ are each more preferably a group selected from among groups 1a to 5a and groups 1d to 9d, especially preferably group 1a, group 3a, or group 5d.

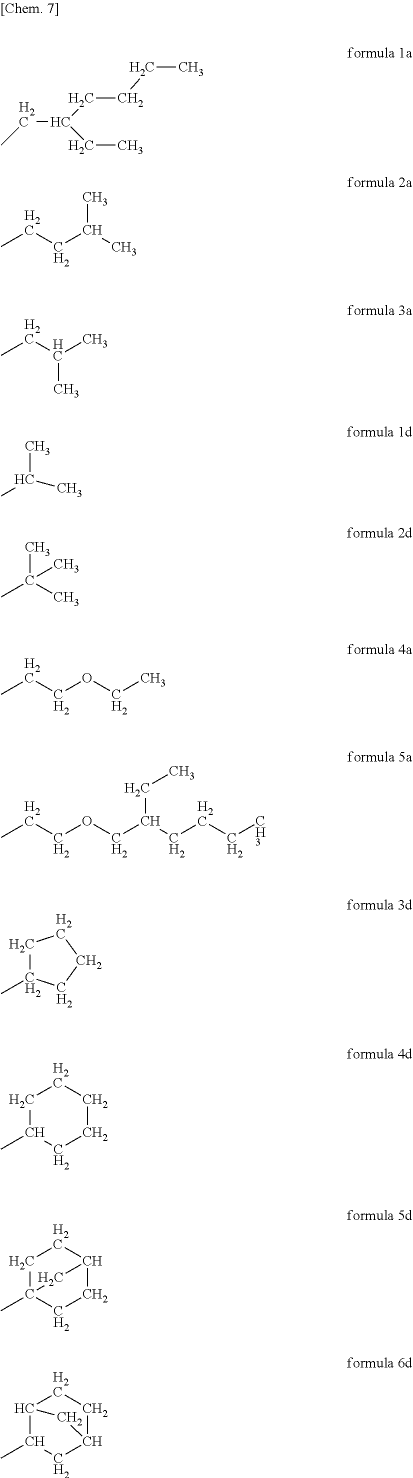

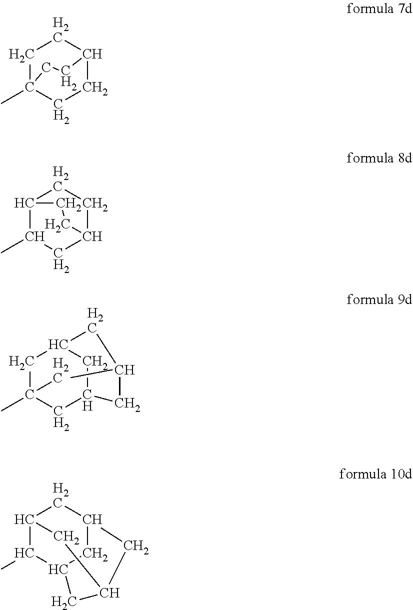

From the standpoints of heat resistance, light resistance, and an elongation of absorption wavelengths, R¹² and R¹³ are each preferably a phenyl group which may have 1 to 5 substituents, a naphthyl group which may have 1 to 7 substituents, or a C₅-C₁₀ cyclic alkyl group. Examples of the substituents by which the hydrogen atoms of the phenyl or naphthyl group may have been replaced include a C₁-C₁₂ alkyl group, a C₁-C₁₂ alkoxy group, or an alkylamino group (the alkyl group has a carbon number of 1 to 12) which each may contain an unsaturated bond or an oxygen atom between carbon atoms. The phenyl group and the naphthyl group are each preferably an unsubstituted group or a group in which 1 to 3 hydrogen atoms have been replaced, and preferred substituents are a methyl group, a tertiary butyl group, a dimethylamino group, a methoxy group, etc.

Specific examples of the phenyl group which may have 1 to 5 substituents include group P1 to group P9.

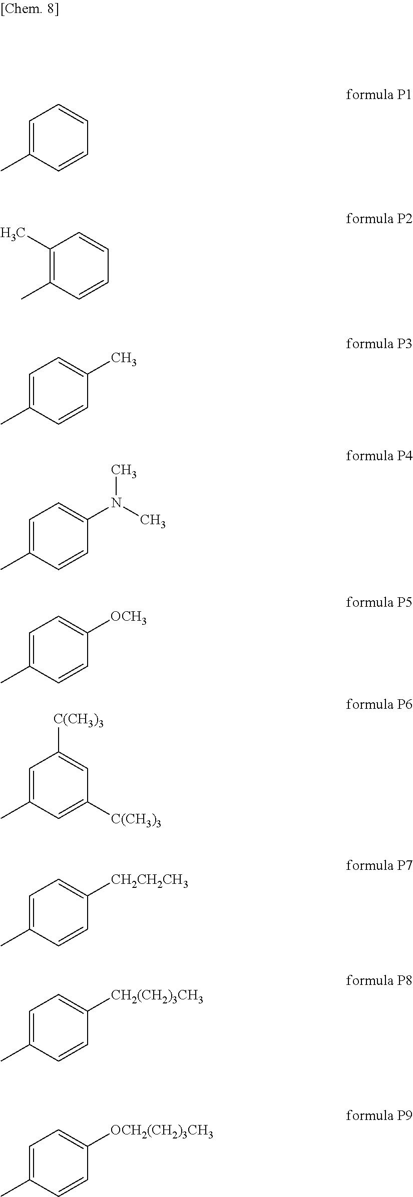

Specific examples of the naphthyl group which may have 1 to 7 substituents include group N1 to group N9.

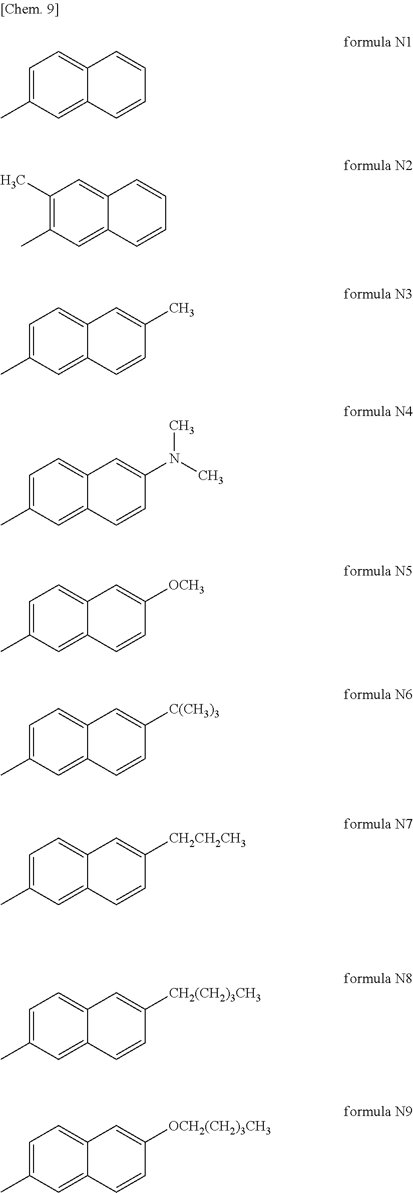

Specific preferred examples of R¹² and R¹³ are methyl group, a phenyl group, a naphthyl group, a toluyl group, a 3,5-di-tert-butylphenyl group, a cyclohexyl group, an isopropyl group, a 2-ethylhexyl group, etc. Especially preferred are a phenyl group, a cyclohexyl group, and an isopropyl group.

From the standpoints of transparency to visible light and solubility in solvents, R¹⁴ is preferably a linear, branched, or cyclic alkyl group which has a carbon number of 1 to 20 and may contain an oxygen atom between carbon atoms, like R¹² and R¹³. The carbon number of the alkyl group is more preferably 1 to 12 in the case where the alkyl group is linear, 3 to 10 in the case where the alkyl group is branched, and 5 to 10 in the case where the alkyl group is cyclic. R¹⁴ is more preferably a group selected from among group 1d to group 15d, and group 1d is especially preferred.

From the standpoint of ease of production, R¹⁴ is preferably a hydrogen atom or a C₁-C₈ alkyl group, especially preferably a hydrogen atom.

The R¹⁵ and R¹⁶ moieties are each independently an aryl group which may have a substituent or an alkyl or alkoxy group which may have a substituent and may contain an unsaturated bond, an oxygen atom, an alicyclic ring, or an aromatic ring between carbon atoms. R¹⁵ and R¹⁶ may have combined with each other to form a 5- to 10-membered heterocyclic ring together with a nitrogen atom, and in this case, one or more hydrogen atoms bonded to the heterocyclic ring may have been replaced by substituents.

Examples of the substituents in R¹⁵ and R¹⁶ include the same substituents as those for R¹¹ to R¹⁴. In the case where R¹⁵ and R¹⁶ are alaryl groups, the alkyl groups possessed thereby may have been further substituted with aryl groups.

R¹⁵ and R¹⁶ each may be a group including an aromatic ring or may be a group including no aromatic ring. R¹⁵ and R¹⁶ each including an aromatic ring are preferred from the standpoints of heat resistance and elongation of absorption wavelengths. R¹⁵ and R¹⁶ each including no aromatic ring are preferred from the standpoints of light resistance, ease of production, and solubility in solvents.

In the case where R¹⁵ and R¹⁶ are aryl groups, examples of the aryl groups include the same groups as those enumerated above with regard to R¹ and R².

In the case where R¹⁵ and R¹⁶ are alkyl or alkoxy groups, the carbon number thereof is preferably 1 to 20, more preferably 1 to 12, still more preferably 1 to 10. From the standpoints of transparency to visible light and solubility in solvents, R¹⁵ and R¹⁶ are each preferably a linear, branched, or cyclic alkyl group which has a carbon number of 3 to 20 and may contain an oxygen atom between carbon atoms, like R¹² and R¹³. The carbon number of the alkyl group is more preferably 3 to 12 in the case where the alkyl group is linear, 3 to 10 in the case where the alkyl group is branched, and 5 to 10 in the case where the alkyl group is cyclic. In the case where R¹⁵ and R¹⁶ have substituents, the carbon number includes the number of carbon atoms of the substituent(s). R¹⁵ and R¹⁶ are more preferably groups selected from among, for example, group 1d to group 15d, and are especially preferably group 1d.

Examples of the heterocyclic ring formed by R¹⁵ and R¹⁶ combined with each other together with a nitrogen atom include the same examples as for the R⁵ and R⁶ of compound 2, and preferred examples are also the same.

In dyes (ASiii), it is preferable that two or more, more preferably three of more, still more preferably the four, of R¹², R¹³, R¹⁵, and R¹⁶ among R¹¹ to R¹⁶ are each a linear or branched alkyl group which has 3 to 20 carbon atoms and may contain an oxygen atom between carbon atoms. This compound is excellent in terms of transparency to visible light and solubility in solvents.

More specific examples of the compounds represented by formula (ASi) include the compounds in which the atoms or groups bonded to each skeleton are as shown in the following Tables 1 and 2. In Table 1, 31 combinations of the atoms or groups represented by R¹⁶¹ to R¹⁶⁷ are designated respectively by numbers S-1 to S-31. In Table 1, all the alkyl groups such as —C₄H₉ are linear alkyl groups.

Table 2 shows dye (ASi-1) to dye (ASi-496) which are classified as dyes (ASi), and indicates that in each dye, the R¹⁶¹ to R¹⁶⁷ lying on the right-hand side of the squarylium ring and those lying on the left-hand side have which of the combinations S-1 to S-31. Dye (ASi-1) to dye (ASi-31) shown in Table 2 are each a compound having a symmetrical structure in which the combination of R¹⁶¹ to R¹⁶⁷ in the left-hand portion and that in the right-hand portion are equal in the formula. Dye (ASi-32) to dye (ASi-496) are each a compound having an asymmetrical structure in which the combination of R¹⁶¹ to R¹⁶⁷ in the left-hand portion and that in the right-hand portion differ in the formula.

Dye (ASi-32) to dye (ASi-61) shown in Table 2 are dyes in which the combination of the right-hand R¹⁶¹ to R¹⁶⁷ is S-1 and the combination of the left-hand R¹⁶¹ to R¹⁶⁷ is any of S-2 to S-31. In the case of the dyes (ASi) in which the right-hand combination is S-1, one in which the left-hand combination is S-2 was designated by dye (ASi-32), one in which the left-hand combination is S-3 was designated by dye (ASi-33), and one in which the left-hand combination is S-4 was designated by dye (ASi-34); in such manner, the dyes were numbered so that the dye number increased one by one in the order of the combination numbers of R¹⁶¹ to R¹⁶⁷. The same applies in other cases. Incidentally, dye (ASi-32) includes both the structure in which the right-hand combination is S-1 and the left-hand combination is S-2 and the structure in which the right-hand combination is S-2 and the left-hand combination is S-1.

TABLE 1

| Subs- | | | | | | | |
|---|---|---|---|---|---|---|---|
| tituent | | | | | | | |
| combi- | | | | | | | |
| nation | Substituent | | | | | | |
| No. | R¹⁶¹ | R¹⁶² | R¹⁶³ | R¹⁶⁴ | R¹⁶⁵ | R¹⁶⁶ | R¹⁶⁷ |
| S-1 | —CH₂—CH(C₂H₅)(C₄H₉) | H | H | H | H | H | H |
| S-2 | —CH₂—CH(C₈H₁₇)(C₆H₁₃) | H | H | H | H | H | H |
| S-3 | —CH₂—CH(C₈H₁₇)(C₆H₁₃) | H | H | —O—C₄H₉ | H | H | H |
| S-4 | —C₁₆H₃₃ | H | H | H | H | H | H |
| S-5 | —C₁₆H₃₃ | H | H | —CH₃ | H | H | H |
| S-6 | —C₁₆H₃₃ | H | H | —O—C₄H₉ | H | H | H |
| S-7 | —C₁₆H₃₃ | H | H | —O—C₈H₁₇ | H | H | H |
| S-8 | —C₁₆H₃₃ | H | H | —O—CH₂—CH(C₈H₁₇)C₆H₁₃) | H | H | H |
| S-9 | —C₁₆H₃₃ | H | H | —NH—SO₂—C₈H₁₇ | H | H | H |
| S-10 | —C₂₀H₄₁ | H | H | H | H | H | H |
| S-11 | —C₂₀H₄₁ | H | H | —CH₃ | H | H | H |
| S-12 | —C₂₀H₄₁ | H | H | —O—C₄H₉ | H | H | H |
| S-13 | —C₂₀H₄₁ | H | H | —O—C₈H₁₇ | H | H | H |
| S-14 | —C₂₀H₄₁ | H | H | —O—CH₂—CH(C₈H₁₇)C₆H₁₃) | H | H | H |
| S-15 | —C₂₀H₄₁ | H | H | —NH—SO₂—C₈H₁₇ | H | H | H |
| S-16 | —CH₂—CH(C₂H₅)(C₄H₉) | H | H | —CH₃ | H | H | H |
| S-17 | —CH₂—CH(C₂H₅)(C₄H₉) | H | H | —O—C₄H₉ | H | H | H |
| S-18 | —CH₂—CH(C₂H₅)(C₄H₉) | H | H | —O—C₈H₁₇ | H | H | H |
| S-19 | —CH₂—CH(C₂H₅)(C₄H₉) | H | H | —O—CH₂—CH(C₈H₁₇)C₆H₁₃) | H | H | H |
| S-20 | —CH₂—CH(C₈H₁₇)(C₆H₁₃) | H | H | —CH₃ | H | H | H |
| S-21 | —CH₂—CH(C₈H₁₇)(C₆H₁₃) | H | H | —O—C₈H₁₇ | H | H | H |
| S-22 | —CH₂—CH(C₈H₁₇)(C₆H₁₃) | H | H | —O—CH₂—CH(C₈H₁₇)C₆H₁₃) | H | H | H |
| S-23 | —CH₂—CH(C₈H₁₇)(C₆H₁₃) | H | H | —NH—SO₂—C₈H₁₇ | H | H | H |
| S-24 | —CH₂—CH(C₈H₁₇)(C₆H₁₃) | H | H | —O—CH₂CH(C₂H₅)(C₄H₉) | H | H | H |
| S-25 | —CH₂—CH(C₈H₁₇)(C₆H₁₃) | H | H | —NH—COO—CH₂—CH(C₂H₅)(C₄H₉) | H | H | H |
| S-26 | —C₁₆H₃₃ | H | H | —NH—COO—CH₂—CH(C₂H₅)(C₄H₉) | H | H | H |
| S-27 | —C₂₀H₄₁ | H | H | —NH—COO—CH₂—CH(C₂H₅)(C₄H₉) | H | H | H |
| S-28 | —CH₂—CH(C₂H₅)(C₄H₉) | H | H | —NH—COO—CH₂—CH(C₈H₁₇)(C₆H₁₃) | H | H | H |
| S-29 | —C₁₆H₃₃ | H | H | —NH—COO—CH₂—CH(C₈H₁₇)(C₆H₁₃) | H | H | H |
| S-30 | —C₂₀H₄₁ | H | H | —NH—COO—CH₂—CH(C₈H₁₇)(C₆H₁₃) | H | H | H |
| S-31 | —CH₂—CH(C₈H₁₇)(C₆H₁₅) | H | H | —NH—COO—CH₂—CH(C₈H₁₇)(C₆H₁₃) | H | H | H |

TABLE 2

| | Substituent combination No. | | | Substituent combination No. | |
|---|---|---|---|---|---|
| Abb. of dye | Right hand | Left hand | Abb. of dye | Right hand | Left hand |
| ASi-1 | S-1 | S-1 | ASi-32 to ASi-61 | S-1 | any of S-2 to S-31 |
| ASi-2 | S-2 | S-2 | ASi-62 to ASi-90 | S-2 | any of S-3 to S-31 |
| ASi-3 | S-3 | S-3 | ASi-91 to ASi-118 | S-3 | any of S-4 to S-31 |
| ASi-4 | S-4 | S-4 | ASi-119 to ASi-145 | S-4 | any of S-5 to S-31 |
| ASi-5 | S-5 | S-5 | ASi-146 to ASi-171 | S-5 | any of S-6 to S-31 |
| ASi-6 | S-6 | S-6 | ASi-172 to ASi-196 | S-6 | any of S-7 to S-31 |
| ASi-7 | S-7 | S-7 | ASi-197 to ASi-220 | S-7 | any of S-8 to S-31 |
| ASi-8 | S-8 | S-8 | ASi-221 to ASi-243 | S-8 | any of S-9 to S-31 |
| ASi-9 | S-9 | S-9 | ASi-244 to ASi-265 | S-9 | any of S-10 to S-31 |
| ASi-10 | S-10 | S-10 | ASi-266 to ASi-286 | S-10 | any of S-11 to S-31 |
| ASi-11 | S-11 | S-11 | ASi-287 to ASi-306 | S-11 | any of S-12 to S-31 |
| ASi-12 | S-12 | S-12 | ASi-307 to ASi-325 | S-12 | any of S-13 to S-31 |
| ASi-13 | S-13 | S-13 | ASi-326 to ASi-343 | S-13 | any of S-14 to S-31 |
| ASi-14 | S-14 | S-14 | ASi-344 to ASi-360 | S-14 | any of S-15 to S-31 |
| ASi-15 | S-15 | S-15 | ASi-361 to ASi-376 | S-15 | any of S-16 to S-31 |
| ASi-16 | S-16 | S-16 | ASi-377 to ASi-391 | S-16 | any of S-17 to S-31 |
| ASi-17 | S-17 | S-17 | ASi-392 to ASi-405 | S-17 | any of S-18 to S-31 |
| ASi-18 | S-18 | S-18 | ASi-406 to ASi-418 | S-18 | any of S-19 to S-31 |
| ASi-19 | S-19 | S-19 | ASi-419 to ASi-430 | S-19 | any of S-20 to S-31 |
| ASi-20 | S-20 | S-20 | ASi-431 to ASi-441 | S-20 | any of S-21 to S-31 |
| ASi-21 | S-21 | S-21 | ASi-442 to ASi-451 | S-21 | any of S-22 to S-31 |
| ASi-22 | S-22 | S-22 | ASi-452 to ASi-460 | S-22 | any of S-23 to S-31 |
| ASi-23 | S-23 | S-23 | ASi-461 to ASi-468 | S-23 | any of S-24 to S-31 |
| ASi-24 | S-24 | S-24 | ASi-469 to ASi-475 | S-24 | any of S-25 to S-31 |
| ASi-25 | S-25 | S-25 | ASi-476 to ASi-481 | S-25 | any of S-26 to S-31 |
| ASi-26 | S-26 | S-26 | ASi-482 to ASi-486 | S-26 | any of S-27 to S-31 |
| ASi-27 | S-27 | S-27 | ASi-487 to ASi-490 | S-27 | any of S-28 to S-31 |
| ASi-28 | S-28 | S-28 | ASi-491 to ASi-493 | S-28 | any of S-29 to S-31 |
| ASi-29 | S-29 | S-29 | ASi-494 to ASi-495 | S-29 | either S-30 or S-31 |
| ASi-30 | S-30 | S-30 | ASi-496 | S-30 | S-31 |
| ASi-31 | S-31 | S-31 | | | |

Among the dyes (ASi), preferred left-hand/right-hand symmetrical dyes (ASi) are dyes (ASi-1), (ASi-2), (ASi-3), (ASi-19), (ASi-22), (ASi-24), (ASi-25), (ASi-28), (ASi-31), etc., and more preferred are dyes (ASi-1), (ASi-19), (ASi-22), (ASi-25), (ASi-31), etc.

Among the dyes (ASi), preferred left-hand/right-hand asymmetrical dyes (ASi) are: dyes (ASi-423), (ASi-424), and (ASi-427), in which the left-hand combination and the right-hand combination are S-19 and any of S-24, S-25, and S-28; dye (ASi-460), in which the combinations are S-22 and S-31; dyes (ASi-469) and (ASi-472), in which the combinations are S-24 and either of S-25 and S-28; etc.

More specific examples of the compounds represented by formula (ASii) include the compounds in which the atoms or groups bonded to each skeleton are as shown in the following Table 3. In all the compounds shown in Table 3, the left-hand portion and right-hand portion of the formula are equal in R¹⁷¹ to R¹⁷⁸ and Y³. In Table 3, all the alkyl groups, e.g., —C₄H₉, are linear alkyl groups.

TABLE 3

| | Substituent | | | | | | | | |
|---|---|---|---|---|---|---|---|---|---|
| Abb. of dye | R¹⁷¹ | R¹⁷² | R¹⁷³ | R¹⁷⁴ | R¹⁷⁵ | R¹⁷⁶ | R¹⁷⁷ | R¹⁷⁸ | Y³ |
| ASii-1 | —C₈H₁₇ | H | H | H | H | H | H | H | C—H |
| ASii-2 | —CH₂—CH(C₈H₁₇)(C₆H₁₃) | H | H | —CH₃ | H | H | H | H | C—H |
| ASii-3 | —CH₂—CH(C₈H₁₇)(C₆H₁₃) | H | H | —OCH₃ | H | H | H | H | C—H |
| ASii-4 | —CH₂—CH(C₈H₁₇)(C₆H₁₃) | H | H | H | H | H | H | H | C—CH₃ |
| ASii-5 | —CH₂—CH(C₈H₁₇)(C₆H₁₃) | H | H | H | H | H | H | H | C—OCH₃ |
| ASii-6 | —CH₂—CH(C₈H₁₇)(C₆H₁₃) | H | H | H | H | H | H | H | N |
| ASii-7 | —CH₂—CH(C₈H₁₇)(C₆H₁₃) | H | H | H | H | H | H | H | C—H |
| ASii-8 | —CH₂—CH(C₈H₁₇)(C₆H₁₃) | H | H | —O—C₈H₁₇ | H | H | H | H | C—H |
| ASii-9 | —C₁₆H₃₃ | H | H | —CH₃ | H | H | H | H | C—H |
| ASii-10 | —C₁₆H₃₃ | H | H | —OCH₃ | H | H | H | H | C—H |
| ASii-11 | —C₁₆H₃₃ | H | H | H | H | H | H | H | C—CH₃ |
| ASii-12 | —C₁₆H₃₃ | H | H | H | H | H | H | H | C—OCH₃ |
| ASii-13 | —C₁₆H₃₃ | H | H | H | H | H | H | H | N |
| ASii-14 | —C₁₆H₃₃ | H | H | H | H | H | H | H | C—H |
| ASii-15 | —C₁₆H₃₃ | H | H | —O—C₈H₁₇ | H | H | H | H | C—H |
| ASii-16 | —C₂₀H₄₁ | H | H | —O—C₈H₁₇ | H | H | H | H | C—H |
| ASii-17 | —CH₂—CH(C₂H₅)(C₄H₉) | H | H | —O—C₈H₁₇ | H | H | H | H | C—H |

Among these dyes (ASii), preferred are dyes (ASii-1) to (ASii-8), (ASii-10), (ASii-15) to (ASii-17), etc. More preferred are dyes (ASii-8), (ASii-15) to (ASii-17), etc.

Dyes (ASi) and dyes (ASii) each can be produced, for example, by producing compounds to be introduced to both sides of a squarylium ring, by the method described in European Journal of Medical Chemistry, 54, 647 (2012) and by the method described in Org. Lett., 18, 5232 (2016) in the case of the dyes (ASii), and introducing the compounds into two sites on a diagonal line of squaric acid, for example, by the method described in Organic Letters, 8, 111 (2006). With respect to asymmetrical structures, the dyes can be produced by the method described in Dyes and Pigments, 141, 457 (2017).

More specific examples of dyes (ASiii) include the compounds in which R¹¹ to R¹⁶ are as shown in the following Table 4. In all the compounds shown in Table 4, the portions respectively lying on the left-hand side and right-hand side of the squarylium skeleton are equal in all of R¹¹ to R¹⁶. In Table 4, the alkyl groups represented by CₙH₂ₙ₊₁ (n is an integer of 3 or larger) are linear alkyl groups.

TABLE 4

| Abb. of dye | R¹¹ | R¹² | R¹³ | R¹⁴ | R¹⁵ | R¹⁶ |
|---|---|---|---|---|---|---|
| ASiii-1 | H | group 1a | group 1a | H | group 11 | |
| ASiii-2 | H | group 1a | group 1a | H | —C₃H₇ | —C₃H₇ |
| ASiii-3 | H | group 1a | group 1a | H | group 1a | group 1a |
| ASiii-4 | —C₁₂H₂₅ | —C₈H₁₇ | —C₈H₁₇ | H | group 11 | |
| ASiii-5 | H | group P1 | group P1 | H | group 1a | group 1a |
| ASiii-6 | H | group P1 | group P1 | H | group 11 | |
| ASiii-7 | H | group P6 | group P6 | H | group 1a | group 1a |
| ASiii-8 | H | group 3a | group 3a | H | group 1a | group 1a |
| ASiii-9 | H | group 3a | group 3a | H | group 11 | |
| ASiii-10 | H | group 9a | group 9a | H | group 1a | group 1a |
| ASiii-11 | H | group 9a | group 9a | H | group 11 | |
| ASiii-12 | H | group N1 | group N1 | H | group 1a | group 1a |
| ASiii-13 | H | group 1a | group 1a | H | group 3a | group 3a |
| ASiii-14 | H | group 3a | group 3a | H | group 3a | group 3a |
| ASiii-15 | H | group 9a | group 9a | H | group 3a | group 3a |
| ASiii-16 | H | group P1 | group P1 | H | group 3a | group 3a |
| ASiii-17 | H | group P6 | group P6 | H | group 3a | group 3a |

Among the dyes (ASiii), from the standpoint of the ability to retain high light resistance, preferred are dyes (ASiii-3), (ASiii-8), (ASiii-10), (ASiii-13), (ASiii-14), and (ASiii-15). Preferred from the standpoint of solubility in solvents are dyes (ASiii-1), (ASiii-2), (ASiii-3), (ASiii-5), (ASiii-7), (ASiii-8), (ASiii-10), (ASiii-12), (ASiii-13), and (ASiii-17). Preferred from the standpoint of ease of synthesis are dyes (ASiii-1), (ASiii-5), (ASiii-6), (ASiii-9), and (ASiii-16).

The dye (ASiii) has the property of highly absorbing near-infrared light having longer wavelengths, because the four or more carbon-carbon double bonds lying from the central squarylium skeleton to the amino group (—NR¹⁵R¹⁶) at each end have brought about an enlarged π-conjugated structure. Furthermore, since the dye (ASiii) does not contain any unnecessary benzene ring, this dye has high transmittances for visible light, in particular for blue light, which is shorter wavelength-side light among visible light. Moreover, the dye (ASiii), when having a configuration in which neither R¹⁵ nor R¹⁶ includes an aromatic ring directly bonded to the nitrogen atom, undergoes enhanced electron donation to the cyclopentadithiophene ring from the amino group that is directly bonded to R¹⁵ and R¹⁶. This dye (ASiii) is preferred because it has higher transmittances for shorter-wavelength visible light and exhibits the property of highly absorbing longer-wavelength near-infrared light.

Dyes (ASiii) can be produced, for example, by reacting 3,4-dihydroxy-3-cyclobutene-1,2-dione (squaric acid) with an amino group-terminated cyclopentadithiophene derivative capable of combining with squaric acid to form a structure represented by formula (ASiii). For example, in the case of a dye (ASiii) having a left-hand/right-hand symmetrical structure, two equivalents of a cyclopentadithiophene derivative having a desired structure within that range may be reacted with one equivalent of squaric acid.

Examples of the diketopyrrolopyrrole dyes usable as the NIR dye (A) include compounds represented by formula (AD).

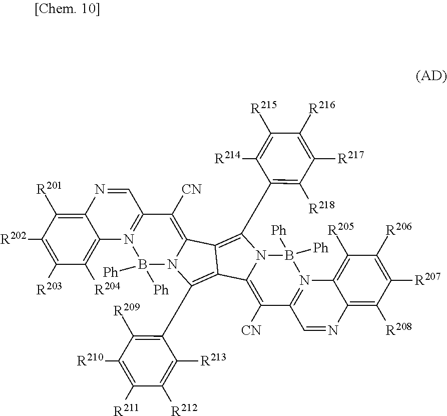

In formula (AD), R²⁰¹ to R²¹⁸ are each independently a hydrogen atom, a halogen atom, a sulfo group, a hydroxy group, a cyano group, a nitro group, a carboxyl group, a phosphate group, an —NR²¹⁹R²²⁰ group, an —NHSO₂R²²¹ group, an —NHCOR²²² group, an —SR²²³ group, an —SO₂R²²⁴ group, an —OSO₂R²²⁵ group, a C₁-C₂₀ alkyl or alkoxy group, a C₁-C₁₂ halogen-substituted alkyl group, a C₃-C₁₄ cycloalkyl group, a C₆-C₁₄ aryl group, or a 3- to 14-membered heterocyclic ring group.

R²¹⁹ to R²²⁵ are each independently a hydrogen atom, a C₁-C₂₀ alkyl or alkoxy group, a C₁-C₁₂ halogen-substituted alkyl group, a C₃-C₁₄ cycloalkyl group, a C₆-C₁₄ aryl group, or a 3- to 14-membered heterocyclic ring group. Ph represents a phenyl group.

In dyes (AD), R²⁰¹ to R²¹⁸ are each independently preferably a hydrogen atom, a halogen atom, a C₁-C₂₀ alkyl or alkoxy group, or a C₁-C₁₂ halogen-substituted alkyl group. R²⁰¹, R²⁰⁴, R²⁰⁵, and R²⁰⁸ are each preferably a hydrogen atom. R²⁰², R²⁰³, R²⁰⁶, and R²⁰⁷ are each independently preferably a hydrogen atom, a halogen atom, or a C₁-C₂₀ alkyl or alkoxy group.

R²⁰⁹, R²¹³, R²¹⁴, and R²¹⁸ are each preferably a hydrogen atom. R²¹⁰ to R²¹² and R²¹⁵ to R²¹⁷ are each independently preferably a hydrogen atom or a C₁-C₂₀ alkyl or alkoxy group 0. At least one of R²¹⁰ to R²¹² and at least one of R²¹⁵ to R²¹⁷ are each preferably a C₁-C₂₀ alkoxy group.

Examples of the halogen atoms include fluorine, chlorine, bromine, and iodine atoms. Preferred are fluorine and chlorine atoms. Especially preferred is chlorine atom. Preferred examples of the alkoxy groups are ones including a branched alkyl group.

More specific examples of the compounds represented by formula (AD) include the compounds in which the atoms or groups bonded to each skeleton are as shown in the following Table 5.

TABLE 5

| Abb. Of | Substituent | | | | | | | | |
|---|---|---|---|---|---|---|---|---|---|
| dye | R²⁰¹, R²⁰⁸ | R²⁰², R²⁰⁷ | R²⁰³, R²⁰⁶ | R²⁰⁴, R²⁰⁵ | R²⁰⁹, R²¹⁸ | R²¹⁰, R²¹⁷ | R²¹¹, R²¹⁶ | R²¹², R²¹⁵ | R²¹³, R²¹⁴ |
| AD-1 | H | Cl | Cl | H | H | —O—n-C₁₂H₂₅ | —O—n-C₁₂H₂₅ | —O—n-C₁₂H₂₅ | H |
| AD-2 | H | H | H | H | H | —O—n-C₁₂H₂₅ | —O—n-C₁₂H₂₅ | —O—n-C₁₂H₂₅ | H |
| AD-3 | H | Cl | Cl | H | H | —OCH₂C(n-C₆H₁₃)(n-C₈H₁₇) | H | H | H |
| AD-4 | H | H | H | H | H | —OCH₂C(n-C₆H₁₃)(n-C₈H₁₇) | H | H | H |
| AD-5 | H | H | H | H | H | H | —O—n-C₈H₁₇ | H | H |
| AD-6 | H | Cl | Cl | H | H | H | —O—n-C₈H₁₇ | H | H |
| AD-7 | H | H | H | H | H | —O—n-C₈H₁₇ | —O—n-C₈H₁₇ | —O—n-C₈H₁₇ | H |
| AD-8 | H | Cl | Cl | H | H | —O—n-C₈H₁₇ | —O—n-C₈H₁₇ | —O—n-C₈H₁₇ | H |

Among of these dyes (AD), from the standpoint of solubility in resins, preferred are dyes (AD-1), (AD-2), (AD-4), etc. Dyes (AD) can be produced by known methods, e.g., the method described in International Publication WO 2016/031810.

The NIR dye (A) may consist of a single compound or may be composed of two or more compounds. In the case where the NIR dye (A) is composed of two or more compounds, each compound need not always have the properties of an NIR dye (A) and it is only required that the compounds as a mixture should have the properties of an NIR dye (A).

The content of the NIR dye (A) in the external resin layer including an alicyclic epoxy resin or in the intermediate resin layer including a cycloolefin resin depends on the thickness of the resin layer. However, from the standpoints of NIR shielding properties and solubility, the content thereof is preferably 0.1 to 20 parts by mass, more preferably 1 to 20 parts by mass, per 100 parts by mass of the alicyclic epoxy resin or the cycloolefin resin. In the case where the thickness of the resin layer containing the NIR dye (A) is 5 μm or less, the content of the NIR dye (A) in the resin layer is preferably 5 to 20 parts by mass, more preferably 5 to 15 parts by mass, per 100 parts by mass of the alicyclic epoxy resin or the cycloolefin resin.

### (NIR Dye (B))

It is preferable that the present filter contains an NIR dye (B) besides the NIR dye (A). The NIR dye (B) has, in a spectral transmittance curve over a wavelength range of 400 to 1,200 nm when examined in a resin included in the resin layer containing the NIR dye (B), a maximum absorption wavelength λ_{max(B)TR} within a wavelength range of 680 to 760 nm. The resin layer containing the NIR dye (B) may be either the external resin layer or the intermediate resin layer, or may be the resin substrate if desired. The NIR dye (B) is preferably contained in a resin layer different from the resin layer containing the NIR dye (A).

It is preferable that the resin layer containing the NIR dye (B) has, in a spectral transmittance curve over a wavelength range of 400 to 1,200 nm, a wavelength within a wavelength range of 650 to 700 nm, the wavelength λ_{H20%} being a wavelength at which an internal transmittance is 20% and which is shorter than a maximum absorption wavelength, and has an average internal transmittance T_{AVE435-480TR(B)} for light having wavelengths of 435 to 480 nm of 90% or higher, an average internal transmittance T_{AVE490-560TR(B)} for light having wavelengths of 490 to 560 nm of 90% or higher, and a wavelength difference λ_{SH20%}−λ_{SH70%} of 55 nm or less, the wavelength difference being a difference between the wavelength λ_{SH20%} and a wavelength λ_{SH70%} at which an internal transmittance is 70% and which is shorter than the maximum absorption wavelength.

λ_{SH20%} is more preferably within the range of 650 to 690 nm, still more preferably within the range of 650 to 680 nm.

T_{AVE435-480TR(B)} is more preferably 90.5% or higher, still more preferably 91% or higher.

T_{AVE490-560TR(B)} is more preferably 93% or higher, still more preferably 95% or higher.

λ_{SH20%}−λ_{SH70%} is more preferably 53 nm or less, still more preferably 51 nm or less.

Specific examples of the NIR dye (B) include squarylium dyes satisfying the requirements concerning λ_{max(B)TR}. More specifically, squarylium dyes represented by the following formula (I) or formula (II) are preferred as the NIR dye (B).

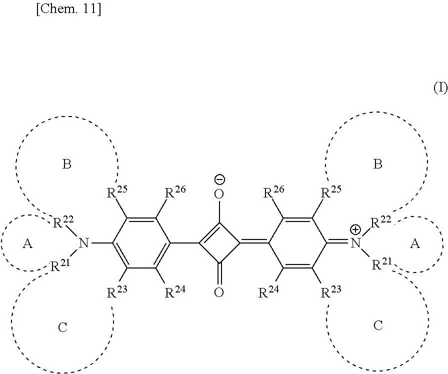

The symbols in formula (I) are as follows.

R²⁴ moieties and R²⁶ moieties are each independently a hydrogen atom, a halogen atom, a hydroxyl group, a C₁-C₂₀ alkyl group, a C₁-C₂₀ alkoxy group, a C₁-C₁₀ acyloxy group, a C₆-C₁₁ aryl group, a C₇-C₁₈ alaryl group which may have a substituent and may contain an oxygen atom between carbon atoms, —NR²⁷R²⁸ (R²⁷ and R²⁸ each independently represent a hydrogen atom, a C₁-C₂₀ alkyl group, —C(═O)—R²⁹ (R²⁹ is a hydrogen atom, a halogen atom, a hydroxyl group, or a C₁-C₂₅ hydrocarbon group which may have a substituent and may contain an unsaturated bond, an oxygen atom, or a saturated or unsaturated ring structure between carbon atoms), —NHR³⁰, or —SO₂—R³⁰ (R³⁰ moieties are each a C₁-C₂₅ hydrocarbon group which may contain an unsaturated bond, an oxygen atom, or a saturated or unsaturated ring structure between carbon atoms and in which one or more hydrogen atoms each may have been replaced with a halogen atom, a hydroxyl group, a carboxy group, a sulfo group, or a cyano group)), or a group represented by the following formula (S) (R⁴¹ and R⁴² each independently represent a hydrogen atom, a halogen atom, a C₁-C₁₀ alkyl group, or a C₁-C₁₀ alkoxy group, and k is 2 or 3).

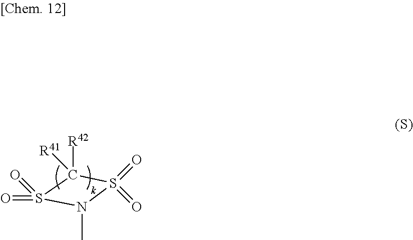

R²¹ and R²², R²² and R²⁵, and R²¹ and R²³ may combine with each other to form, respectively, a heterocyclic ring A, a heterocyclic ring B, and a heterocyclic ring C together with a nitrogen atom, each ring having 5 or 6 ring members.

R²¹ and R²², when forming the heterocyclic ring A, represent a divalent group -Q- formed by the bonding thereof, the divalent group -Q- being an alkylene or alkyleneoxy group in which a hydrogen atom may have been replaced with a C₁-C₆ alkyl group, a C₆-C₁₀ aryl group, or a C₁-C₁₀ acyloxy group which may have a substituent.

R²² and R²⁵, when forming the heterocyclic ring B, and R²¹ and R²³, when forming the heterocyclic ring C, are divalent groups —X¹—Y¹— and —X²—Y²— respectively each formed by the bonding thereof (X¹ and X² are bonded to the nitrogen atom), in which X¹ and X² are each a group represented by the following formula (1x) or (2x) and Y¹ and Y² are each a group represented by a formula selected from the group consisting of the following formulae (1y) to (5y). When X¹ and X² are each a group represented by the following formula (2x), Y¹ and Y² each may be a single bond and, in this case, the group may have an oxygen atom between carbon atoms.

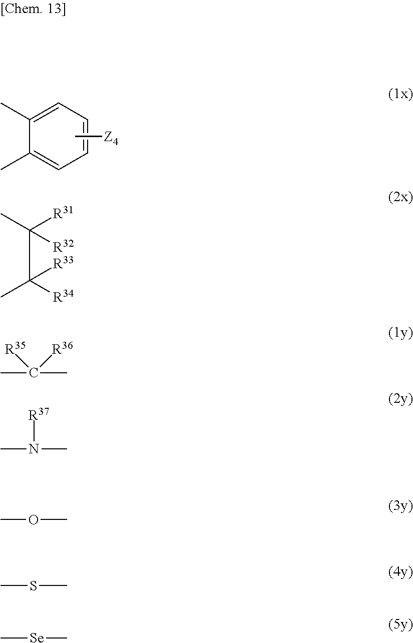

In formula (1x), the four Z moieties each independently represent a hydrogen atom, a hydroxyl group, a C₁-C₆ alkyl group, a C₁-C₆ alkoxy group, or —NR³⁸R³⁹ (R³⁸ and R³⁹ each independently represent a hydrogen atom or a C₁-C₂₀ alkyl group). R³¹ to R³⁶ each independently represent a hydrogen atom, a C₁-C₆ alkyl group, or a C₆-C₁₀ aryl group, and R³⁷ represents a C₁-C₆ alkyl group or a C₆-C₁₀ aryl group.

R²⁷, R²⁸, R²⁹, R³¹ to R³⁷, R²¹ to R²³ which have not formed the heterocyclic rings, and R²⁵ each may be bonded to any of the others to form a 5-membered ring or a 6-membered ring. R³¹ and R³⁶ may be directly bonded to each other, and R³¹ and R³⁷ may be directly bonded to each other.

R²¹, R²², R²³, and R²⁵ which have not formed the heterocyclic rings each independently represent a hydrogen atom, a halogen atom, a hydroxyl group, a C₁-C₂₀ alkyl group, a C₁-C₂₀ alkoxy group, a C₁-C₁₀ acyloxy group, a C₆-C₁₁ aryl group, or a C₇-C₁₈ alaryl group which may have a substituent and may have an oxygen atom between carbon atoms.

In formula (I), unless specified otherwise, each hydrocarbon group is an alkyl group, an aryl group, or an alaryl group. Unless specified otherwise, each alkyl group and the alkyl moiety of each alkoxy, aryl, or alaryl group may be linear, branched, or cyclic or have a structure formed by combining these structures. The same holds true for the alkyl, alkoxy, aryl, and alaryl groups in other formulae set forth below. In formula (I), examples of the substituent in R²⁹ include halogen atoms, a hydroxyl group, a carboxy group, a sulfo group, a cyano group, and C₁-C₆ acyloxy groups. Examples of the substituent in the case of using the expression “may have a substituent”, except the substituent in R²⁹, include halogen atoms and C₁-C₁₅ alkoxy groups. Examples of the halogen atoms include fluorine, chlorine, bromine, and iodine atoms. Fluorine and chlorine atoms are preferred.

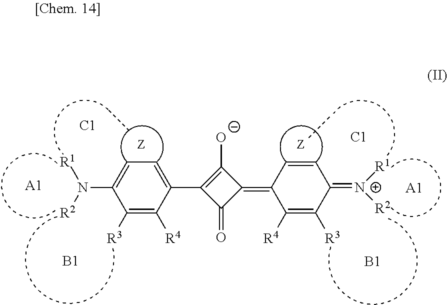

The symbols in formula (II) are as follows.

Rings Z are each independently a 5- or 6-membered ring having 0 to 3 heteroatoms therein, and a hydrogen atom contained in each ring Z may have been replaced. In the case where the hydrogen atom has been replaced, examples of the substituent include halogen atoms and alkyl groups which each have a carbon number of 1 to 10 and may have a substituent.

R¹ and R², R² and R³, and R¹ and a carbon atom or heteroatom as a component of each ring Z may have combined with each other to form, respectively, a heterocyclic ring A1, a heterocyclic ring B1, and a heterocyclic ring C1 together with a nitrogen atom, and in this case, hydrogen atoms contained in the heterocyclic ring A1, heterocyclic ring B1, and heterocyclic ring C1 may have been replaced. In the case where the hydrogen atoms have been replaced, examples of the substituents include halogen atoms and alkyl groups which each have a carbon number of 1 to 15 and may have a substituent.

R¹ and R² which have not formed the heterocyclic ring each independently represent a hydrogen atom, a halogen atom, or a hydrocarbon group which may contain an unsaturated bond, a heteroatom, or a saturated or unsaturated ring structure between carbon atoms and which may have a substituent. R⁴ and R³ which has not formed the heterocyclic ring each independently represent a hydrogen atom, a halogen atom, or an alkyl or alkoxy group which may contain a heteroatom between carbon atoms and may have a substituent.

In formula (II), each hydrocarbon group may have 1 to 15 carbon atoms. Each alkyl or alkoxy group may have a carbon number of 1 to 10. In formula (II), examples of the substituent in the case of using the expression “may have a substituent” include halogen atoms and C₁-C₁₀ alkoxy groups. Examples of the halogen atoms include fluorine, chlorine, bromine, and iodine atoms, and fluorine and chlorine atoms are preferred.

Examples of compounds (I) include compounds represented by any of formulae (I-1) to (I-4).

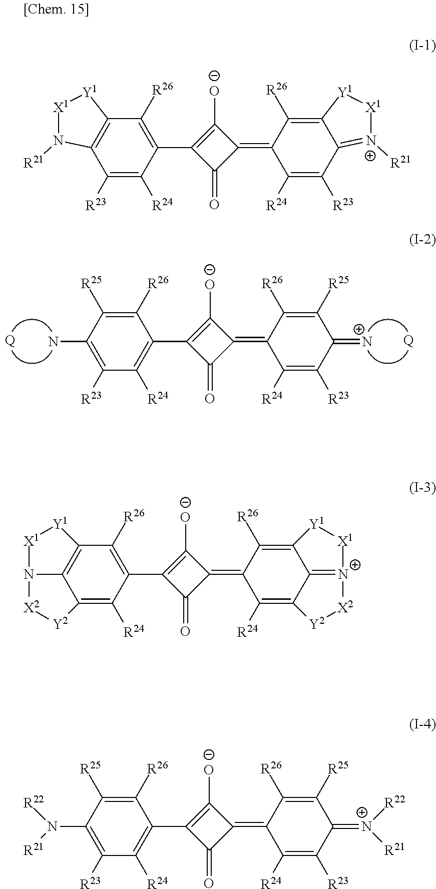

The symbols in formulae (I-1) to (I-4) have the same meanings as the like symbols in formula (I), and preferred examples are also the same.

Among compounds (I-1) to (I-4), compounds (I-1) to (I-3) are preferred as the NIR dye (B) from the standpoint of the ability to heighten the visible-light transmittance of the resin layer containing the compounds. Especially preferred are compounds (I-1).

In compounds (I-1), X¹ is preferably group (2x) and Y¹ is preferably a single bond or group (1y). In this case, R³¹ to R³⁶ are each preferably a hydrogen atom or an alkyl group having 1 to 3 carbon atoms, more preferably a hydrogen atom or a methyl group. Specific examples of —Y¹—X¹— include the divalent organic groups represented by formulae (11-1) to (12-3).

—C(CH₃)₂—CH(CH₃)— (11-1)

—C(CH₃)₂—CH₂— (11-2)

—C(CH₃)₂—CH(C₂H₅)— (11-3)

—C(CH₃)₂—C(CH₃)(nC₃H₇)— (11-4)

—C(CH₃)₂—CH₂—CH₂— (12-1)

—C(CH₃)₂—CH₂—CH(CH₃)— (12-2)

—C(CH₃)₂—CH(CH₃)—CH₂— (12-3)

In compounds (I-1), it is more preferable that the R²¹ moieties are each independently a group represented by formula (4-1) or (4-2), from the standpoints of solubility, heat resistance, and the steepness of change in the vicinity of the boundary between the visible region and the near-infrared region in a spectral transmittance curve.

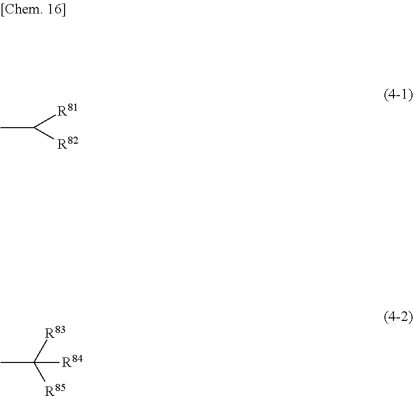

In formulae (4-1) and (4-2), R⁸¹ to R⁸⁵ each independently represent a hydrogen atom, a halogen atom, or a C₁-C₄ alkyl group.

In compounds (I-1), R²⁴ is preferably —NR²⁷R²⁸. —NR²⁷R²⁸ is preferably —NH—C(═O)—R²⁹ from the standpoint of solubility in a resin to be used in combination with the NIR dye (B) or in a solvent to be used in forming the resin layer on the resin substrate. Compounds (I-1) in which R²⁴ is —NH—C(═O)—R²⁹ are shown by formula (I-11).

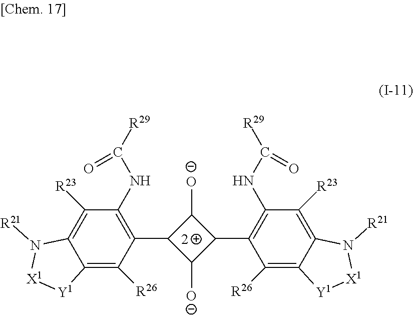

In compounds (I-11), the R²³ and R²⁶ moieties are each independently preferably a hydrogen atom, a halogen atom, a C₁-C₆ alkyl group, or a C₁-C₆ alkoxy group, and each more preferably a hydrogen atom.

In compounds (I-11), R²⁹ is preferably an alkyl group which has 1 to 20 carbon atoms and may have a substituent, an aryl group which has a carbon number of 6 to 10 and may have a substituent, or an alaryl group which has a carbon number of 7 to 18 and which may have a substituent and may have an oxygen atom between carbon atoms. Examples of the substituents include halogen atoms, e.g., fluorine atom, etc., a hydroxyl group, a carboxy group, a sulfo group, a cyano group, C₁-C₆ alkyl groups, C₁-C₆ fluoroalkyl groups, C₁-C₆ alkoxy groups, and C₁-C₆ acyloxy groups.

R²⁹ is preferably a hydrogen atom, a halogen atom, a hydroxyl group, a C₁-C₂₀ alkyl group, a C₁-C₂₀ alkoxy group, a C₁-C₁₀ acyloxy group, a C₆-C₁₁ aryl group, or a C₇-C₁₈ alaryl group which may have a substituent and may have an oxygen atom between carbon atoms.

R²⁹ is preferably a group selected from the group consisting of: a linear, branched, or cyclic alkyl group which has a carbon number of 1 to 17 and may be substituted by a fluorine atom; a phenyl group which may be substituted by a C₁-C₆ fluoroalkyl group and/or a C₁-C₆ alkoxy group; and a C₇-C₁₈ alaryl group which may have an oxygen atom between carbon atoms and which includes a terminal phenyl group that may be substituted by an optionally fluorine atom-substituted alkyl group with a carbon number of 1 to 6 and/or an alkoxy group with a carbon number of 1 to 6.

Also preferred as R²⁹ is a hydrocarbon group which has a carbon number of 5 to 25 and at least one branch and may contain an unsaturated bond, an oxygen atom, or a saturated or unsaturated ring structure between carbon atoms and in which one or more hydrogen atoms each may independently have been replaced by a halogen atom, a hydroxyl group, a carboxy group, a sulfo group, or a cyano group. Examples of such R²⁹ include the groups represented by the following formulae (11a), (11b), (12a) to (12e), and (13a) to (13e).

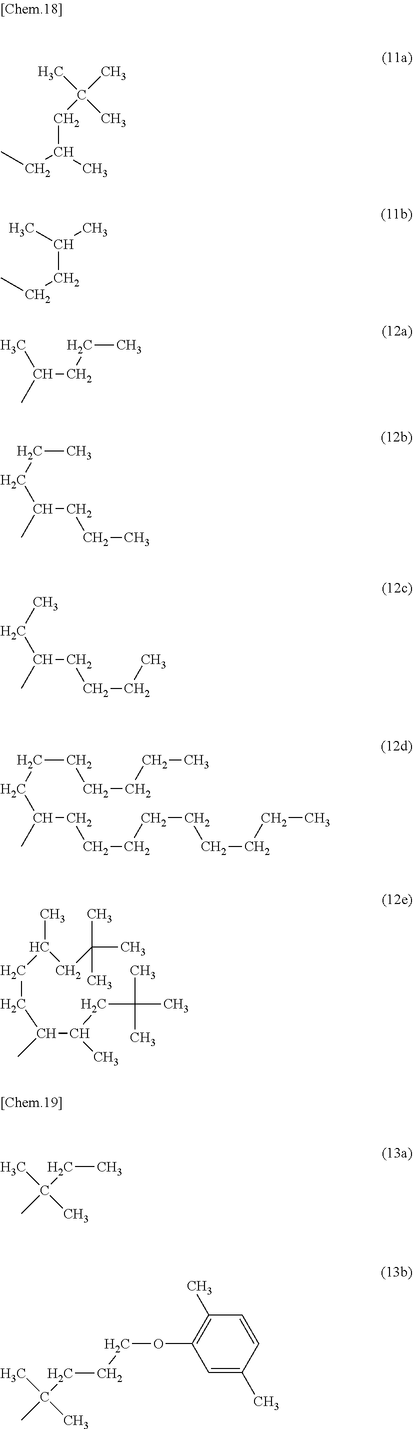

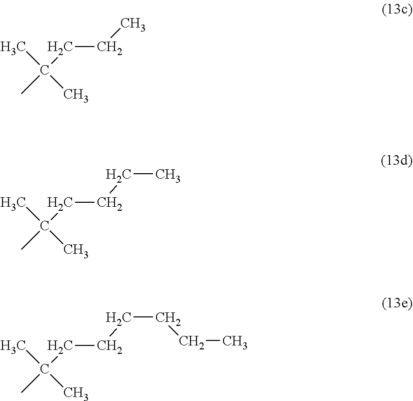

More specific examples of compounds (I-11) include the compounds shown in the following Table 6. In Table 6, group (11-1) is denoted by (11-1). The same holds true for other groups. The notation of groups is the same also in other Tables set forth below. In each of the compounds shown in Table 6, the symbols on the left-hand side of the squarylium skeleton have the same meanings as those on the right-hand side. The same holds true for the squarylium dyes shown in other Tables below.

TABLE 6

| Abb. of | Substituent | | | | |
|---|---|---|---|---|---|
| dye | —Y¹—X¹— | R²¹ | R²⁹ | R²³ | R²⁶ |
| I-11-1 | (11-1) | —CH₃ | (2b) | H | H |
| I-11-2 | (11-1) | —CH₃ | (2c) | H | H |
| I-11-3 | (11-1) | —CH₃ | (2d) | H | H |
| I-11-4 | (11-1) | —CH₃ | (2c) | H | H |
| I-11-5 | (11-1) | —CH₂CH₃ | (2c) | H | H |
| I-11-6 | (11-1) | —CH₂CH₂CH₃ | (2c) | H | H |
| I-11-7 | (11-1) | —CH(CH₃)₂ | (2c) | H | H |
| I-11-8 | (11-1) | —CH₂CH₃ | (3b) | H | H |
| I-11-9 | (11-1) | —CH₃ | (1b) | H | H |
| I-11-10 | (11-1) | —CH₃ | (2a) | H | H |
| I-11-11 | (11-1) | —CH₃ | (1a) | H | H |
| I-11-12 | (11-1) | —CH₃ | (3a) | H | H |
| I-11-13 | (11-1) | —CH₃ | (3b) | H | H |
| I-11-14 | (11-1) | —CH₃ | (3c) | H | H |
| I-11-15 | (11-1) | —C(CH₃)₂CH₂CH₃ | (2c) | H | H |
| I-11-16 | (11-1) | —C(CH₃)₂CH₂CH₃ | (3b) | H | H |
| I-11-17 | (11-1) | —C(CH₃)₂CH₂CH₃ | (3c) | H | H |
| I-11-18 | (11-1) | —C(CH₃)₂CH₂CH₃ | (3d) | H | H |
| I-11-19 | (11-1) | —C(CH₃)₂CH₂CH₃ | (3e) | H | H |
| I-11-20 | (11-1) | —CH(CH₃)₂ | —C₂F₅ | H | H |

In compounds (I-1), R²⁴ is preferably —NH-S02-R³⁰ from the standpoint of increasing visible-light transmittance, in particular transmittance for light having wavelengths of 430 to 550 nm. Compounds (I-1) in which R²⁴ is —NH-S02-R³⁰ are shown by formula (I-12).

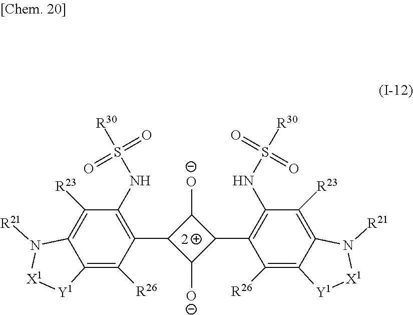

In compounds (I-12), the R²³ and R²⁶ moieties are each independently preferably a hydrogen atom, a halogen atom, a C1-C6 alkyl group, or a C1-C6 alkoxy group, and each more preferably a hydrogen atom.

In compounds (I-12), the R³⁰ moieties are each independently preferably an alkyl group which has a carbon number of 1 to 12 and may have a branch, an alkoxy group which has a carbon number of 1 to 12 and may have a branch, or a hydrocarbon group which has a carbon number of 6 to 16 and includes an unsaturated ring structure, from the standpoint of light resistance. Examples of the unsaturated ring structure include benzene, toluene, xylene, furan, and benzofuran. More preferably, the R³⁰ moieties are each independently an alkyl group which has a carbon number of 1 to 12 and may have a branch or an alkoxy group which has a carbon number of 1 to 12 and may have a branch. In each of the groups represented by R³⁰, some or all of the hydrogen atoms each may have been replaced by a halogen atom, in particular fluorine atom. The replacement of hydrogen atoms by fluorine atoms needs to be to such a degree as not to result in a decrease in adhesion between the resin layer containing the dye (I-12) and the resin substrate.

Specific examples of R³⁰ including an unsaturated ring structure include the groups represented by the following formulae (P2), (P3), (P7), (P8), and (P10) to (P13).

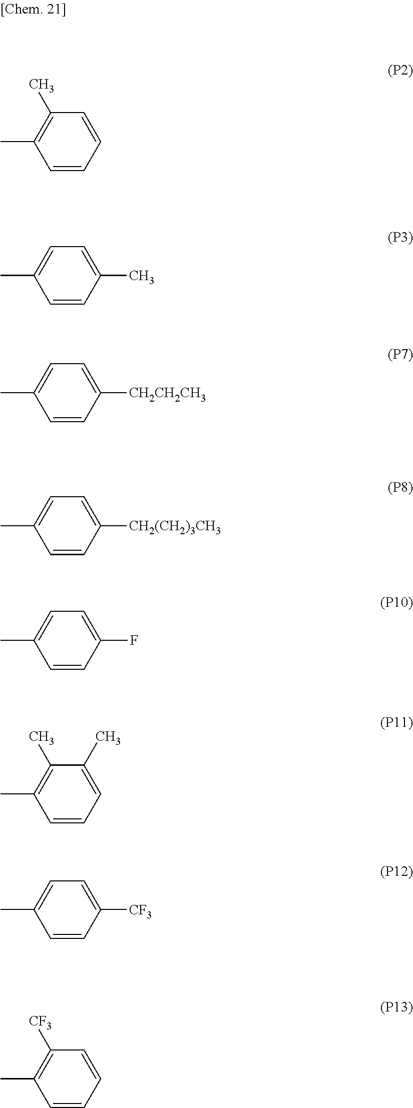

More specific examples of compounds (1-12) include the compounds shown in the following Table 7.

TABLE 7

| Abb. of | Substituent | | | | |
|---|---|---|---|---|---|
| dye | —Y¹—X¹— | R²¹ | R²⁹ | R²³ | R²⁶ |
| I-12-1 | (11-1) | —CH₃ | —CH₂(CH₂)₆CH₃ | H | H |
| I-12-2 | (11-1) | —CH₃ | —CF₃ | H | H |
| I-12-3 | (11-1) | —CH₃ | —CF₂(CF₂)₂CF₃ | H | H |
| I-12-4 | (11-1) | —CH₃ | (P2) | H | H |
| I-12-5 | (11-1) | —CH₃ | (P5) | H | H |
| I-12-6 | (11-1) | —CH₃ | (P7) | H | H |
| I-12-7 | (11-1) | —CH₃ | (P8) | H | H |
| I-12-8 | (11-1) | —CH₃ | (P6) | H | H |
| I-12-9 | (11-1) | —CH(CH₃)₂ | —CF₃ | H | H |
| I-12-10 | (11-1) | —CH(CH₃)₂ | —CH(CH₃)₂ | H | H |
| I-12-11 | (11-1) | —CH(CH₃)₂ | (P4) | H | H |
| I-12-12 | (11-1) | —CH(CH₃)₂ | (P3) | H | H |
| I-12-13 | (11-1) | —CH(CH₃)₂ | —CH₂CH₂CH₃ | H | H |
| I-12-14 | (11-1) | —CH(CH₃)₂ | (P7) | H | H |
| I-12-15 | (11-1) | —CH(CH₃)₂ | —CH₂(CH₂)₆CH₃ | H | H |
| I-12-16 | (11-1) | —CH(CH₃)₂ | (P6) | H | H |
| I-12-17 | (11-1) | —CH(CH₃)₂ | —CF₂(CF₂)₂CF₃ | H | H |
| I-12-18 | (11-1) | —CH(CH₃)₂ | (P1) | H | H |
| I-12-19 | (11-1) | —CH(CH₃)₂ | (P8) | H | H |
| I-12-20 | (11-1) | —C(CH₃)₂CH₂CH₃ | —CH₂(CH₂)₆CH₃ | H | H |
| I-12-21 | (11-1) | —C(CH₃)₂CH₂CH₃ | —CF₃ | H | H |
| I-12-22 | (11-1) | —C(CH₃)₂CH₂CH₃ | —CF₂(CF₂)₂CF₃ | H | H |
| I-12-23 | (11-4) | —CH(CH₃)₂ | —CH₂(CH₂)₆CH₃ | H | H |
| I-12-24 | (11-4) | —CH(CH₃)₂ | —CH₂(CH₂)₂CH₃ | H | H |

Examples of compounds (II) include compounds represented by any of formulae (II-1) to (II-3).

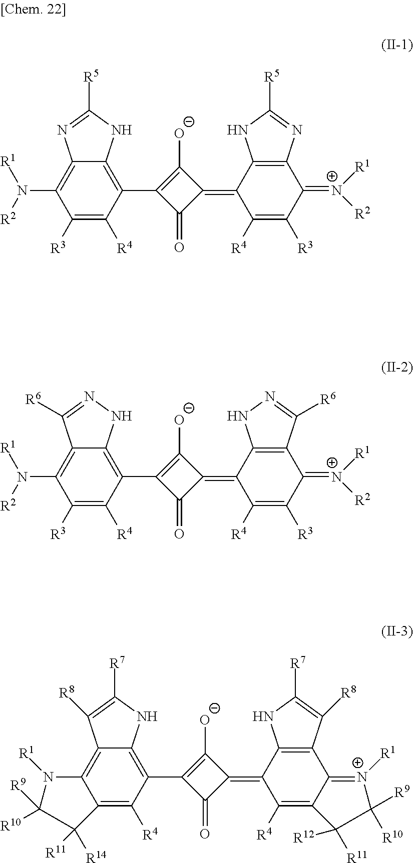

In formulae (II-1) and (II-2), the R¹ and R² moieties each independently represent a hydrogen atom, a halogen atom, or an alkyl group which has a carbon number of 1 to 15 and may have a substituent, and the R³ to R⁶ moieties each independently represent a hydrogen atom, a halogen atom, or an alkyl group which has a carbon number of 1 to 10 and may have a substituent.

In formula (II-3), the R¹, R⁴, and R⁹ to R¹² moieties each independently represent a hydrogen atom, a halogen atom, or an alkyl group which has a carbon number of 1 to 15 and may have a substituent, and the R⁷ and R⁸ moieties each independently represent a hydrogen atom, a halogen atom, or an alkyl group which has a carbon number of 1 to 5 and may have a substituent.

From the standpoints of solubility in resins, transparency to visible light, etc., the R¹ and R² moieties in compounds (II-1) and compounds (II-2) are each independently preferably a C₁-C₁₅ alkyl group, more preferably a C₇-C₁₅ alkyl group. It is still more preferable that at least one of R¹ and R² is a C₇-C₁₅ alkyl group having a branch. It is especially preferable that both R¹ and R² are C₈-C₁₅ alkyl groups each having a branch.

The R³ moieties are each independently preferably a hydrogen atom, a halogen atom, or an alkyl group having 1 to 3 carbon atoms, more preferably a hydrogen atom, a halogen atom, or a methyl group, from the standpoints of solubility in resins, transparency to visible light, etc. R⁴ is preferably a hydrogen atom or a halogen atom, especially preferably a hydrogen atom, from the standpoint of the steepness of change in the vicinity of the boundary between the visible region and the near-infrared region in a spectral transmittance curve. The R⁵ moieties in compounds (II-1) and the R⁶ moieties in compounds (II-2) are each independently preferably a hydrogen atom, a halogen atom, or an alkyl group which has a carbon number of 1 to 5 and may have been substituted with a halogen atom, and more preferably a hydrogen atom, a halogen atom, or a methyl group.

More specific examples of compounds (II-1) and compounds (II-2) include the compounds shown in the following Tables 8 and 9, respectively. In Tables 8 and 9, —C₈H₁₇, —C₄H₉, and —C₆H₁₃ represent a linear octyl group, a linear butyl group, and a linear hexyl group, respectively.

TABLE 8

| | Substituent | | | | |
|---|---|---|---|---|---|
| Abb. of dye | R¹ | R² | R³ | R⁴ | R⁵ |
| II-1-1 | —CH₂CH(C₂H₅)(C₄H₉) | —CH₂CH(C₂H₅)(C₄H₉) | H | H | H |
| II-1-2 | —CH₂CH(C₂H₅)(C₄H₉) | —CH₂CH(C₂H₅)(C₄H₉) | H | H | —C(CH₃)₃ |
| II-1-3 | —CH₂CH(C₂H₅)(C₄H₉) | —CH₂CH(C₂H₅)(C₄H₉) | H | H | —CF₃ |
| II-1-4 | —CH₂CH(C₂H₅)(C₄H₉) | —CH₂CH(C₂H₅)(C₄H₉) | H | H | —CH₃ |
| II-1-5 | —CH₂CH(C₂H₅)(C₄H₉) | —CH₂CH(C₂H₅)(C₄H₉) | H | H | —C₈H₁₇ |
| II-1-6 | —(CH₂)₂CH(CH₃)₂ | —(CH₂)₂CH(CH₃)₂ | H | H | H |
| II-1-7 | —CH₂CH(CH₃)₂ | —CH₂CH(CH₃)₂ | H | H | H |
| II-1-8 | —CH₂CH(C₂H₅)(C₄H₉) | —C₂H₅ | H | H | H |
| II-1-9 | —(CH₂)₅CH₃ | —(CH₂)₃CH₃ | H | H | H |
| II-1-10 | —CH₂CH(C₂H₅)(C₆H₁₃) | —CH₂CH(C₂H₅)(C₆H₁₃) | H | H | H |

TABLE 9

| Abb. | Substituent | | | | |
|---|---|---|---|---|---|
| of dye | R¹ | R² | R³ | R⁴ | R⁶ |
| 11-2-1 | —(CH₂)₂CH(CH₃)₂ | —(CH₂)₂CH(CH₃)₂ | H | H | H |
| 11-2-2 | —CH₂CH(C₂H₅)(C₄H₉) | —CH₂CH(C₂H₅)(C₄H₉) | H | H | H |
| 11-2-3 | —CH₂CH(CH₃)₂ | —CH₂CH(CH₃)₂ | H | H | H |
| 11-2-4 | —CH₂CH(C₂H₅)(C₆H₁₃) | —CH₂CH(C₂H₅)(C₆H₁₃) | H | H | H |

From the standpoints of solubility in resins, transparency to visible light, etc., the R¹ moieties in compounds (II-3) are each independently preferably a C₁-C₁₅ alkyl group, more preferably a C₁-C₁₀ alkyl group, especially preferably an ethyl or isopropyl group.

From the standpoints of transparency to visible light and ease of synthesis, R⁴ is preferably a hydrogen atom or a halogen atom, especially preferably a hydrogen atom. The R⁷ and R⁸ moieties are each independently preferably a hydrogen atom, a halogen atom, or an alkyl group which has a carbon number of 1 to 5 and may have been substituted with a halogen atom, more preferably a hydrogen atom, a halogen atom, or a methyl group.

The R⁹ to R¹² moieties are each independently preferably a hydrogen atom, a halogen atom, or an alkyl group which has a carbon number of 1 to 5 and may have been substituted with a halogen atom. Examples of —CR⁹R¹⁰—CR¹¹R¹²— include groups (11-1) to (11-3) shown above and the divalent organic group represented by the following formula (11-5).

—C(CH₃)(CH₂—CH(CH₃)₂)—CH(CH₃)— (11-5)

More specific examples of compounds (II-3) include the compounds shown in the following Table 10.

TABLE 10

| Abb. | Substituent | | | | |
|---|---|---|---|---|---|
| of dye | —CR⁹R¹⁰—CR¹¹R¹²— | R¹ | R⁴ | R⁷ | R⁸ |
| 11-3-1 | (11-1) | —C₂H₅ | H | H | H |
| 11-3-2 | (11-5) | —C₂H₅ | H | H | H |
| 11-3-3 | (11-1) | —CH(CH₃)₂ | H | H | —CH₃ |

Among these dyes, preferred for use as the NIR dye (B), from the standpoints of solubility in resins and solvents and transparency to visible light, are dyes (I-11) and dyes (I-12). More preferred are the dyes (I-11) shown in Table 6 and the dyes (I-12) shown in Table 7. Among these, preferred are dyes (I-11-7), (I-11-20), (I-12-2), (I-12-9), (I-12-15), etc.

The NIR dye (B) may consist of a single compound or may be composed of two or more compounds. In the case where the NW dye (B) is composed of two or more compounds, each compound need not always have the properties of an NW dye (B) and it is only required that the compounds as a mixture should have the properties of an NW dye (B).

Compounds (I) and compounds (II) each can be produced by known methods. Among the compounds (I), compounds (I-11) can be produced, for example, by the method described in U.S. Pat. No. 5,543,086, and compounds (I-12) can be produced, for example, by the methods described in U.S. Patent Application Publication No. 2014/0061505 and International Publication WO 2014/088063. Compounds (II) can be produced by the method described in International Publication WO 2017/135359.

The content of the NW dye (B) in the external resin layer or intermediate resin layer containing the NW dye (B) depends on the thickness of the resin layer. However, from the standpoints of NIR shielding properties and solubility, the content of the NW dye (B) is preferably 0.1 to 20 parts by mass, more preferably 1 to 20 parts by mass, per 100 parts by mass of the resin included in the layer. In the case where the thickness of the resin layer containing the NIR dye (B) is 5 μm or less, the content of the NIR dye (B) in the resin layer is preferably 5 to 20 parts by mass, more preferably 5 to 15 parts by mass, per 100 parts by mass of the resin.

Besides containing NIR dyes, the external resin layer or the intermediate resin layer may contain dyes other than NIR dyes, e.g., a UV dye, so long as the inclusion thereof does not lessen the effects of the present invention.

### (UV Dye)

The UV dye that the external resin layer or the intermediate resin layer optionally contains is preferably a UV dye (U) satisfying the following requirement (iii-1).

(iii-1) The UV dye (U) has, in a spectral transmittance curve over a wavelength range of 350 to 1,100 nm when examined in the state of having been dissolved in dichloromethane a maximum absorption wavelength λ_{max(U)DCM} within a wavelength range of 380 to 420 nm. The maximum absorption wavelength λ_{max(U)DCM} of the UV dye (U) is more preferably within a wavelength range of 380 to 415 nm, still more preferably within a wavelength range of 390 to 410 nm.

Specific examples of the UV dye (U) include oxazole dyes, merocyanine dyes, cyanine dyes, naphthalimide dyes, oxadiazole dyes, oxazine dyes, oxazolidine dyes, naphthalic acid dyes, styryl dyes, anthracene dyes, cyclic carbonyl dyes, and triazole dyes. Among these, preferred are oxazole dyes and merocyanine dyes. More preferred are merocyanine dyes. In the external resin layer or intermediate resin layer, one UV dye (U) may be used alone or two or more UV dyes (U) may be used in combination.

The UV dye (U) preferably further satisfies the following requirement (iii-2).

(iii-2) The UV dye (U) has, in a spectral transmittance curve over a wavelength range of 350 to 1,100 nm when examined in the state of being contained in dichloromethane so as to result in a transmittance of 1% at the maximum absorption wavelength λ_{max(U)DCM}, an average transmittance for a wavelength range of 435 to 500 nm (hereinafter, referred to as “T_{435-500ave(U)DCM}”) of 94% or higher and an average transmittance for a wavelength range of 500 to 600 nm (hereinafter, referred to as “T_{500-600ave(U)DCM}”) of 94% or higher.

T_{435-500ave(U)DCM} is preferably 95% or higher, more preferably 96% or higher. T_{500-600ave(U)DCM} is preferably 95% or higher, more preferably 96% or higher.

In the case where a UV dye (U) satisfying both (iii-1) and (iii-2) is used together with the NIR dye (A), preferably with the NIR dye (A) and the NIR dye (B), the present filter can attain high visible-light transmittances and good NIR-shielding and UV-shielding properties.

The UV dye (U) is especially preferably a merocyanine dye represented by formula (M).

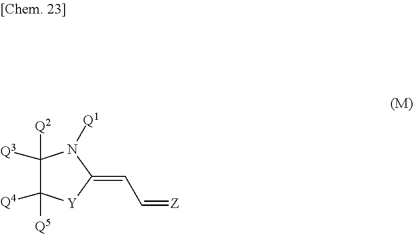

In formula (M), Y represents a substituted or unsubstituted methylene group or an oxygen atom. Examples of the substituent(s) of the substituted methylene group include halogen atoms and C₁-C₁₀ alkyl or alkoxy groups. Preferred are C₁-C₁₀ alkyl or alkoxy groups. In the case where Y is a substituted or unsubstituted methylene group, this Y is preferably an unsubstituted methylene group or a methylene group in which one of the hydrogen atoms has been replaced by a C₁-C₄ alkyl group, and especially preferably an unsubstituted methylene group.

Q¹ represents a substituted or unsubstituted monovalent hydrocarbon group with a carbon number of 1 to 12. In the case where Q¹ is a substituted hydrocarbon group, a preferred substituent is an alkoxy group, an acyl group, an acyloxy group, a cyano group, a dialkylamino group, or a chlorine atom. The alkoxy, acyl, acyloxy, and dialkylamino groups each preferably have a carbon number of 1 to 6.

Preferred examples of Q¹ not having any of those substituents are: a C₁-C₁₂ alkyl group in which some of the hydrogen atoms each may have been replaced by an aliphatic ring, an aromatic ring, or an alkenyl group; a C₃-C₈ cycloalkyl group in which some of the hydrogen atoms each may have been replaced by an aromatic ring, an alkyl group, or an alkenyl group; and a C₆-C₁₂ aryl group in which some of the hydrogen atoms each may have been replaced by an aliphatic ring, an alkyl group, or an alkenyl group.

In the case where Q¹ is an unsubstituted alkyl group, this alkyl group may be linear or branched and the carbon number thereof is more preferably 1 to 6.

In the case where Q¹ is an alkyl group which has a carbon number of 1 to 12 and in which some of the hydrogen atoms each have been replaced by an aliphatic ring, an aromatic ring, or an alkenyl group, this Q¹ is more preferably a C₁-C₄ alkyl group which has a cycloalkyl group with a carbon number of 3 to 6 or a C₁-C₄ alkyl group which has been substituted by a phenyl group, and is especially preferably an alkyl group with a carbon number of 1 or 2 which has been substituted by a phenyl group. The term “alkyl group substituted by an alkenyl group” means a group which as a whole is an alkenyl group but does not have an unsaturated bond between the 1- and 2-positions; examples thereof include an allyl group and a 3-butenyl group.

Q¹ is preferably an alkyl group which has a carbon number of 1 to 6 and in which some of the hydrogen atoms each may have been replaced by a cycloalkyl group or a phenyl group. Q¹ is especially preferably a C₁-C₆ alkyl group, and specific examples thereof include methyl, ethyl, n-propyl, isopropyl, n-butyl, isobutyl, and t-butyl groups.

Q² to Q⁵ each independently represent a hydrogen atom, a halogen atom, a C₁-C₁₀ alkyl group, or a C₁-C₁₀ alkoxy group. The carbon number of the alkyl group and that of the alkoxy group are each preferably 1 to 6, more preferably 1 to 4.

It is preferable that at least one of Q² and Q³ is an alkyl group, and it is more preferable that both are alkyl groups. In the case where Q² or Q³ is not an alkyl group, this Q² or Q³ is more preferably a hydrogen atom. It is especially preferable that Q² and Q³ are each a C₁-C₆ alkyl group.

It is preferable that at least one of Q⁴ and Q⁵ is preferably a hydrogen atom, and it is more preferable that both are hydrogen atoms. In the case where Q⁴ or Q⁵ is not a hydrogen atom, this Q⁴ or Q⁵ is preferably a C₁-C₆ alkyl group.

Z represents any of divalent groups represented by formulae (Z1) to (Z5).

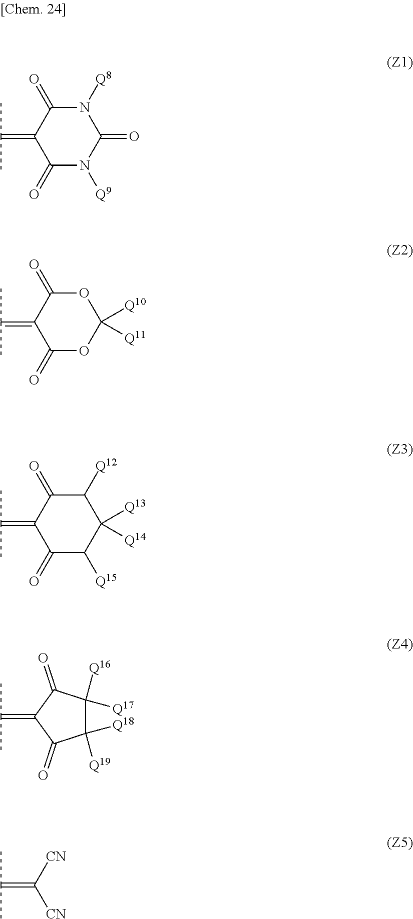

In formulae (Z1) to (Z5), Q⁸ to Q¹⁹ each independently represent a substituted or unsubstituted monovalent hydrocarbon group with a carbon number of 1 to 12. In the case where Q⁸ to Q¹⁹ are substituted hydrocarbon groups, examples of the substituents include the same substituents as the substituents in Q¹, and preferred examples are also the same. In the case where Q⁸ to Q¹⁹ are hydrocarbon groups having no substituent, examples thereof include the same groups as the examples of Q¹ having no substituent.

In formula (Z1), Q⁸ and Q⁹ may be different groups but are preferably the same group. In the case where Q⁸ and Q⁹ are each an unsubstituted alkyl group, the alkyl group may be linear or branched and the number of carbon atoms thereof is more preferably 1 to 6.

Q⁸ and Q⁹ are each preferably an alkyl group which has 1 to 6 carbon atoms and in which some of the hydrogen atoms each may have been replaced by a cycloalkyl group or a phenyl group. Q⁸ and Q⁹ are each especially preferably an alkyl group having 1 to 6 carbon atoms, and specific examples thereof include methyl, ethyl, n-propyl, isopropyl, n-butyl, isobutyl, and t-butyl groups.

In formula (Z2), Q¹⁰ and Q¹¹ are each more preferably an alkyl group having 1 to 6 carbon atoms, and are especially preferably the same alkyl group.

In formula (Z3), Q¹² and Q¹⁵ are each preferably a hydrogen atom or a C₁-C₆ alkyl group which has no substituent. The two moieties Q¹³ and Q^{m}, which have been bonded to the same carbon atom, are each preferably a hydrogen atom or a C₁-C₆ alkyl group. In formula (Z4), the two moieties Q¹⁶ and Q¹⁷, which have been bonded to the same carbon atom, and the two moieties Q¹⁸ and Q¹⁹, which have been bonded to the same carbon atom, are each preferably a hydrogen atom or a C₁-C₆ alkyl group.

Preferred examples of the compound represented by formula (M) are a compound in which Y is an oxygen atom and Z is group (Z1) or group (Z2) and a compound in which Y is an unsubstituted methylene group and Z is group (Z1) or group (Z5).

More specific examples of dyes (M) include the compounds shown in the following Table 11. In Table 11, —C₃H₇ represents an n-propyl group.

TABLE 11

| Abb. of | Substituent | | | | | | | | | | |
|---|---|---|---|---|---|---|---|---|---|---|---|
| dye | Q¹ | Q² | Q³ | Q⁴ | Q⁵ | Y | Z | Q⁸ | Q⁹ | Q¹⁰ | Q¹¹ |
| M-1 | —CH₃ | H | H | H | H | —O— | Z1 | —CH₃ | —CH₃ | — | — |
| M-2 | —CH₃ | —CH₃ | —CH₃ | H | H | —O— | Z1 | —CH₃ | —CH₃ | — | — |
| M-3 | —CH₃ | —CH₃ | —CH₃ | H | H | —O— | Z1 | —C₃H₇ | —C₃H₇ | — | — |
| M-4 | —C₂H₅ | H | H | H | H | —O— | Z1 | —CH₃ | —CH₃ | — | — |
| M-5 | —C₂H₅ | —CH₃ | —CH₃ | H | H | —O— | Z1 | —CH₃ | —CH₃ | — | — |
| M-6 | —CH(CH₃)₂ | —CH₃ | —CH₃ | H | H | —O— | Z1 | —CH₃ | —CH₃ | — | — |
| M-7 | —C₂H₅ | —CH₃ | —CH₃ | H | H | —O— | Z1 | —C₃H₇ | —C₃H₇ | — | — |
| M-8 | —CH₃ | —CH₃ | —CH₃ | H | H | —O— | Z2 | — | — | —CH₃ | —CH₃ |
| M-9 | —CH₃ | H | H | H | H | —CH₂— | Z1 | —CH₃ | —CH₃ | — | — |
| M-10 | —CH(CH₃)₂ | H | H | H | H | —CH₂— | Z5 | — | — | — | — |
| M-11 | —C₂H₅ | H | H | H | H | —CH₂— | Z5 | — | — | — | — |

Among these UV dyes (U), preferred are dyes (M-1), (M-2), (M-5), (M-6), etc., from the standpoints of solubility in resins or solvents, transparency to visible light, in particular the ability to satisfy (iii-2), etc. Compounds (M) can be produced by known methods.

The UV dye (U) may consist of a single compound or may be composed of two or more compounds. In the case where the UV dye (U) is composed of two or more compounds, each compound need not always have the properties of a UV dye (U) and it is only required that the compounds as a mixture should have the properties of a UV dye (U).

The content of the UV dye (U) in the external resin layer or intermediate resin layer containing the UV dye (U) depends on the thickness of the resin layer. However, from the standpoints of UV shielding properties and solubility, the content thereof is preferably 0.01 to 20 parts by mass, more preferably 0.05 to 20 parts by mass, still more preferably 0.1 to 20 parts by mass, per 100 parts by mass of the resin included in the layer. The external resin layer or the intermediate resin layer may contain other UV dyes besides the UV dye (U) so long as the inclusion thereof does not lessen the effects of the present invention.

It is preferable in the present filter that the resin-including members as a whole have optical properties which satisfy all of (i-1) to (i-5), that is, the present filter from which the dielectric multilayer films have been removed shows optical properties which satisfy all of (i-1) to (i-5). In the case where the conditions are satisfied, the present filter has high transparency to visible light and high near-infrared light shielding properties.

Specifically, it is preferable that in the case of the optical filter 10A illustrated in FIG. 1, the configuration composed of the resin substrate 1 and, superposed on one main surface thereof, the intermediate resin layer 4 and the external resin layer 2 shows optical properties satisfying (i-1) to (i-5) and that in the case of the optical filter 10B illustrated in FIG. 2, the configuration composed of the resin substrate 1, the first intermediate resin layer 4a and first external resin layer 2a superposed on one of the main surfaces of the resin substrate 1, and the second intermediate resin layer 4b and second external resin layer 2b superposed on the other main surface shows optical properties satisfying (i-1) to (i-5). These optical properties are ones regarding an incident angle of 0°.

(i-1) To have an internal light transmittance of 20% at a wavelength within a wavelength range of 630 to 750 nm. The wavelength is preferably within a wavelength range of 650 to 690 nm, more preferably within a wavelength range of 650 to 680 nm.

(i-2) To have an internal light transmittance of 50% or less at a wavelength within a wavelength range of 800 to 1,200 nm. The wavelength is preferably within a wavelength range of 800 to 900 nm, more preferably within a wavelength range of 800 to 870 nm.

(i-3) [Absorbance at wavelength of 450 nm]/[maximum absorbance in wavelength range of 800 to 1,200 nm]≤0.075. [Absorbance at wavelength of 450 nm]/[maximum absorbance in wavelength range of 800 to 1,200 nm] is preferably 0.07 or less, more preferably 0.06 or less.

(i-4) [Absorbance at wavelength of 500 nm]/[maximum absorbance in wavelength range of 800 to 1,200 nm]≤0.065. [Absorbance at wavelength of 500 nm]/[maximum absorbance in wavelength range of 800 to 1,200 nm] is preferably 0.06 or less, more preferably 0.05 or less.

(i-5) [Absorbance at wavelength of 700 nm]/[maximum absorbance in wavelength range of 800 to 1,200 nm]≥1.00. [Absorbance at wavelength of 700 nm]/[maximum absorbance in wavelength range of 800 to 1,200 nm] is preferably 1.5 or larger, more preferably 1.6 or larger.

### [Dielectric Multilayer Films]

As illustrated in the optical filter 10A of FIG. 1 and the optical filter 10B of FIG. 2, both main surfaces of the present filter are constituted of dielectric multilayer films. In the present filter, at least one of the dielectric multilayer films has been designed as an NIR reflection layer. The present filter is less apt to be deformed by heat or stress because the resin substrate, the intermediate resin layer(s), and the external resin layer(s) have the configurations described above, and this sufficiently inhibit the dielectric multilayer films from separating from the resin substrate or external resin layer. Furthermore, due to the properties of the resin included in the external resin layer, the dielectric multilayer film overlying the external resin layer is sufficiently inhibited from peeling off.

In the present filter, dyes including the NIR dye (A) are contained in the intermediate resin layer and/or the external resin layer as specified above. In the following explanations, the external resin layer of the present filter including no intermediate resin layer is sometimes referred to also as “absorption layer”, or the superposed resin layers composed of an external resin layer and an intermediate resin layer in the present filter including both the external resin layer and the intermediate resin layer are sometimes referred to also as “absorption layer”.

The NIR reflection layer is a dielectric multilayer film designed to shield light in the near-infrared region. The NIR reflection layer has wavelength selectivity whereby the NIR reflection layer, for example, transmits visible light and mainly reflects light having wavelengths in the near-infrared region other than a light-blocking range for the absorption layer. The reflection region of the NIR reflection layer may include a light-blocking range of the absorption layer in the near-infrared region. The NIR reflection layer may be appropriately designed so that the NIR reflection layer not only has the NIR reflection properties but also further blocks light having wavelengths outside the near-infrared region, e.g., light in a near-ultraviolet region.

In the present filter, the absorption layer and the NIR reflection layer preferably have the following relationship. The absorption layer preferably has λ_{ABIRSHT20-0°} within a wavelength range of 650 to 720 nm, the λ_{ABIRSHT20-0°} being a shorter wavelength-side wavelength at which a transmittance for light entering at an incident angle of 0° is 20% and which is within a near-infrared absorption range. It is preferable that the λ_{ABIRSHT20-0°} satisfies relationship (iv-1) with λ_{REIRSHT20-0°}, which is a shorter wavelength-side wavelength at which the NIR reflection layer has a transmittance for light entering at an incident angle of 0° of 20% and which is within a near-infrared reflection range.

(iv-1) [λ_{ABIRSHT20-0°}+30 nm]≤λ_{REIRSHT20-0°}≤790 nm

The NIR reflection layer preferably further satisfies (iv-2).

(iv-2) To have an average transmittance for light having wavelengths ranging from λ_{REIRSHT20-0°} to λ_{REIRSHT20-0°}+300 nm of 10% or less.

The present filter has high near-infrared light shielding properties because the absorption layer, due to the NIR dye (A) contained therein, absorbs light which entered at high incident angles and has leaked through the NIR reflection layer. In a preferred embodiment of the present filter, the absorption layer contains an NIR dye (B) and, because of this, the incident-angle dependence of the NIR reflection layer with respect to light which has entered at high incident angles can be reduced. In particular, the incident-angle dependence of the NIR reflection layer at the boundary between the visible-light region and the near-infrared region can be reduced.

In the case where the present filter has been designed so that the absorption layer further contains a UV dye (U) and the NIR reflection layer further blocks light in a near-ultraviolet range, it is preferable that the absorption layer and the NIR reflection layer have the following relationship.

The absorption layer preferably has λ_{ABUVLO20-0°} within a wavelength range of 395 to 420 nm, the λ_{ABUVLO20-0°} being a longer wavelength-side wavelength at which a transmittance for light entering at an incident angle of 0° is 20% and which is within a near-ultraviolet absorption range. Further, the NIR reflection layer has λ_{REUVLO20-0°} within a wavelength range of 390 to 420 nm, the λ_{REUVLO20-0°} being a longer wavelength-side wavelength at which a transmittance for light entering at an incident angle of 0° is 20% and which is within a near-ultraviolet reflection range.

The NIR reflection layer is constituted of a dielectric multilayer film formed by alternately stacking low-refractive index dielectric films (low-refractive index films) and high-refractive index dielectric films (high-refractive index films). The high-refractive index films have a refractive index of preferably 1.6 or higher, more preferably 2.2 to 2.5. Examples of the material of the high-refractive index films include Ta₂O₅, TiO₂, and Nb₂O₅. Among these, TiO₂ is preferred from the standpoints of reproducibility, stability, etc. regarding film-forming properties, refractive index, etc.

On the other hand, the low-refractive index films have a refractive index of preferably less than 1.6, more preferably 1.45 or higher but less than 1.55. Examples of the material of the low-refractive index films include SiO₂ and SiOₓN_{y}. SiO₂ is preferred from the standpoints of reproducibility and stability regarding film-forming properties, profitability, etc.

It is preferable that the NIR reflection layer changes steeply in transmittance in a boundary wavelength range between the transmission region and the light blocking region. For this purpose, the total number of stacked layers in the dielectric multilayer film constituting the NIR reflection layer is preferably 15 or more, more preferably 25 or more, still more preferably 30 or more. However, if the total number of stacked layers is too large, warping, etc. may occur and the film thickness may increase. Hence, the total number of stacked layers is preferably 100 or less, more preferably 75 or less, still more preferably 60 or less. The thickness of the dielectric multilayer film is preferably 2 to 10 μm.

In the case where the total number of stacked layers and thickness of the dielectric multilayer film are in those ranges, the NIR reflection layer satisfies a requirement for miniaturization and can have a reduced incident-angle dependence while maintaining high production efficiency. For forming the dielectric multilayer film, use can be made, for example, of a vacuum film-forming process such as a CVD method, sputtering method or vacuum deposition method, or a wet film-forming process such as a spray method or a dip method.

A single NIR reflection layer (a group of dielectric multilayer films) may be included as the only layer for imparting given optical properties, or two NIR reflection layers may be included for imparting the given optical properties. Taking the optical filter 10A illustrated in FIG. 1 as an example for explanation, in the case where one of the first dielectric multilayer film 3a and second dielectric multilayer film 3b of the optical filter 10A is an NIR reflection layer, then the other is an NIR reflection layer, a reflection layer having a reflection region outside the near-infrared region, or an antireflection layer.

Also in the case where the first dielectric multilayer film 3a or the second dielectric multilayer film 3b is either a reflection layer having a reflection region outside the near-infrared region or an antireflection layer, this dielectric multilayer film is appropriately designed and formed so that the structure configured by alternately stacking low-refractive index films and high-refractive index films provides the desired reflection properties, like the above-described NIR reflection layer.

In the case where both the first dielectric multilayer film 3a and the second dielectric multilayer film 3b are NIR reflection layers, these NIR reflection layers may have the same configuration or different configurations. In the case of an optical filter including two NIR reflection layers, the two layers are usually configured so as to differ in reflection band.

In the case of forming two NIR reflection layers, it is possible to configure one of the layers as an NIR reflection layer for shielding light having wavelengths in a shorter-wavelength band within the near-infrared region and to configure the other as an NIR reflection layer for shielding both light having wavelengths in a longer-wavelength band within the near-infrared region and light having wavelengths in the near-ultraviolet region.

The present filter may include, as other constituent elements, for example, a constituent element (layer) giving absorption by inorganic fine particles, etc. which controls the transmission and absorption of light having wavelengths in a specific region. Specific examples of the inorganic fine particles include ITO (indium tin oxides), ATO (antimony-doped tin oxides), cesium tungstate, and lanthanum boride. Fine ITO particles and fine cesium tungstate particles have high visible-light transmittances and have light absorbing properties in a wide infrared wavelength range exceeding 1,200 nm, and can hence be used in the case where the property of shielding such infrared light is required.

The present filter is an optical filter which has high transparency to visible light and the property of highly shielding near-infrared light, in particularly near-infrared light having longer wavelengths, and which has excellent adhesion between each dielectric multilayer film and the resin layer, is inhibited from thermally deforming, and has excellent heat resistance.

The present filter preferably satisfies all of the following requirements (I-1) to (I-5) regarding optical properties.

(I-1) To have an average transmittance T₄₃₅₋₄₈₀ₐᵥₑ₀ for light entering at an incident angle of 0° in a wavelength range of 435-480 nm of 82% or higher. T₄₃₅₋₄₈₀ₐᵥₑ₀ is more preferably 82.5% or higher.

(I-2) To have an average transmittance T₄₉₀₋₅₆₀ₐᵥₑ₀ for light entering at an incident angle of 0° in a wavelength range of 490-560 nm of 82% or higher. T₄₉₀₋₅₆₀ₐᵥₑ₀ is more preferably 83.5% or higher.

(I-3) To have a transmittance of 20% for light entering at an incident angle of 0° and having a wavelength within a wavelength of 600-700 nm. The wavelength range where a wavelength at which the transmittance is 20% is present is more preferably 650 to 690 nm, still more preferably 660 to 680 nm.

(I-4) To have a transmittance of 20% for light entering at an incident angle of 0° and having a wavelength λ_{0°-20%} within a 600-700 nm range and have a transmittance of 20% for light entering at an incident angle of 30° and having a wavelength λ_{30°-20%} within a 600-700 nm range, the difference therebetween |λ_{0°-20%}−λ_{30°-20%}| being 5 nm or less. |λ_{0°-20%}−λ_{30°-20%| is more preferably} 4 nm or less, still more preferably 3 nm or less.

(I-5) At each of incident angles of 0° and 30°, to have a minimum OD of 4.0 or more in a wavelength range of [maximum absorption wavelength λ_{max(A)TR} of the near-infrared absorbing dye (A)]±10 nm. The minimum OD is preferably 4.5 or more.

In the case where the present filter is used, for example, for an imaging device such as digital still camera, an imaging device having excellent color reproducibility and having excellent heat resistance of the color reproducibility can be provided. Also, in the present filter of a preferred embodiment, the separation of the dielectric multilayer films is inhibited, so that an imaging device having excellent durability can be provided. An imaging device using the present filter includes a solid-state image sensing device, an imaging lens, and the present filter. The present filter can be used, for example, by disposing the present filter between the imaging lens and the solid-state image sensing device or by directly attaching the present filter to the solid-state image sensing device, imaging lens, etc. of the imaging device via an adhesive layer.

### EXAMPLES

The present invention is more specifically described below by referring to Examples. For measuring each of the following optical properties, an ultraviolet-visible spectrophotometer (Model U-4100, manufactured by Hitachi High Technologies Co., Ltd.) was used.

### [Evaluation of Resins for Resin Substrate]

Using commercially available resin films shown in Table 12, spectral transmittance curves and spectral reflectance curves over a wavelength range of 350 to 1,100 nm for light entering at an incident angle of 5° were obtained. Based on the obtained transmittances and reflectances, an average internal transmittance T_{350-450ave(TR)} in a wavelength range of 350 to 450 nm and a minimum internal transmittance T_{400-450min(TR)} in a wavelength range of 400 to 450 nm, both calculated in terms of a thickness of 100 μm, were determined.

The results are shown in Table 12 together with the trade name, thickness, kind of resin, manufacturer, and Tg of each resin film. In Table 12, NEOPRIM, PURE-ACE, Teonex, and ZeonorFilm are registered trademarks. In the following description, only symbols are presented by omitting trademarks. “M5-80” and “S5-100” indicate an 80 μm-thick film of PURE-ACE (registered trademark) M5 and a 100 μm-thick film of PURE-ACE (registered trademark) S5, respectively. In the following, “M5-80” each has the same meaning. As for the kinds of resin, the following abbreviations were used: PI is a polyimide resin; PC is a polycarbonate resin; PET is a polyethylene terephthalate resin; PEN is a polyethylene naphthalate resin; and COP is a cycloolefin resin.

TABLE 12

| | Thickness | Kind of | | | T_{350-450ave(TR)} | T_{400-450min(TR)} |
|---|---|---|---|---|---|---|
| Trade name | [μm] | resin | Manufacturer | Tg [° C.] | [%] | [%] |
| NEOPRIM | 50 | PI | Mitsubishi Gas | 320 | 100 | 99.7 |
| L-3G30 | | | Chemical | | | |
| PURE-ACE | 80 | PC | Teijin | 215 | 99.4 | 99.2 |
| M5-80 | | | | | | |
| PURE-ACE | 100 | PC | Teijin | 225 | 98.9 | 99.0 |
| S5-100 | | | | | | |
| NEOPRIM | 50 | PI | Mitsubishi Gas | 303 | 94.1 | 95.4 |
| L-3450 | | | Chemical | | | |
| PURE-ACE | 100 | PC | Teijin | 155 | 99.4 | 99.0 |
| C110 | | | | | | |
| OKP-F2 | 100 | PE | Osaka Gas | 142 | 95.3 | 98.6 |
| | | | Chemical | | | |
| OKP-F5 | 100 | PE | Osaka Gas | 150 | 72.0 | 97.6 |
| | | | Chemical | | | |
| Teonex | 100 | PEN | Teijin | 151 | 61.2 | 90.6 |
| Q65HA | | | | | | |
| ZeonorFilm | 100 | COP | Nippon Zeon | 163 | 100 | 100 |
| ZF-16 | | | | | | |

It is seen from Table 12 that the polyimide resin L-3G30 and the polycarbonate resins M5-80 and S5-100 are applicable as the resin (P) in the resin substrate of the present filter.

### [Formation and Evaluation of Resin Layers Containing NIR Dye (A)]

Resin layers were formed using the following NIR dyes (A) and resins and examined for optical properties to evaluate the applicability of each resin layer, constituted of a combination of an NIR dye (A) and a resin, to the present filter.

### (NIR Dyes (A))

Dye (ASi-22) and dye (ASiii-5) as squarylium dyes and dye (AD-1) as a diketopyrrolopyrrole dye were synthesized in common manners and used.

### (Resins)

The following commercial products were prepared as resins for forming the resin layers containing an NIR dye (A).
ARTON (registered trademark) F4520 (produced by JSR Co., Ltd., trade name, hereinafter referred to as “F4520”); a cycloolefin resin; Tg: 162° C.
OKP-850 (produced by Osaka Gas Chemicals Co., Ltd., trade name); a polyethylene terephthalate resin; Tg: 150° C.
NEOPRIM (registered trademark)C-3G30 (produced by Mitsubishi Gas Chemical Company, Inc., trade name, hereinafter referred to as “C-3G30”); a varnish containing a polyimide resin; Tg of the contained polyimide resin: 320° C.
FPC-0220 (produced by Mitsubishi Gas Chemical Company, Inc., trade name); a polycarbonate resin; Tg: 186° C.
SP3810 (produced by Teijin Ltd., trade name); a polycarbonate resin; Tg: 150° C.
PLEXIMID8817 (produced by Daicel-Evonik Ltd., trade name); an acrylimide resin; softening point: 170° C.
BR50 (produced by Mitsubishi Rayon Co., Ltd., trade name); an acrylic resin; Tg: 105° C.

The same abbreviations as shown above were used for indicating the kinds of resins. Furthermore, “AI” was used for acrylimide resin and “AP” was used for acrylic resin.

### (1-1) Optical Properties in Dichloromethane

Each NIR dye (A) was dissolved in dichloromethane (in the Table, denoted by “DCM”), and a spectral transmittance curve over a wavelength range of 400 to 1,200 nm was measured. A maximum absorption wavelength λ_{max(A)DCM} in the wavelength range of 400 to 1,200 nm was determined, and an average transmittance T_{AVE435-480(A)DCM} for light having wavelengths of 435 to 480 nm and an average transmittance T_{AVE490-560(A)DCM} for light having wavelengths of 490 to 560 nm were determined, these average transmittances having been determined by examining a solution obtained by incorporating the dye so as to result in a transmittance of 10% at the maximum absorption wavelength. The results are shown in Tables 13, 14, and 15 with respect to dye (ASi-22), dye (ASiii-5), and dye (AD-1), respectively.

### (1-2) Optical Properties in Resins

An NIR dye (A) was dissolved in cyclohexanone and each of the resins shown in Tables 13 to 15 to obtain a coating solution. The content of the NIR dye (A) was adjusted to 7.5 parts by mass per 100 parts by mass of the resin. The obtained coating solution was applied onto a glass plate (D263, manufactured by SCHOTT; all the glass plates used hereinafter were D263, manufactured by SCHOTT) and dried to obtain a resin layer containing the NIR dye (A) and having a thickness of 1.0 μm. This glass plate coated with the resin layer containing the NIR dye (A) was examined for spectral transmittance curve and spectral reflectance curve over a wavelength range of 400 to 1,200 nm for light entering at an incident angle of 5°. Similarly, the glass plate itself was examined for spectral transmittance curve and spectral reflectance curve. From these curves, a spectral internal transmittance curve of the resin layer containing the NIR dye (A) was obtained.

From the obtained spectral internal transmittance curve, a maximum absorption wavelength λ_{max(A)TR} and the following transmittances in the case where the internal transmittance of light at the maximum absorption wavelength λ_{max(A)TR} was 10% were determined: an average internal transmittance T_{AVE435-480(A)TR} for light having wavelengths of 435 to 480 nm, an average internal transmittance T_{AVE490-560(A)TR} for light having wavelengths of 490 to 560 nm, an internal transmittance T_{435(A)TR} for light having a wavelength of 435 nm, an internal transmittance T_{550(A)TR} for light having a wavelength of 550 nm, and an internal transmittance T_{700(A)TR} for light having a wavelength of 700 nm. The results are shown in Tables 13 to 15.

In Tables 13 to 15, the column indicating items of optical properties show abbreviations of the optical properties from which the final “DCM” and “TR” have been omitted, since the items were common between DCM and the resin.

Furthermore, |T_{AVE435-480(A)DCM}−T_{AVE435-480(A)TR} and T_{AVE490-560(A)DCM}−T_{AVE490-560(A)TR} were calculated from the results of (1-1) and (1-2) above and shown in Tables 13 to 15.

TABLE 13

| | | | | | PLEXIMI | | |
|---|---|---|---|---|---|---|---|
| Dye (ASi-22) + DCM or resin | DCM | F4520 | 0KP-850 | SP3810 | D8817 | FPC-0220 | BR50 |
| Kind of resin | — | COP | PET | PC | AI | PC | AP |
| λ_{max(A)} [nm] | 934 | 950 | 959 | 953 | 945 | 951 | 954 |
| T_{435(A)} [%] | 95.0 | 93.9 | 77.0 | 72.1 | 63.4 | 85.4 | 84.8 |
| T_{700(A)} [%] | 95.2 | 93.9 | 78.6 | 67.3 | 67.6 | 85.1 | 83.4 |
| T_{500(A)} [%] | 90.3 | 89.4 | 72.0 | 65.4 | 58.2 | 79.9 | 78.9 |
| T_{AVE490-560(A)} [%] | 94.1 | 92.4 | 74.6 | 68.4 | 60.7 | 82.8 | 81.6 |
| T_{AVE435-480(A)} [%] | 92.0 | 91.3 | 74.1 | 68.4 | 60.6 | 82.1 | 81.3 |
| \|T_{AVE490-560(A)DCM}-T_{AVE490-560(A)TR}\| | — | 1.7 | 19.5 | 25.7 | 33.4 | 11.3 | 12.5 |
| \|T_{AVE435-480(A)DCM}-T_{AVE435-480(A)TR}\| | — | 0.7 | 17.9 | 23.6 | 31.4 | 9.9 | 10.7 |

TABLE 14

| | | | | PLEXIMI | | |
|---|---|---|---|---|---|---|
| Dye (ASiii-5) + DCM or resin | DCM | F4520 | C-3G30 | D8817 | FPC-0220 | BR50 |
| Kind of resin | — | COP | PI | AI | PC | AP |
| λ_{max(A)} [nm] | 928 | 898 | 929 | 932 | 908 | 911 |
| T_{435(A)} [%] | 98.9 | 96.9 | 93.7 | 94.0 | 92.4 | 93.3 |
| T_{700(A)} [%] | 98.0 | 95.3 | 93.2 | 91.1 | 92.4 | 90.7 |
| T_{500(A)} [%] | 95.5 | 91.8 | 88.5 | 88.3 | 87.0 | 87.9 |
| T_{AVE490-560(A)} [%] | 96.4 | 93.2 | 89.6 | 89.6 | 88.5 | 88.6 |
| T_{AVE435-480(A)} [%] | 98.4 | 95.9 | 92.7 | 93.1 | 91.4 | 92.1 |
| \|T_{AVE490-560(A)DCM}-T_{AVE490-560(A)TR}\| | — | 3.3 | 6.8 | 6.8 | 7.9 | 7.8 |
| \|T_{AVE435-480(A)DCM}-T_{AVE435-480(A)TR}\| | — | 2.6 | 5.7 | 5.3 | 7.0 | 6.3 |

TABLE 15

| Dye (AD-1) + | | | | | PLEXIMI |
|---|---|---|---|---|---|
| DCM or resin | DCM | F4520 | OKP-850 | SP3810 | D8817 |
| Kind of resin | — | COP | PET | PC | AI |
| λ_{max(A)} [nm] | 883 | 892 | 895 | 897 | 893 |
| T_{435(A)} [%] | 89.8 | 93.0 | 87.7 | 85.2 | 77.6 |
| T_{700(A)} [%] | 91.9 | 94.0 | 94.2 | 88.0 | 89.1 |
| T_{500(A)} [%] | 92.6 | 94.5 | 93.1 | 91.0 | 87.4 |
| T_{AVE490-560(A)} [%] | 92.0 | 94.7 | 93.6 | 91.2 | 88.2 |
| T_{AVE435-480(A)} [%] | 91.6 | 94.4 | 91.2 | 88.5 | 83.7 |
| \|T_{AVE490-560(A)DCM} − | — | 2.7 | 1.6 | 0.8 | 3.8 |
| T_{AVE490-560(A)TR}\| | | | | | |
| \|T_{AVE435-480(A)DCM} − | — | 2.7 | 0.5 | 3.1 | 7.9 |
| T_{AVE435-480(A)TR}\| | | | | | |

It can be seen from Tables 13 to 15 that the NIR dyes (A) were dyes absorbing little visible light and that the resin layers including the cycloolefin resin and the dyes contained therein maintained the properties to have high visible-light transmittances. It can also be seen that in the case of using the polyethylene terephthalate resin, polyimide resin, polycarbonate resin, acrylimide resin, and acrylic resin, the resin layers containing the NIR dyes (A) did not have high visible-light transmittances as compared with the case where the cycloolefin resin was used.

### (1-3) Light Resistance of Resin Layers Containing NIR Dye (A)

Dye (ASiii-5) was used as an NIR dye (A) and F4520 and C-3G30 were used as resins to produce two coating solutions in the same manner as in (1-2) above.

The obtained coating solutions were each applied to a main surface of a glass plate coated with a dielectric multilayer film (UVIR reflection layer reflecting infrared light and ultraviolet light; the same UVIR reflection layer 1 as that used in Example 1, which will be described later), the main surface being not the one having the UVIR reflection layer thereon. The applied coating solution was dried to form a resin layer containing the NIR dye (A) and having a thickness of 1.0 μm. A dielectric multilayer film (a 3.25 μm-thick antireflection layer composed of layers of SiO₂ and TiO₂ alternately stacked on the side facing the resin layer containing the NIR dye (A)) was deposited on the resin layer containing the NIR dye (A). Thus, optical samples for a light resistance test were obtained.

The obtained optical samples were subjected to a light resistance test using Super Xenon Weather Meter, manufactured by Suga Test Instruments Co., Ltd. Specifically, in the light resistance test, each optical sample was introduced into the Super Xenon Weather Meter and irradiated with light having wavelengths in a wavelength band of 300 to 2,450 nm so as to result in an integrated quantity of light of 80,000 J/mm². The residual rate of the dye was calculated using the following formula from absorbances (ABS) before and after the light resistance test at a maximum absorption wavelength λ_{max(A)TR} before the test.

Residual rate of dye=(absorbance after test)/(absorbance before test)

TABLE 16

| | | | | Absorbance | | Residual |
|---|---|---|---|---|---|---|
| | Kind | NIR dye | λ_{max(A)TR} | Before | After | rate |
| Resin | of resin | (A) | [nm] | test | test | of dye |
| F4520 | COP | Dye | 898 | 1.16 | 0.96 | 0.83 |
| C-3G30 | PI | (ASiii-5) | 928 | 1.05 | 0.80 | 0.76 |

### [Formation and Evaluation of External Resin Layers]

Resin layers were formed using dye (I-12-15) as an NIR dye (B) and using an alicyclic epoxy resin, C-3G30, SP3810, and F4520 as resins, and were examined for adhesion to a dielectric multilayer film and optical properties. Thus, the applicability of each resin layer, constituted of a combination of the NIR dye (B) and a resin, to the external resin layer of the present filter was evaluated.

### (2-1) Production of Samples for Adhesiveness Evaluation, and Adhesiveness Evaluation

Samples for adhesiveness evaluation which each include a glass plate and include a resin layer containing the NIR dye (B) and a dielectric multilayer film disposed in this order on the glass plate were produced and evaluated for adhesiveness.

A resin layer including an alicyclic epoxy resin was formed by the method described in JP 2017-149896 A. First, EHPE3150 (trade name; produced by Daicel Ltd.) was diluted with a toluene solvent to produce a monomer solution having a solid concentration of 28.5 mass %. Dye (I-12-15) was added to the monomer solution in an amount of 7.5 mass % with respect to the resin component (EHPE3150). To the dye-containing mixture, 3-mercaptopropyltrimethoxysilane as an additive and tris(pentafluorophenyl)borane as a curing catalyst were added in amounts of 10 mass % and 2.5 mass %, respectively, with respect to the resin component, thereby obtaining a coating solution. The obtained coating solution was used to form, on a glass plate, a resin layer containing the NIR dye (B) and having a thickness of 1.0 μm. The coating solution was cured under the conditions of 160° C. and 1 hour.

With respect to each of C-3G30, SP3810, and F4520, a 1.0 μm-thick resin layer containing the NIR dye (B) was formed on a glass plate in the same manner as in (1-2) above, except that the NIR dye (A) was replaced by the NIR dye (B).

A dielectric multilayer film (a 3.25 μm-thick antireflection layer composed of layers of SiO₂ and TiO₂ alternately stacked on the side facing the resin layer containing the NIR dye (B)) was deposited on the resin layer containing the NIR dye (B). Thus, samples for adhesiveness evaluation were obtained. A cellophane tape was attached to the antireflection layer of each sample, and the adhesiveness was evaluated by the cross-cut method (JIS K5600). When the number of detached squares, out of 100 squares of a cross-cut pattern, was 5 or less, the rating was “A”, and when it was 6 or more, the rating was “C”.

In the case where the alicyclic epoxy resin and C-3G30 (polyimide resin) were used, rating “A” was obtained. In the case where SP3810 (polycarbonate resin) or F4520 (cycloolefin resin) was used, the rating was “C”.

### (2-2) Production and Evaluation of Samples for Optical-Property Evaluation

Using an alicyclic epoxy resin and C-3G30 (polyimide resin), resin layers containing an NIR dye (B) were formed on glass plates in the same manner as in (2-1) above, thereby obtaining samples for optical-property evaluation. Using each sample, a spectral internal transmittance curve of the resin layer containing an NIR dye (B) was obtained in the same manner as in (1-2) above. Furthermore, the spectral internal transmittance curve was normalized so that a wavelength λ_{SH20%} was 665 nm, the λ_{SH20%} being a wavelength which was shorter than a maximum absorption wavelength λ_{max(B)TR} of the NIR dye (B) and at which the internal transmittance was 20%.

From the obtained spectral internal transmittance curve, a maximum absorption wavelength λ_{max(B)TR} and the following properties in the case where the internal transmittance of light at the maximum absorption wavelength λ_{max(A)TR} was 10% were determined: an average internal transmittance T_{AVE435-480(B)TR} for light having wavelengths of 435 to 480 nm, an average internal transmittance T_{AVE490-560(B)TR} for light having wavelengths of 490 to 560 nm, wavelengths λ_{SH20%} and λ_{SH70%} at which the internal transmittance was 20% and 70%, respectively, and which were shorter than the λ_{max(B)TR}, and λ_{SH20%}−λ_{SH70%}. The results are shown in Table 17.

TABLE 17

| | Cured object from composition | |
|---|---|---|
| Dye (1-12-15) + resin | including EHPE3150 | C-3G30 |
| Kind of resin | alicyclic epoxy resin | PI |
| λ_{max(B)TR} [nm] | 702 | 707 |
| T_{AVE435-480(B)TR} [%] | 93.3 | 91.6 |
| T_{AVE490-560(B)TR} [%] | 97.0 | 97.0 |
| λ_{SH20%} [nm] | 665.0 | 665.0 |
| λ_{SH70%} [nm] | 616.0 | 616.0 |
| λ_{SH20%} − λ_{SH70%} [nm] | 49.0 | 49.0 |

It can be seen from the results that by using an external resin layer including the alicyclic epoxy resin or the polyimide resin, an optical filter in which a dielectric multilayer film has excellent adhesiveness can be produced. Furthermore, it can be seen that in the case where the alicyclic epoxy resin or polyimide resin which contains an NIR dye (B) is used in forming an external resin layer, it is possible to obtain a resin layer containing the NIR dye (B) which retains high values of T_{AVE435-480(B)TR} and T_{AVE490-560(B)TR}, has λ_{SH20%} in a desired wavelength band (650 to 700 nm), and has excellent steepness with λ_{SH20%}−λ_{SH70%} of 55 nm or less.

### [Evaluation of Optical Properties of Resin Members]

Resin members of the following Configuration Examples 1 to 10, which were each the optical filter 10B illustrated in FIG. 2 having neither the first dielectric multilayer film 3a nor the second dielectric multilayer film 3b, were evaluated for optical properties.

As the resin substrate 1 was used M5-80, which is a polycarbonate resin film. As the first external resin layer 2a and the second external resin layer 2b, use was made of the following resin layer (1A) or (1B).

(1A) A resin layer including dye (I-12-15) as an NIR dye (B) and an alicyclic epoxy resin as a resin, the resin layer having been formed in the same manner as in (2-1) above.

(1B) A resin layer including dye (I-12-15) as an NIR dye (B) and C-3G30 (polyimide resin) as a resin, the resin layer having been formed in the same manner as in (2-1) above.

In each of the two configurations, any of the following resin layers (2A) to (2E) was used as the first intermediate resin layer 4a and second intermediate resin layer 4b. The thus-produced resin members of Configuration Examples 1 to 10, which are shown in Table 18, were examined for optical properties. The results are shown in Table 18.

Specifically, the evaluated optical properties were as follows: a wavelength (λ_{T20%}) at which the internal transmittance was 20%; a wavelength (λ_{T50%}) at which the internal transmittance was 50% in a wavelength range of 800 to 1,200 nm; [absorbance at a wavelength of 450 nm]/[maximum absorbance in a wavelength range of 800 to 1,200 nm] (ABS₄₅₀/ABSₘₐₓ₈₀₀₋₁₂₀₀); [absorbance at a wavelength of 500 nm]/[maximum absorbance in a wavelength range of 800 to 1,200 nm] (ABS₅₀₀/ABSₘₐₓ₈₀₀₋₁₂₀₀), and [absorbance at a wavelength of 700 nm]/[maximum absorbance in a wavelength range of 800 to 1,200 nm] (ABS₇₀₀/ABSₘₐₓ₈₀₀₋₁₂₀₀). In determining these optical properties, normalization was conducted so that the wavelength λ_{T20%}, at which the internal transmittance was 20%, was 664 nm.

(2A) A resin layer formed using dye (ASi-22) as an NIR dye (A) and using F4520 (cycloolefin resin) as a resin, in the same manner as in (1-2) above.

(2B) A resin layer formed using dye (ASiii-5) as an NIR dye (A) and using F4520 as a resin, in the same manner as in (1-2) above.

(2C) A resin layer formed using dye (AD-1) as an NIR dye (A) and using F4520 as a resin, in the same manner as in (1-2) above.

(2D) A resin layer formed using dye (ASi-22) as an NIR dye (A) and using OKP-850 (polyethylene terephthalate resin) as a resin, in the same manner as in (1-2) above.

(2E) A resin layer formed using dye (AD-1) as an NIR dye (A) and using SP3810 (polycarbonate resin) as a resin, in the same manner as in (1-2) above.

TABLE 18

| | | Confi- | Confi- | Confi- | Confi- | Confi- | Confi- | Confi- | Confi- | Confi- | Confi- |
|---|---|---|---|---|---|---|---|---|---|---|---|
| | | guration | guration | guration | guration | guration | guration | guration | guration | guration | guration |
| | | Example | Example | Example | Example | Example | Example | Example | Example | Example | Example |
| | | 1 | 2 | 3 | 4 | 5 | 6 | 7 | 8 | 9 | 10 |
| Confi- | Resin substrate 1 | M5-80 | | | | | | | | | |
| gura- | External resin layers | (1A) | | | | | (1B) | | | | |
| tion | 2a, 2b | | | | | | | | | | |
| | Intermediate resin | (2A) | (2B) | (2C) | (2D) | (2E) | (2A) | (2B) | (2C) | (2D) | (2E) |
| | layers 4a, 4b | | | | | | | | | | |
| Pro- | λ_{T20%} [nm] | 664 | 664 | 664 | 664 | 664 | 664 | 664 | 664 | 664 | 664 |
| per- | λ_{T50%} [nm] | 822 | 833 | 851 | 786 | 800 | 821 | 834 | 851 | 786 | 800 |
| ties | ABS₄₅₀/ABSₘₐₓ₈₀₀₋₁₂₀₀ | 0.074 | 0.055 | 0.064 | 0.166 | 0.096 | 0.067 | 0.048 | 0.057 | 0.159 | 0.089 |
| | ABS₅₀₀/ABSₘₐₓ₈₀₀₋₁₂₀₀ | 0.061 | 0.050 | 0.037 | 0.155 | 0.054 | 0.057 | 0.046 | 0.033 | 0.151 | 0.050 |
| | ABS₇₀₀/ABSₘₐₓ₈₀₀₋₁₂₀₀ | 1.958 | 1.950 | 1.956 | 2.036 | 1.985 | 1.698 | 1.691 | 1.697 | 1.776 | 1.726 |

Among the configurations shown above, Configuration Examples 1 to 3 and 6 to 8, in each of which the resin substrate, the external resin layers, and the intermediate resin layers have the configurations according to the present filter, have optical properties within preferred ranges. Meanwhile, in Configuration Examples 4, 5, 9, and 10, in which the intermediate resin layers are (2D) and (2E), which include resins outside the ranges of the configurations of the present filter, ABS₄₅₀/ABSₘₐₓ₈₀₀₋₁₂₀₀ and/or ABS₅₀₀/ABSₘₐₓ₈₀₀₋₁₂₀₀ is not within a preferred range.

### [Production and Evaluation of Optical Filter]

### Example 1

An optical filter having the same configuration as the optical filter 10B illustrated in FIG. 2 was produced and evaluated in the following manners.

As the resin substrate 1 was used M5-80, which is a polycarbonate resin film. As the first external resin layer 2a and the second external resin layer 2b, the resin layer (1B) shown above was used. As the first intermediate resin layer 4a and the second intermediate resin layer 4b, the resin layer (2B) shown above was used.

TiO₂ films and SiO2 films were alternately stacked as a first dielectric multilayer film 3a by vapor deposition on the first external resin layer 2a on the resin substrate 1, thereby depositing an antireflection layer having a thickness of 3.25 μm (hereinafter referred to as “AR layer 1”).

TiO₂ films and SiO₂ films were alternately stacked as a second dielectric multilayer film 3b by vapor deposition on the second external resin layer 2b on the resin substrate 1, thereby forming an NIR reflection layer which was constituted of a 6.7 μm-thick dielectric multilayer film and in which the relationship between incident angle and transmittances in respective wavelength ranges was as shown in Table 19. This NIR reflection layer is a reflection layer having the property of shielding light not only in the near-infrared region but also in the near-ultraviolet region; this reflection layer is hereinafter referred to as “UVIR reflection layer 1”. In Table 19, R₄₂₀₋₆₅₀ indicates a maximum reflectance [%] for light having wavelengths in a wavelength range of 420 to 650 nm and having each of the incident angles shown in Table 19. λ_{REIRSHT20} indicates a shorter wavelength-side wavelength on the near-infrared region side at which the transmittance of the reflection layer for light having each of the incident angles shown in Table 19 is 20%. λ_{REUVLO20} indicates a longer-wavelength-side wavelength in a 350-500 nm range at which the transmittance of the reflection layer for light having each of the incident angles shown in Table 19 is 20%.

TABLE 19

| Evaluation item/Incident angle (deg) | 0 | 30 |
|---|---|---|
| R₄₂₀₋₆₅₀ (%) | 0.7 | 2.5 |
| λ_{REIRSHT20} (nm) | 716 | 688 |
| λ_{RESUVLO20} (nm) | 405 | 394 |

### (Evaluation)

### (1) Optical Properties

FIG. 3 shows spectral transmittance curves of the obtained optical filter for light having wavelengths of 400 to 1,200 nm and having incident angles of 0° and 30°. From the obtained spectral transmittance curves, the following optical properties were evaluated. The results are shown in Table 20.

(a) An average transmittance T_{AVE435-480} for light having wavelengths in a wavelength range of 435 to 480 nm and entering at an incident angle of 0°.

(b) An average transmittance T_{AVE490-560} for light having wavelengths in a wavelength range of 490 to 560 nm and entering at an incident angle of 0°.

(c) A wavelength λ_{20%} at which the transmittance for light entering at an incident angle of 0° is 20% in a wavelength range of 600 to 700 nm.

(d) The difference between the wavelength λ_{0°-20%} at which the transmittance for light having wavelengths in the 600 to 700 nm range and having an incident angle of 0° is 20% and the wavelength λ_{30°-20%} at which the transmittance for light having wavelengths in the 600 to 700 nm range and having an incident angle of 30° is 20%.

(e) A minimum value of OD in a wavelength range of [maximum absorption wavelength λ_{max(A)TR} of the NIR dye (A)]±10 nm at incident angles of 0° and 30°.

TABLE 20

| | Example 1 | |
|---|---|---|
| λ_{max(A)TR} [nm] | 898 | |
| | 0 deg | 30 deg |
| T_{AVE435-480} [%] | 83.7 | 83.6 |
| T_{AVE490-560} [%] | 85.2 | 84.5 |
| λ_{20%} [nm] | 675 | 674 |
| λ_{0°-20%} − λ_{30°-20%} [nm] | 1 | |
| Minimum OD in 898 nm ± 10 nm | 5.45 | 4.57 |

An optical filter having the same configuration as the optical filter of Example 1 except that the external resin layers 2a and 2b and the intermediate resin layers 4a and 4b had been omitted was examined to determine OD values in a wavelength range of 888 to 908 nm at incident angles of 0° and 30°. The minimum OD values in the wavelength range were 4.52 at an incident angle of 0° and 3.64 at an incident angle of 30°.

As can be seen from Table 20, the optical filter of Example 1, due to the inclusion of the NIR dye (A), had increased values of OD in the range of [maximum absorption wavelength of the dye]±10 nm and was able to retain high visible-light transmittances.

### (2) Heat Resistance (Warping) and Adhesiveness

Samples having Configurations A to C shown in Table 21 were produced as samples to be evaluated for heat resistance (warping) and adhesiveness. Each sample had a size of 76 cm×76 cm.

Configuration A had the configuration of the optical filter of Example 1 in which the external resin layers 2a and 2b did not contain the NIR dye (B) and the intermediate resin layers 4a and 4b did not contain the NIR dye (A) and the thickness of each resin layer had been regulated to the value shown in Table 21.

Configuration B and Configuration C employed ZF-16, which is a cycloolefin resin film, as the resin substrate 1. Configuration B was a configuration in which 1.0 μm-thick resin layers containing no dye had been formed using F4520, as the only resin layers, on both main surfaces of the resin substrate 1. Configuration C was a configuration in which 1.0 μm-thick resin layers containing no dye had been formed using C-3G30, as the only resin layers, on both main surfaces of the resin substrate 1. Configuration B and Configuration C each had, as outermost layers, the same AR layer 1 and UVIR layer 1 as in the optical filter of Example 1.

Table 21 shows the proportion [%] of the total thickness of members each including a resin having a Tg of 200° C. or higher to the thickness of the whole resin members in each configuration. It can be seen that Configuration A only satisfies the requirement for the present filter.

### (Evaluation of Adhesiveness)

The adhesiveness of the AR layer 1 was evaluated by the cross-cut method (JIS K5600) in the same manner as that shown above under (2-1) in Formation and Evaluation of External Resin Layers. When the number of detached squares, out of 100 squares of a cross-cut pattern, was 5 or less, the rating was “A”, and when it was 6 or more, the rating was “C”. The results are shown in Table 21.

### (Evaluation of Warping)

The samples of Configurations A to C were allowed to stand in a 150° C. thermostatic chamber for 3 minutes and then examined for the amount of warping. Each sample was placed on a horizontal plane so that the center of the sample was in contact with the horizontal plane, and the distances between each of edge portions of the sample and the horizontal plane were measured and defined as amounts of warping. A maximum value of the amounts of warping of the whole periphery of the sample was used for evaluation. When the maximum amount of warping was 10 mm or less, the rating was “A”, and when it exceeded 10 mm, the rating was “C”. The results are shown in Table 21.

TABLE 21

| | | | | Configuration | Configuration | Configuration |
|---|---|---|---|---|---|---|
| | | | | A | B | C |
| Configuration | | Resin | Tg [° C.] | Thickness | Thickness | Thickness |
| | | | | [μm] | [μm] | [μm] |
| | First dielectric | AR layer 1 | | 3.25 | 3.25 | 3.25 |
| | multilayer film 3a | | | | | |
| | First external | C-3G30G | 320 | 1.0 | — | 1.0 |
| | resin layer 2a | | | | | |
| | First intermediate | F4520 | 147 | 0.5 | 1.0 | — |
| | resin layer 4a | | | | | |
| | Resin substrate 1 | M5-80 | 220 | 80.0 | — | — |
| | | ZF-16 | 163 | — | 100.0 | 100.0 |
| | Second intermediate | F4520 | 147 | 0.5 | 1.0 | — |
| | resin layer 4b | | | | | |
| | Second external | C-3G30G | 320 | 1.0 | — | 1.0 |
| | resin layer 2b | | | | | |

| | | | | |
|---|---|---|---|---|
| Second dieletric | UVIR layer 1 | 6.7 | 6.7 | 6.7 |
| multilayer film 3b | | | | |

| | | | | |
|---|---|---|---|---|
| Properties | Thickness of the whole resin members [μm] | 83.0 | 102.0 | 102.0 |
| | Total thickness of resinous members with | 82.0 | 0.0 | 2.0 |
| | Tg of 200° C. or higher [μm] | | | |
| | Thickness proportion of resinous members | 98.8 | 0.0 | 2.0 |
| | with Tg of 200° C. or higher [%] | | | |
| | Evaluation of adhesiveness | A | C | A |
| | Evaluation of warping | A | C | C |

It can be seen from Table 21 that in the case where the proportion [%] of the total thickness of members each including a resin having a Tg of 200° C. or higher to the thickness of the whole resin members is too low, a thermal deformation (warping) is prone to occur and such configuration gives an optical filter which is prone to warp. Furthermore, in the case where the resin layer in contact with a dielectric multilayer film is one constituted of a resin which is neither a polyimide resin nor an alicyclic epoxy resin, there is a possibility that the dielectric multilayer film might peel off.

While the invention has been described in detail and with reference to specific embodiments thereof, it will be apparent to one skilled in the art that various changes and modifications can be made therein without departing from the spirit and scope thereof. This application is based on Japanese Patent Application No. 2019-071316 filed on Apr. 3, 2019, the contents thereof being incorporated herein by reference.

### INDUSTRIAL APPLICABILITY

The optical filter of the present invention is a near-infrared cut filter which employs a combination of a resin layer constituted of a resinous material containing a near-infrared absorbing dye, a resin substrate, and dielectric multilayer films and which has high transparency to visible light and the property of highly shielding near-infrared light, in particular, near-infrared light having longer wavelengths, and has excellent adhesion between a resin layer and each dielectric multilayer film and excellent heat resistance with diminished thermal deformation. This optical filter is hence useful in applications such as, for example, imaging devices, e.g., digital still cameras, in which performance elevation and miniaturization are proceeding nowadays.

### REFERENCE SIGNS LIST

10A, 10B: Optical filter, 1: resin substrate, 2, 2a, 2b: external resin layer, 3a, 3b: dielectric multilayer film, and 4, 4a, 4b: intermediate resin layer.

1. An optical filter, comprising:
a resin substrate comprising a resin (P) which has a glass transition temperature of 200° C. or higher and which, when having a thickness of 100 μm, has an average internal transmittance in a 350-450 nm wavelength range of 95% or higher and a minimum internal transmittance in a 400-450 nm wavelength range of 97% or higher in a spectral transmittance curve over a wavelength range of 350 nm to 1,100 nm;
an external resin layer that is disposed on at least one of main surfaces of the resin substrate and that comprises at least one of a polyimide resin and an alicyclic epoxy resin; and
dielectric multilayer films disposed as outermost layers on both main surfaces of the resin substrate,
wherein:
in a case where the external resin layer comprises the polyimide resin, the optical filter comprises an intermediate resin layer comprising a cycloolefin resin, the intermediate resin layer being disposed between the resin substrate and the external resin layer;
at least one of the dielectric multilayer films is a near-infrared reflection layer;
at least one of the external resin layer and the intermediate resin layer contains a near-infrared absorbing dye (A);
the near-infrared absorbing dye (A), when examined in a resin included in the resin layer containing the near-infrared absorbing dye (A), has a maximum absorption wavelength λ_{max(A)TR} within a wavelength range of 800 nm to 1,200 nm in a spectral transmittance curve over a wavelength range of 400 nm to 1,200 nm; and
the optical filter has a proportion of a total thickness of members including a resin having a glass transition temperature of 200° C. or higher to a total thickness of the resin-including members of 85% or higher.

2. The optical filter according to claim 1, wherein the external resin layer is disposed on each of both main surfaces of the resin substrate.

3. The optical filter according to claim 1, wherein the resin (P) comprises at least one resin selected from the group consisting of polyimide resins and polycarbonate resins, and the proportion of the total thickness of members including a resin having a glass transition temperature of 200° C. or higher to the total thickness of the resin-including members is 90% or higher.

4. The optical filter according to claim 1, wherein when T_{AVE435-480(A)TR} and T_{AVE490-560(A)TR} are respectively defined as an average internal transmittance for light having wavelengths of 435 nm to 480 nm and an average internal transmittance for light having wavelengths of 490 nm to 560 nm in a spectral transmittance curve over a wavelength range of 400 nm to 1,200 nm obtained by examining the near-infrared absorbing dye (A) in a resin included in the resin layer containing the near-infrared absorbing dye (A) while regulating an internal light transmittance to be 10% at the maximum absorption wavelength λ_{max(A)TR}, and T_{AVE435-480(A)DCM} and T_{AVE490-560(A)DCM} are respectively defined as an average internal transmittance for light having wavelengths of 435 nm to 480 nm and an average internal transmittance for light having wavelengths of 490 nm to 560 nm in a spectral transmittance curve over a wavelength range of 400 nm to 1,200 nm obtained by examining the near-infrared absorbing dye (A) dissolved in dichloromethane while regulating a light transmittance to be 10% at a maximum absorption wavelength λ_{max(A)DCM}, the near-infrared absorbing dye (A) satisfies the following relationships:

|T_{AVE435-480(A)DCM}−T_{AVE435-480(A)TR}| being 5% or less; and

|T_{AVE490-560(A)DCM}−T_{AVE490-560(A)TR}| being 5% or less.

5. The optical filter according to claim 1, wherein when T_{AVE435-480(A)TR}, T_{AVE490-560(A)TR}, T_{435(A)TR}, T_{550(A)TR}, and T_{700(A)TR} are respectively defined as an average internal transmittance for light having wavelengths of 435 nm to 480 nm, an average internal transmittance for light having wavelengths of 490 nm to 560 nm, an internal transmittance for light having a wavelength of 435 nm, an internal transmittance for light having a wavelength of 550 nm and an internal transmittance for light having a wavelength of 700 nm in a spectral transmittance curve over a wavelength range of 400 nm to 1,200 nm obtained by examining the near-infrared absorbing dye (A) in a resin included in the resin layer containing the near-infrared absorbing dye (A) while regulating an internal light transmittance to be 10% at the maximum absorption wavelength λ_{max(A)TR}, the near-infrared absorbing dye (A) satisfies the following relationships:
T_{AVE435-480(A)TR} being 88% or higher,
T_{AVE490-560(A)TR} being 88% or higher,
T_{435(A)TR} being 88.1% or higher,
T_{550(A)TR} being 79.4% or higher, and
T_{700(A)TR} being 79.4% or higher.

6. The optical filter according to claim 1, wherein the near-infrared absorbing dye (A) comprises at least one dye selected from the group consisting of squarylium dyes and diketopyrrolopyrrole dyes.

7. The optical filter according to claim 1, wherein the near-infrared absorbing dye (A) comprises at least one compound selected from the group consisting of compounds represented by the following formula (ASi), compounds represented by the following formula (ASii), compounds represented by the following formula (ASiii), and compounds represented by the following formula (AD): 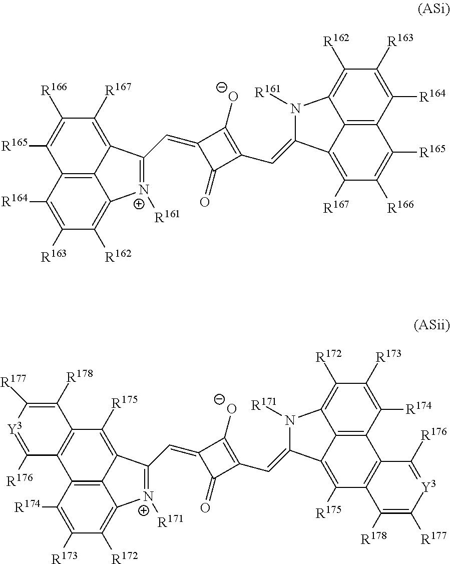
wherein symbols are as follows:
R¹⁶¹ moieties are each independently a C₃-C₂₀ branched alkyl group or a C₁₃-C₂₀ linear alkyl group;
Y³ moieties are each independently C—R¹⁷⁹ or N;
R¹⁶² to R¹⁶⁷ moieties and R¹⁷¹ to R¹⁷⁹ moieties are each independently a hydrogen atom, a halogen atom, a sulfo group, a hydroxy group, a cyano group, a nitro group, a carboxyl group, a phosphate group, an —NR¹¹²R¹¹³ group, an —NHSO₂R¹¹⁴ group, an —NHCOR¹¹⁵ group, an —SR¹¹⁶ group, an —SO₂R¹¹⁷ group, an —OSO₂R¹¹⁸ group, a C₁-C₂₀ alkyl group, a C₁-C₂₀ alkoxy group, a C₁-C₁₂ halogen-substituted alkyl group, a C₃-C₁₄ cycloalkyl group, a C₆-C₁₄ aryl group, or a 3- to 14-membered heterocyclic ring group; and
R¹¹² to R¹¹⁸ are each independently a hydrogen atom, a C₁-C₂₀ alkyl group, a C₁-C₂₀ alkoxy group, a C₁-C₁₂ halogen-substituted alkyl group, a C₃-C₁₄ cycloalkyl group, a C₆-C₁₄ aryl group, or a 3- to 14-membered heterocyclic ring group; 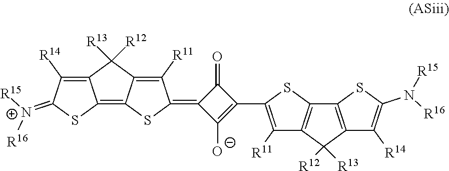
wherein R¹¹ to R¹⁴ moieties are each independently an alkyl, alkoxy, aryl, or alaryl group which may have a substituent and may contain an unsaturated bond or an oxygen atom between carbon atoms, and R¹⁵ and R¹⁶ moieties are each independently an aryl group, or an alkyl or alkoxy group which may have a substituent and may contain an unsaturated bond, an oxygen atom, an alicyclic ring, or an aromatic ring between carbon atoms, or R¹⁵ and R¹⁶ have combined with each other to form a 5- to 10-membered heterocyclic ring together with a nitrogen atom, in which the heterocyclic ring may have a substituent, 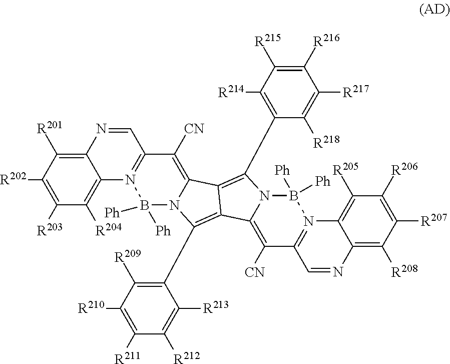
wherein R²⁰¹ to R²¹⁸ are each independently a hydrogen atom, a halogen atom, a sulfo group, a hydroxy group, a cyano group, a nitro group, a carboxyl group, a phosphate group, an —NR²¹⁹R²²⁰ group, an —NHSO₂R²²¹ group, an —NHCOR²²² group, an —SR²²³ group, an —SO₂R²²⁴ group, an —OSO₂R²²⁵ group, a C₁-C₂₀ alkyl group, a C₁-C₂₀ alkoxy group, a C₁-C₁₂ halogen-substituted alkyl group, a C₃-C₁₄ cycloalkyl group, a C₆-C₁₄ aryl group, or a 3- to 14-membered heterocyclic ring group; and
R²¹⁹ to R²²⁵ are each independently a hydrogen atom, a C₁-C₂₀ alkyl group, a C₁-C₂₀ alkoxy group, a C₁-C₁₂ halogen-substituted alkyl group, a C₃-C₁₄ cycloalkyl group, a C₆-C₁₄ aryl group, or a 3- to 14-membered heterocyclic ring group, and Ph represents a phenyl group.

8. The optical filter according to claim 1, wherein at least one of the external resin layer and the intermediate resin layer contains a near-infrared absorbing dye (B), and
the near-infrared absorbing dye (B), when examined in a resin included in the resin layer containing the near-infrared absorbing dye (B), has a maximum absorption wavelength λ_{max(B)TR} within a wavelength range of 680 nm to 760 nm in a spectral transmittance curve over a wavelength range of 400 nm to 1,200 nm.

9. The optical filter according to claim 8, wherein the external resin layer comprises a polyimide resin and the near-infrared absorbing dye (B), and the intermediate resin layer contains the near-infrared absorbing dye (A).

10. The optical filter according to claim 8, wherein when λ_{SH20%} is defined as a wavelength which is shorter than a maximum absorption wavelength and at which an internal transmittance is 20% in a spectral transmittance curve over a wavelength range of 400 nm to 1,200 nm, the resin layer containing the near-infrared absorbing dye (B) has λ_{SH20%} in a wavelength range of 650 nm to 700 nm,
the resin layer containing the near-infrared absorbing dye (B) has:
an average internal transmittance for light having wavelengths of 435 nm to 480 nm of 90% or higher;
an average internal transmittance for light having wavelengths of 490 nm to 560 nm of 90% or higher; and
a wavelength difference λ_{SH20%}−λ_{SH70%} of 55 nm or less, in which λ_{SH70%} is defined as a wavelength which is shorter than the maximum absorption wavelength and at which an internal transmittance is 70% in the spectral transmittance curve, and
the resin layer containing the near-infrared absorbing dye (B) contains at least one compound selected from the group consisting of compounds represented by the following formula (I) and compounds represented by the following formula (II): 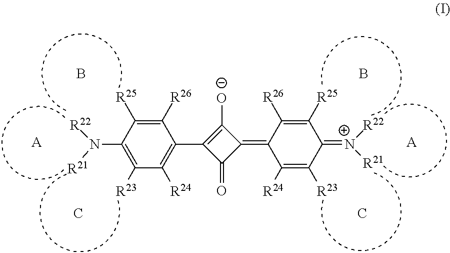
wherein symbols are as follows:
R²⁴ moieties and R²⁶ moieties are each independently a hydrogen atom, a halogen atom, a hydroxyl group, a C₁-C₂₀ alkyl group, a C₁-C₂₀ alkoxy group, a C₁-C₁₀ acyloxy group, a C₆-C₁₁ aryl group, a C₇-C₁₈ alaryl group which may have a substituent and may contain an oxygen atom between carbon atoms, —NR²⁷R²⁸ (R²⁷ and R²⁸ each independently represent a hydrogen atom, a C₁-C₂₀ alkyl group, —C(═O)—R²⁹ (R²⁹ is a hydrogen atom, a halogen atom, a hydroxyl group, or a C₁-C₂₅ hydrocarbon group which may have a substituent and may contain an unsaturated bond, an oxygen atom, or a saturated or unsaturated ring structure between carbon atoms), —NHR³⁰, or —SO₂—R³⁰ (R³⁰ moieties are each a C₁-C₂₅ hydrocarbon group which may contain an unsaturated bond, an oxygen atom, or a saturated or unsaturated ring structure between carbon atoms and in which one or more hydrogen atoms each may have been replaced with a halogen atom, a hydroxyl group, a carboxy group, a sulfo group, or a cyano group)), or a group represented by the following formula (S) (R⁴¹ and R⁴² each independently represent a hydrogen atom, a halogen atom, a C₁-C₁₀ alkyl group or a C₁-C₁₀ alkoxy group, and k is 2 or 3), 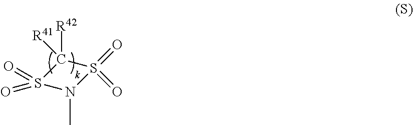
wherein R²¹ and R²², R²² and R²⁵, and R²¹ and R²³ may combine with each other to form, respectively, a heterocyclic ring A, a heterocyclic ring B, and a heterocyclic ring C together with a nitrogen atom, each ring having 5 or 6 ring members;
R²¹ and R²², when forming the heterocyclic ring A, represent a divalent group -Q- formed by the bonding of R²¹ and R²², the divalent group -Q- being an alkylene or alkyleneoxy group in which a hydrogen atom may have been replaced with a C₁-C₆ alkyl group, a C₆-C₁₀ aryl group, or a C₁-C₁₀ acyloxy group which may have a substituent; and
R²² and R²⁵, when forming the heterocyclic ring B, and R²¹ and R²³, when forming the heterocyclic ring C, are divalent groups —X¹—Y¹— and —X²—Y²— respectively each formed by the bonding thereof (X¹ and X² are bonded to the nitrogen atom), wherein each of X¹ and X² is a group represented by the following formula (1x) or (2x) and each of Y¹ and Y² is a group represented by a formula selected from the group consisting of the following formulae (1y) to (5y), and when X¹ is a group represented by the following formula (2x), Y¹ may be a single bond and, in this case, the group may have an oxygen atom between carbon atoms, and when X² is a group represented by the following formula (2x), Y² may be a single bond and, in this case, the group may have an oxygen atom between carbon atoms, 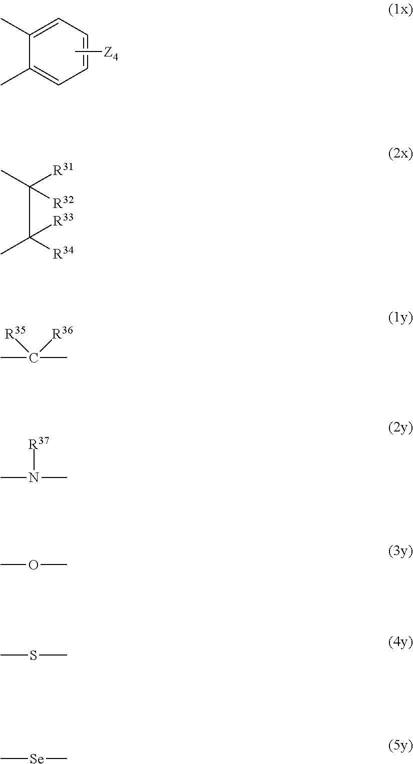
wherein four Z moieties in formula (1x) each independently represent a hydrogen atom, a hydroxyl group, a C₁-C₆ alkyl group, a C₁-C₆ alkoxy group, or —NR³⁸R³⁹ (R³⁸ and R³⁹ each independently represent a hydrogen atom or a C₁-C₂₀ alkyl group), R³¹ to R³⁶ each independently represent a hydrogen atom, C₁-C₆ alkyl group, or a C₆-C₁₀ aryl group, R³⁷ represents C₁-C₆ alkyl group or a C₆-C₁₀ aryl group;
R²⁷, R²⁸, R²⁹, R³¹ to R³⁷, R²¹ to R²³ which have not formed a heterocyclic ring, and R²⁵ each may be bonded to any of the others to form a 5-membered ring or a 6-membered ring, R³¹ and R³⁶ may be directly bonded to each other, and R³¹ and R³⁷ may be directly bonded to each other; and
R²¹, R²², R²³, and R²⁵ which have not formed a heterocyclic ring each independently represent a hydrogen atom, a halogen atom, a hydroxyl group, a C₁-C₂₀ alkyl group, a C₁-C₂₀ alkoxy group, a C₁-C₁₀ acyloxy group, a C₆-C₁₁ aryl group, or a C₇-C₁₈ alaryl group which may have a substituent and may have an oxygen atom between carbon atoms, 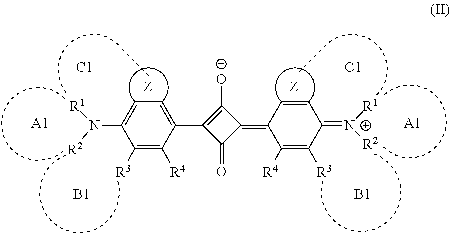
wherein symbols are as follows:
rings Z are each independently a 5- or 6-membered ring having 0 to 3 heteroatoms in the ring, and a hydrogen atom contained in each ring Z may have been replaced; and
R¹ and R², R² and R³, and R¹ and a carbon atom or heteroatom as a component of each ring Z may have combined with each other to form, respectively, a heterocyclic ring A1, a heterocyclic ring B1, and a heterocyclic ring C1 together with a nitrogen atom, and in this case, a hydrogen atom contained in the heterocyclic ring A1, heterocyclic ring B1, and heterocyclic ring C1 may have been replaced, R¹ and R² which have not formed the heterocyclic ring each independently represent a hydrogen atom, a halogen atom, or a hydrocarbon group which may contain an unsaturated bond, a heteroatom, or a saturated or unsaturated ring structure between carbon atoms and which may have a substituent, and R⁴ and R³ which has not formed the heterocyclic ring each independently represent a hydrogen atom, a halogen atom, or an alkyl or alkoxy group which may contain a heteroatom between carbon atoms and may have a substituent.

11. The optical filter according to claim 1, wherein the resin-including members as a whole have optical properties which satisfy all of the following (i-1) to (i-5):
(i-1) to have an internal light transmittance of 20% at a wavelength within a wavelength range of 630 nm to 750 nm;
(i-2) to have an internal light transmittance of 50% or less at a wavelength within a wavelength range of 800 nm to 1,200 nm;
(i-3) [absorbance at wavelength of 450 nm]/[maximum absorbance in wavelength range of 800 nm to 1,200 nm]≤0.075;
(i-4) [absorbance at wavelength of 500 nm]/[maximum absorbance in wavelength range of 800 nm to 1,200 nm]≤0.065; and
(i-5) [absorbance at wavelength of 700 nm]/[maximum absorbance in wavelength range of 800 nm to 1,200 nm]≥1.00.

12. The optical filter according to claim 1, which satisfies all of the following requirements (I-1) to (I-5):
(I-1) to have an average transmittance for light entering at an incident angle of 0° in a wavelength range of 435 nm to 480 nm of 82% or higher;
(I-2) to have an average transmittance for light entering at an incident angle of 0° in a wavelength range of 490 nm to 560 nm of 82% or higher;
(I-3) to have a transmittance of 20% for light entering at an incident angle of 0° and having a wavelength within a 600-700 nm range;
(I-4) to have a transmittance of 20% for light entering at an incident angle of 0° and having a wavelength λ_{0°-20%} within a 600-700 nm range and have a transmittance of 20% for light entering at an incident angle of 30° and having a wavelength λ_{30°-20%} within a 600-700 nm range, a difference between the λ_{0°-20%} and the λ_{30°-20%} being 5 nm or less; and
(I-5) at each of incident angles of 0° and 30°, to have a minimum OD of 4.0 or more in a wavelength range of [maximum absorption wavelength λ_{max(A)TR} of the near-infrared absorbing dye (A)]±10 nm.

13. An imaging device, comprising the optical filter according to claim 1.
